(19) United States
(12) Patent Application Publication
(10) Pub. No.: US 2024/0368469 A1
(43) Pub. Date: Nov. 7, 2024

(54) COMPOSITIONS AND METHODS FOR ACCELERATED SOIL STABILIZATION

(71) Applicant: University of Maine System Board of Trustees, Orono, ME (US)

(72) Inventors: Aaron P. Gallant, Orono, ME (US); Warda Bint Ashraf, Arlington, TX (US)

(21) Appl. No.: 18/654,912

(22) Filed: May 3, 2024

Related U.S. Application Data
(60) Provisional application No. 63/464,397, filed on May 5, 2023.

(51) Int. Cl. C09K 17/04; C04B 2/02; C09K 105/00

(52) U.S. Cl. CPC C09K 17/045; C04B 2/02; C09K 2105/00

(57) ABSTRACT

The present disclosure provides compositions and methods for accelerating soil stabilization using carbon dioxide.

### CROSS REFERENCE TO RELATED APPLICATIONS

This application claims the benefit of and priority to U.S. Provisional Application No. 63/464,397 filed on May 5, 2023, the disclosure of which is hereby incorporated by reference in its entirety.

### BACKGROUND

Soil stabilization is a process by which properties of soil are transformed to provide long-term permanent strength gains. Stabilization typically results in increased strength and overall bearing capacity of a soil. Stabilized soils provide a strong working platform and foundation for all other parts a project.

### SUMMARY

Long-term performance of infrastructure (e.g. buildings, pavement, roadways, and railways) is reliant on, among other things, the quality of underlying soil conditions. Challenging soil subgrade conditions may leave infrastructure vulnerable to a wide array of performance issues, e.g. excessive deformations and/or erosion. Among other things, the present disclosure provides an insight relating to accelerating soil stabilization using carbon dioxide.

In accordance with various embodiments, provided technologies display certain advantages and/or solve one or more problems associated with prior technologies. In certain embodiments, the present disclosure encompasses a recognition that certain parameters may be advantageous for scaling accelerated soil stabilization, for example, using carbon dioxide. In certain embodiments, provided technologies (e.g. compositions and methods) for scalable processes to rapidly and/or consistently introduce CO₂ in soil may provide improvements to constructions projects in the field.

In some embodiments, the present disclosure provides for methods of soil stabilization, the method including, contacting a composition including soil, lime, and water, with exogenous carbon dioxide sufficient to create and/or maintain a continuous gas phase in the composition for a period of time sufficient to precipitate (e.g., to form by precipitation) carbonate minerals in the composition.

In some embodiments, the present disclosure provides for methods of stabilizing frost susceptible soil, the method including, contacting a composition including frost susceptible soil, a metal oxide and/or metal hydroxide, and water with exogenous carbon dioxide sufficient to create and/or maintain a continuous gas phase in the composition for a period of time sufficient to precipitate carbonate minerals in the composition. In some embodiments, the frost susceptible soil includes silt, sand, or a mixture thereof.

In some embodiments, the present disclosure provides for methods of reducing a susceptibility of pavement subgrade to freezing and thawing, the method including, contacting a composition including frost susceptible soil, a metal oxide and/or metal hydroxide, and water with exogenous carbon dioxide sufficient to create and/or maintain a continuous gas phase in the composition for a period of time sufficient to form carbonate minerals in the composition. In some embodiments, the frost susceptible soil includes silt, sand, or a mixture thereof.

In some embodiments, the present disclosure provides for methods of reducing annually repair of pavement subgrade, the method including, contacting a composition including frost susceptible soil, a metal oxide and/or metal hydroxide, and water with exogenous carbon dioxide sufficient to create and/or maintain a continuous gas phase in the composition for a period of time sufficient to form carbonate minerals in the composition. In some embodiments, the frost susceptible soil includes silt, sand, or a mixture thereof.

In some embodiments, the present disclosure provides for methods of reducing carbon emission during subgrade stabilization, the method including, contacting a composition including soil, a metal oxide and/or metal hydroxide, and water with exogenous carbon dioxide sufficient to create and/or maintain a continuous gas phase in the composition for a period of time sufficient to form carbonate minerals in the composition, wherein the formation of the carbonate mineral sequesters carbon dioxide in the soil.

In some embodiments, the present disclosure provides for methods of accelerated soil stabilization, the method including, contacting a composition including soil, a metal oxide and/or metal hydroxide and water, with exogenous carbon dioxide sufficient to create and/or maintain a continuous gas phase in the composition for a period of time sufficient to precipitate carbonate minerals in the composition.

In some embodiments, the present disclosure provides for methods of soil stabilization, the method including, (a) determining a soil type, void ratio, and/or degree of saturation for a composition including soil, a metal oxide and/or metal hydroxide, and water; and (b) contacting the composition with exogenous carbon dioxide sufficient to create and/or maintain a continuous gas phase in the composition for a period of time sufficient to precipitate carbonate minerals in the composition, wherein the period of time is determined by the soil type, degree of saturation, and/or water content.

In some embodiments, the present disclosure provides for methods of improving subgrade soil, the method including, (a) determining a soil type, void ratio, and/or degree of saturation for a composition including soil, a metal oxide and/or metal hydroxide, and water; and (b) contacting the composition with exogenous carbon dioxide sufficient to create and/or maintain a continuous gas phase in the composition for a period of time sufficient to precipitate carbonate minerals in the composition, wherein the period of time is determined by the soil type, degree of saturation, and/or water content.

A method for determining efficient CO₂ consumption of a composition during carbonation, the method including, (a) determining a soil type, void ratio, and/or degree of saturation for the composition including soil, a metal oxide and/or metal hydroxide, and water prior to carbonation; (b) contacting the composition with exogenous carbon dioxide sufficient to create and/or maintain a continuous gas phase in the composition for a period of time sufficient to form carbonate minerals in the composition, wherein the period of time is determined by the soil type, degree of saturation, and/or water content.

In some embodiments, a combination of void ratio and water content results in the composition with a degree of saturation that maintains the continuous gas-phase (i.e. a gas phase that facilitates mobility of CO₂ gas in the soil matrix, e.g. diffusion or advection), such that the carbonate minerals are rapidly and/or efficiently precipitated to bond the soil grains.

In some embodiments, a variety of compositions are considered to be compatible with methods provided herein. In one aspect, the present disclosure provides compositions including silt, non-plastic silt, sand, non-plastic sand, clay, peat, chalk, loam, or a mixture thereof. In some embodiments, the composition includes silt. In some embodiments, the composition includes sand. In some embodiments, the composition includes contaminated soil. In some embodiments, the composition includes solid waste.

In accordance with various aspects, the one or more metal oxide and/or metal hydroxide is compatible with provided methods. In some embodiments, the one or more metal oxide and/or metal hydroxide is selected from the group consisting of CaSiO₃, CaO, Mg₂SiO₄, MgO, Mg(OH)₂. In some embodiments, the one or more metal oxide and/or metal hydroxide is selected from the group consisting of CaSiO₃, CaO, Mg₂SiO₄, MgO, Ca(OH)₂, and Mg(OH)₂. In some embodiments, the metal oxide and/or metal hydroxide is quicklime or hydrated lime. In some embodiments, the hydrated lime is in amount between about 3% to about 15% by weight of the soil. In some embodiments, the hydrated lime is in amount about 3% to about 4% by weight of the soil. In some embodiments, the hydrated lime is in amount about 4% to about 5% by weight of the soil. In some embodiments, the hydrated lime is in amount about 5% to about 6% by weight of the soil. In some embodiments, the hydrated lime is in amount about 6% to about 7% by weight of the soil. In some embodiments, the hydrated lime is in amount about 7% to about 8% by weight of the soil. In some embodiments, the hydrated lime is in amount about 8% to about 9% by weight of the soil. In some embodiments, the hydrated lime is in amount about 9% to about 10% by weight of the soil. In some embodiments, the hydrated lime is in amount about 10% to about 11% by weight of the soil. In some embodiments, the hydrated lime is in amount about 11% to about 12% by weight of the soil.

In accordance with various aspects, the composition includes about 5% to about 50% water. In some embodiments, the composition includes about 5% to about 10% water. In some embodiments, the composition includes about 10% to about 15% water. In some embodiments, the composition includes about 15% to about 20% water. In some embodiments, the composition includes about 20% to about 25% water. In some embodiments, the composition includes about 25% to about 30% water. In some embodiments, the composition includes about 25% to about 30% water. In some embodiments, the composition includes about 25% to about 30% water. In some embodiments, the composition includes about 30% to about 35% water. In some embodiments, the composition comprises about 35% to about 40% water.

In some embodiments, a metal oxide and/or metal hydroxide reacts with CO₂ and water to form a precipitated carbonate mineral (e.g. CaCO₃, MgCO₃) in the composition. In some embodiments, the precipitated carbonate mineral is calcium carbonate. In some embodiments, the calcium carbonate is at least 3% mineral content by weight of the composition. In some embodiments, the calcium carbonate is at least 4% mineral content by weight of the composition. In some embodiments, the calcium carbonate is at least 5% mineral content by weight of the composition. In some embodiments, the calcium carbonate is at least 6% mineral content by weight of the composition. In some embodiments, the calcium carbonate is at least 7% mineral content by weight of the composition. In some embodiments, the calcium carbonate is at least 8% mineral content by weight of the composition. In some embodiments, the calcium carbonate is at least 9% mineral content by weight of the composition. In some embodiments, the calcium carbonate is at least 10% mineral content by weight of the composition. In some embodiments, the calcium carbonate is at least 15% mineral content by weight of the composition. In some embodiments, the calcium carbonate is at least 20% mineral content by weight of the composition.

In some embodiments, the formation of the carbonate mineral does not result in substantial atmospheric release of carbon dioxide into the atmosphere.

In some embodiments, the void ratio, eₒ, is between 0.3-2.0. In some embodiments, the void ratio, eₒ, between is 0.5-1.3.

In some embodiments, the degree of saturation is between 10%-80%. In some embodiments, the degree of saturation is about 20%. In some embodiments, the degree of saturation is about 25%. In some embodiments, the degree of saturation is about 30%. In some embodiments, the degree of saturation is about 35%. In some embodiments, the degree of saturation is about 40%. In some embodiments, the degree of saturation is about 45%. In some embodiments, the degree of saturation is about 50%. In some embodiments, the degree of saturation is about 55%. In some embodiments, the degree of saturation is about 60%. In some embodiments, the degree of saturation is about 65%. In some embodiments, the degree of saturation is about 70%. In some embodiments, the degree of saturation is about 75%. In some embodiments, the degree of saturation is about 80%.

In accordance with various aspect, the present disclosure recognizes that it can be advantageous for a composition to be contacted with exogenous carbon dioxide for a period of time. In some embodiments, the period of time is between 2 hours and 72 hours. In some embodiments, the period of time is between 2 hours and 200 hours. In some embodiments, the period of time is between 2 hours and 300 hours.

In some embodiments, the exogenous carbon dioxide is applied under a constant pressure. In some embodiments, the pressure is at least about 1 kPa. In some embodiments, the pressure is at least about 2 kPa. In some embodiments, the pressure is at least about 3 kPa. In some embodiments, the pressure is at least about 4 kPa. In some embodiments, the pressure is at least about 5 kPa. In some embodiments, the pressure is at least about 6 kPa. In some embodiments, the pressure is at least about 7 kPa. In some embodiments, the pressure is at least about 8 kPa. In some embodiments, the pressure is at least about 10 kPa. In some embodiments, the pressure is at least about 15 kPa. In some embodiments, the pressure is at least about 20 kPa. In some embodiments, the pressure is at least about 30 kPa. In some embodiments, the pressure is at least about 50 kPa. In some embodiments, the pressure is at least about 100 kPa. In some embodiments, the pressure is at least about 200 kPa. In some embodiments, the pressure is at least about 300 kPa. In some embodiments, the pressure is at least about 400 kPa. In some embodiments, the pressure is at least about 500 kPa. In some embodiments, the pressure is about atmospheric pressure.

As used in this application, the terms “about” and “approximately” are used as equivalents. Any citations to publications, patents, or patent applications herein are incorporated by reference in their entirety. Any numerals used in this application with or without about/approximately are meant to cover any normal fluctuations appreciated by one of ordinary skill in the relevant art.

Other features, objects, and advantages of the present invention are apparent in the detailed description that follows. It should be understood, however, that the detailed description, while indicating embodiments of the present invention, is given by way of illustration only, not limitation. Various changes and modifications within the scope of the invention will become apparent to those skilled in the art from the detailed description.

### Definitions

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” may be understood to permit standard variation as would be understood by those of ordinary skill in the art; and (v) where ranges are provided, endpoints are included.

About: The term “about”, when used herein in reference to a value, refers to a value that is similar, in context to the referenced value. In general, those skilled in the art, familiar with the context, will appreciate the relevant degree of variance encompassed by “about” in that context. For example, in some embodiments, the term “about” may encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or less of the referred value.

Agent: As used herein, the term “agent”, may refer to an entity or phenomenon. In some embodiments, an agent may be characterized by a particular feature and/or effect. In some embodiments, an agent may be a compound, molecule, or entity of any chemical class including, for example, a small molecule, polypeptide, nucleic acid, saccharide, lipid, metal, or a combination or complex thereof. In some embodiments, the term “agent” may refer to a compound, molecule, or entity that comprises a polymer. In some embodiments, the term may refer to a compound or entity that comprises one or more polymeric moieties. In some embodiments, the term “agent” may refer to a compound, molecule, or entity that is substantially free of a particular polymer or polymeric moiety. In some embodiments, the term may refer to a compound, molecule, or entity that lacks or is substantially free of any polymer or polymeric moiety. In some embodiments, an agent may be or comprise a system or device. In some embodiments, an agent may be or comprise a force such as an electric force, a gravitational force, a magnetic force, etc.

Degree of saturation: As used herein, the term “degree of saturation” (also referred herein as Sᵣ) in general refers to a ratio of volume of water to void volume of a composition. A degree of saturation may range from 0% to 100%. In some embodiments, a composition may have a degree of saturation of 0% and is completely dry. In some embodiments, a composition may have a degree of saturation of 100% and is fully saturated. In some embodiments, a formulated composition may have a theoretical maximal degree of saturation. In some embodiments, a maximal degree of saturation may be about 0%, 10%, 20%, 30%, 40%, 50%, 60%, 70, 80, 90, 100%. In some embodiments, a composition at a theoretical maximal degree of saturation is fully saturated.

Rapid: As used herein, the term “rapid” or “rapidly” refers to a composition and/or one or more aspects of a component of a composition that are formed over a period of time. In some embodiments, the period of time is at least about one (1) hour; the period of time is about five (5) hours, about ten (10) hours, about twenty (20) hours, about twenty-four (24) hours, about thirty-six (36) hours, about forty-eight (48) hours, about seventy-two (72) hours; the period of time is within the range of about one (1) hour to about two (2) hours, about two (2) hours to about twelve (12) hours, about twelve (12) hours to about twenty-four (24) hours, about twenty-four (24) hours to thirty-six (36) hours, about thirty-six (36) hours to about forty-eight (48) hours, about forty-eight (48) hours to about seventy-two (72) hours.

Substantially: As used herein, the term “substantially” refers to the qualitative condition of exhibiting total or near-total extent or degree of a characteristic or property of interest. One of ordinary skill in the arts will understand that chemical phenomena and/or reactions rarely, if ever, go to completion and/or proceed to completeness or achieve or avoid an absolute result. The term “substantially” is therefore used herein to capture the potential lack of completeness inherent in many chemical phenomena and/or chemical reactions.

Void ratio: As used herein, the term “void ratio” (also referred herein as e) refers to a ratio of space occupied by voids to the space occupied by solids. In some embodiments, the space occupied is represented by a volume of a void and/or solid. In some embodiments, a composition will have a relatively low value of void ratio, and is defined as dense. In some embodiments, a composition will have relatively high value of void ratio, and is defined as dense.

### BRIEF DESCRIPTION OF THE DRAWING

FIG. 1 shows an exemplary schematic depicting accelerated carbonation of lime mixed granular soils.

FIG. 2A shows exemplary soil gradation curves for Ottawa sand and non-plastic silt. FIG. 2B shows standard proctor compaction curves for Ottawa sand and non-plastic silt containing 10% lime by dry weight of soil.

FIGS. 3A-3E show exemplary temporal changes in unconfined compressive strength for carbonated sand compositions with varying degrees of saturation (Sᵣ). FIG. 3A shows results after 3 hours. FIG. 3B shows results after 24 hours. FIG. 3C shows results after 72 hours. FIG. 3D shows results after 120 hours. FIG. 3E shows results after 168 hours. All soils had an initial void ratio of 0.49.

FIGS. 4A-4D show exemplary temporal changes in unconfined compressive strength for silt carbonated at different degrees of saturation. FIG. 4A shows results after 3 hours. FIG. 4B shows results after 24 hours. FIG. 4C shows results after 72 hours. FIG. 4D shows results after 120 and 168 hours. All soils had an initial void ratio of 1.09.

FIG. 5A depicts an exemplary relationship between unconfined compressive strength and mineral (i.e. CaCO₃) content at the center of sand compositions with an initial void ratio (eₒ) of 0.49. FIG. 5B depicts another exemplary relationship between unconfined compressive strength and mineral (i.e. CaCO₃) content at the center of silt compositions with an initial void ratio (e) of 1.09.

FIG. 6A shows exemplary temporal changes in mineral (i.e. CaCO₃) content and degree of carbonation at the center of sand compositions with different degrees of saturation. Corresponding volumetric air content and water content are also shown. FIG. 6B shows temporal changes in mineral (i.e. CaCO₃) content and degree of carbonation at the center of silt compositions with different degrees of saturation. Corresponding volumetric air content and water content are also shown.

FIGS. 7A and 7B show exemplary differences in rate of mineral (i.e. CaCO₃) formation in carbonated sand and silt compositions (closed symbol: sand [initial void ratio (eₒ) of 0.49] and open symbol: silt [initial void ratio (eₒ) of 1.09]) with different degrees of saturation. FIG. 7A shows gravimetric mineral (i.e. CaCO₃) content of exemplary compositions with degrees of saturation values of about 25%-27% (left), about 40-41% (middle), and 49%-53% (right). FIG. 7B shows volumetric mineral (i.e. CaCO₃) content of exemplary compositions with degrees of saturation values of about 25%-27% (left), about 40-41% (middle), and 49%-53% (right).

FIGS. 8A and 8B show a comparison of volumetric mineral (i.e. CaCO₃) content in exemplary compositions (closed symbol: [initial void ratio (eₒ) of 0.49] and open symbol: silt [initial void ratio (eₒ) of 1.09]). FIG. 8A shows a comparison of temporal change in volumetric mineral (i.e. CaCO₃) content for sand and silt compositions with the same volumetric water content (θ_{w}). FIG. 8B shows a comparison of temporal change in volumetric mineral (i.e. CaCO₃) content for sand and silt compositions with the same volumetric air content (θₐ).

FIG. 9 depicts exemplary stress-strain curves from an unconfined compression strength (UCS) test performed on sand (left) and silt (right) compositions with different void ratio (eₒ) and degrees of saturation (Sᵣ). Compositions were carbonated such that a maximum degree of carbonation (DoC) was achieved.

FIG. 10A shows influence of initial void ratio (eₒ) (i.e. density) on unconfined compressive strength in certain exemplary carbonated sand compositions. Volumetric mineral (i.e. CaCO₃) content (left) and gravimetric mineral (i.e. CaCO₃) content (right) are shown. Void ratio ranges considered as loose, medium-dense, and dense are also shown.

FIG. 10B shows influence of initial void ratio (eₒ) (i.e. density) on unconfined compressive strength in carbonated silt compositions. Volumetric mineral (i.e. CaCO₃) content (left) and gravimetric mineral (i.e. CaCO₃) content (right) are shown. Void ratio ranges considered as loose, medium-dense, and dense are also shown.

FIGS. 11A and 11B show predicted strengths, stiffness, and approximate limits to carbonation that may be achieved for soil compositions with different exemplary gravimetric lime content. Lime content refers to the amount of calcium hydroxide, lime, that has fully reacted to form calcium carbonate (CaCO₃). (I) refers to suppressed carbonation rate anticipated (continuous water-phase); (II) refers to transition zone; (III) refers to efficient carbonation rate (continuous gas-phase); and (IV) refers to untested. FIG. 11A shows predicted unconfined compressive strength (left) and stiffness (middle), as well as influence of water content on the degree of saturation at different porosities (right) for exemplary carbonated sand compositions. FIG. 11B shows the predicted unconfined compressive strength (left) and stiffness (middle), as well as influence of water content on the degree of saturation at different porosities (right) for exemplary carbonated silt compositions.

FIG. 12 shows an exemplary schematic illustrating the equivalent amount of carbon dioxide emissions sequestered during soil carbonation.

FIG. 13 shows an exemplary schematic of a large soil box intended to simulate a portion of an embankment near a perimeter where gas escape near a perimeter and/or slope may occur. Carbon dioxide gas is introduced beneath an impermeable gas barrier (e.g. plastic tarp or geosynthetic) and sealed near a perimeter of a targeted area to enforce vertical penetration of carbon dioxide gas into the soil.

FIGS. 14A and 14B show an exemplary schematic of a soil box (as shown in FIG. 13). Location of flowmeter, thermocouples (TC) and bender elements (BE) are shown. All dimensions are measured in meter and measurements represent inside dimension excluding wall thickness. FIG. 14A shows a plan view. FIG. 14B shows an elevation view.

FIGS. 15A and 15B show an exemplary schematic of California Bearing Ratio (CBR) testing locations and where soil sampling was undertaken to perform thermogravimetric analyses and determine mineral contents. FIG. 15A shows a plan view. FIG. 15B shows an elevation view.

FIG. 16 shows soil gradation curve of tested soils (left), and standard proctor compaction curves for tested soils and soil containing approximately 8% Ca(OH)₂, lime, material by dry weight of soil (right). The lime material was approximately 80% pure calcium hydroxide.

FIGS. 17A and 17B show exemplary flowmeter readings at a gas-entry point during surface carbonation experiments. FIG. 17A shows absolute pressure and temperature measured during carbonation. FIG. 17B shows CO₂ mass flow rate and total mass of CO₂ introduced.

FIGS. 18A-C show temporal changes in temperature readings and shear wave velocity at various depths in exemplary soil compositions during surface carbonation. Number in legends shows depth, z, in mm from the soil surface. Solid line depict measurements from side A (degree of saturation (Sᵣ) of 30%) and dashed line depicts measurements from side B (degree of saturation (Sᵣ) of 40%). FIG. 18A shows temperature readings at 0 and 100 mm (left) and 200, 300, and 400 mm (right). FIG. 18B shows rate of temperature change at 0 and 100 mm (left) and 200, 300, and 400 mm (right). FIG. 18C shows changes in shear wave velocity at 50 mm (left) and 250 mm (right).

FIG. 19A shows gravimetric mineral (i.e. CaCO₃) content and unreacted hydrated lime (i.e. lime) content on side A of the soil box after surface carbonation. FIG. 19B shows gravimetric mineral (i.e. CaCO₃) contents and unreacted hydrated lime (i.e. lime) contents on side B of the soil box after surface carbonation.

FIG. 20 shows pre- and post-carbonation California Bearing Ratio (CBR) values throughout the soil column on side A (left) and side B (right) of the soil box.

FIG. 21A shows before and after surface carbonation stress-penetration curves from California Bearing Ratio (CBR) tests at depths of 0 mm (left), 100 mm (middle), and 150 mm (right) on side A of the soil box. FIG. 21B shows before and after surface carbonation stress-penetration curves from California Bearing Ratio (CBR) tests at depths of 0 mm (left), 100 mm (middle), and 150 mm (right) on side B of the soil box.

FIG. 22A shows unload-reload cycles performed at varying stress levels for depths of 0, 100, and 150 mm for side A of the soil box after surface carbonation. Stress levels and deformations where unload-reload cycles were performed are shown on the right. FIG. 22B shows unload-reload cycles performed at varying stress levels for depths of 0, 100, and 150 mm for side B of the soil box after surface carbonation. Stress levels and deformations where unload-reload cycles were performed are shown on the right.

FIGS. 23A-23C show results of California Bearing Ratio (CBR) testing. FIG. 23A shows influence of thickness, Hc, of fully carbonated soil layer underlying a CBR loading piston of diameter, B (i.e. diameter of loading piston is about 50.8 mm), on failure stress, q_{f} (left) and CBR (right). FIG. 23B shows permanent deformation associated with unload-reload cycles performed at varying stress-levels, qᵤᵣ, at depths of 0, 100, and 150 mm. FIG. 23C shows influence of the unload-reload stress relative to the ultimate capacity of the soil, expressed as a qᵤᵣ/q_{f} ratio, on permanent deformations from unload-reload cycles.

FIGS. 24A and 24B show an exemplary schematic of a soil box for freeze-thaw experiments. Location of thermocouples (TC) bender element pairs (BE), and Linear Potentiometer Position Sensor (LPSS) mounted on settlement plates are shown. All dimensions are measured in meter and measurements represent inside dimension excluding wall thickness. FIG. 24A shows a plan view. FIG. 24B shows an elevation view.

FIGS. 25A and 25B show an exemplary schematic of field California Bearing Ratio (CBR) testing locations and soil sampling for freeze-thaw (FT) experiments. FIG. 25A shows a plan view. FIG. 25B shows an elevation view.

FIGS. 26A and 26B show gravimetric mineral (i.e. CaCO₃) contents and unreacted hydrated lime (Ca(OH)₂) contents measured immediately after carbonation was performed and after freeze-thaw (FT) cycles. FIG. 26A shows gravimetric mineral (i.e. CaCO₃) contents and unreacted hydrated lime contents on side A of the soil box. FIG. 26B shows gravimetric mineral (i.e. CaCO₃) contents and unreacted hydrated lime contents on side B of the soil box.

FIGS. 27A-27C show California Bearing Ratio (CBR) testing at the surface of the soil box, but before freeze-thaw testing and compared with measurements immediately after carbonation. FIG. 27A shows stress-penetration curves on side A (left) and side B (right). FIG. 27B shows changes in surface CBR and water content after soaking on Side A of the soil box. FIG. 27C shows changes in surface CBR and water content after soaking on Side B of the soil box.

FIGS. 28A-28C depicts continuous monitoring during two exemplary freeze-thaw cycles of side A (left) and side B (right) of the soil box. FIG. 28A shows temperatures monitored at soil depths of about 100, 200, 300, and 400 mm. FIG. 28B shows subsurface vertical deformations measured via settlement plate at soil depths of about 100, 200, 300, and 400 mm. FIG. 28C shows relative vertical deformations expressed as a percentage of the thickness of soil between settlement plates for the subsurface depth intervals of about 0-100, 100-200, 200-300, and 300-450 mm.

FIG. 29 shows vertical deformations through subsurface profile at different points in time during freeze-thaw (FT) experiments for side A (left) and side B (right) of the soil box. Number in legend reflects the time during freeze-thaw experiments. For thawing, “swell” indicates the approximate time peak swelling was observed and “end” indicates at the end of a freeze or thaw period.

FIG. 30 shows shear wave velocity measurements on side B of the soil box at soil depth of about 50 mm in fully carbonated silt (left) and soil depth of about 250 mm in lightly carbonated silt (right). Number in legends shows the depth, z in mm from the soil surface. Temperatures were recorded at location B1 (as shown in FIG. 25A).

FIG. 31 shows exemplary stress-penetration curves from California Bearing Ratio (CBR) testing after freeze-thaw (FT) cycles were performed on side A of the soil box (left) and side B (right) of the soil box. The soil remained fully saturated after FT cycles.

FIGS. 32A and 32B show California Bearing Ratio (CBR) values and water contents measured after two freeze-thaw cycles compared with surface measurements after soaking, but before freeze-thaw testing, and before surface carbonation was performed. The frost-susceptibility criteria according to ASTM D5918 is also shown. FIG. 32A shows CBR values from side A of the soil box. FIG. 32B shows CBR values from side B of the soil box.

FIGS. 33A and 33B show California Bearing Ratio (CBR) stress-penetration curves in exemplary fully carbonated soil compositions at depths of about 0 mm, 100 mm and 150 mm after a drying period compared with measurements after surface carbonation, soaking, and two freeze-thaw cycles. FIG. 33A shows CBR stress-penetration curves from side A of the soil box. FIG. 33B shows CBR stress-penetration curves from side B of the soil box.

FIGS. 34A and 34B show California Bearing Ratio (CBR) stress-penetration curves in exemplary fully carbonated soil compositions at depths of about 250 mm and 350 mm after a drying period compared with measurements after surface carbonation, soaking, and two freeze-thaw cycles. FIG. 34A shows CBR stress-penetration curves from side A of the soil box. FIG. 34B shows CBR stress-penetration curves from side B of the soil box.

FIGS. 35A and 35B depict a comparison summary for Side A of the soil box. FIG. 35A depicts a comparison between California Bearing Ratio (CBR) values observed after two-freeze thaw cycles with values after a 12-week drying period (left) and changes in water content (right). FIG. 35B depicts changes in gravimetric binder content (left) and unreacted calcium hydroxide during the drying period (right).

FIGS. 36A and 36B depict a comparison summary for Side B of the soil box. FIG. 36A depicts a comparison between California Bearing Ratio (CBR) values observed after two-freeze thaw cycles with values after a 12-week drying period (left) and changes in water content (right). FIG. 36B depicts changes in gravimetric binder content (left) and unreacted calcium hydroxide during the drying period (right).

### DETAILED DESCRIPTION OF CERTAIN EMBODIMENTS

It is contemplated that compositions, methods, and processes of the present application encompass variations and adaptations developed using information from embodiments described in the following description. Adaptation and/or modification of compositions, methods, and processes described in the following description may be performed by those of ordinary skill in the relevant art.

Throughout the description, where compositions are described as having, including, or comprising specific components, or where processes and methods are described as having, including, or comprising specific steps, it is contemplated that, additionally, there are aspects of the present application that consist essentially of, or consist of, recited components, and that there are processes and methods according to the present application that consist essentially of, or consist of, recited processing steps.

It should be understood that order of steps or order for performing certain actions is immaterial so long as a described method remains operable. Moreover, two or more steps or actions may be conducted simultaneously.

Reference in the present application to any publication, for example, in the Background section, is not an admission that the publication serves as prior art with respect to any of the presented claims. The Background section is presented for purposes of clarity and is not meant as a description of prior art with respect to any claim. Headers are provided for the convenience of the reader and are not intended to be limiting with respect to claimed subject matter.

### Soil Stabilization

Before construction, when subgrade soil conditions are not adequate, additional work is conducted to improve soil quality. Improvements can be achieved through soil stabilization methods which can include improving soil gradation, reducing plasticity index or swelling potential, and/or increasing durability and strength (see, e.g. Makusa, Gregory Paul. “Soil stabilization methods and materials in engineering practice: State of the art review.” (2013)).

Soil stabilization methods can either involve ex-situ (or off site) or in-situ processes (see, e.g. Afrin, Habiba. “A review on different types soil stabilization techniques.” International Journal of Transportation Engineering and Technology 3.2 (2017): 19-24). Ex-situ soil stabilization involves excavating an existing soil layer and installing a more suitable material in place of the old soil material that was removed (see, e.g. Makusa, Gregory Paul. “Soil stabilization methods and materials in engineering practice: State of the art review.” (2013)). However, depending on an availability and location of borrow sites, excavation and replacement may not be an option. Thus, alternative methods are preferred to augment strength and stiffness of an existing soil layer (see, e.g. Makusa, Gregory Paul. “Soil stabilization methods and materials in engineering practice: State of the art review.” (2013).

In-situ soil stabilization is a process by which physical properties of native subgrade soil are transformed to provide strength gains through incorporation of an additional stabilizing component (e.g. cementitious materials e.g. cement, lime, fly ash, bitumen and/or combination thereof). In contrast to ex-situ methods, in-situ soil stabilization can eliminate a need for expensive remove-and-replace operations. Several in-situ soil stabilization methods have been contemplated for improving subgrade soil.

### In-Situ Soil Stabilization Methods

### Mechanical Stabilization

Mechanical stabilization is a process of improving properties of soil by changing its density and the associated porosity and void ratio. This process includes soil compaction and densification by application of mechanical energy. Mechanical stabilization is further accomplished by mixing or blending soils of two or more gradations to obtain a novel soil material that meets a required specification (see, e.g. Afrin, Habiba. “A review on different types soil stabilization techniques.” International Journal of Transportation Engineering and Technology 3.2 (2017): 19-24; and Onyelowe Ken, C., and F. O. Okafor. “A comparative review of soil modification methods.” University of Nigeria (2006)).

A main objective of mechanical stabilization is to blend available soils so that, when properly compacted, they give a desired stability. However, when soil blending is not feasible or does not produce a satisfactory soil material, alternative methods of stabilization are considered (see, e.g. Onyelowe Ken, C., and F. O. Okafor. “A comparative review of soil modification methods.” University of Nigeria (2006)).

### Fly Ash Stabilization

Fly ash stabilization is recognized as a relatively sustainable and inexpensive method for improving poor soil conditions (see, e.g. Renjith, Rintu, et al. “Optimization of fly ash based soil stabilization using secondary admixtures for sustainable road construction.” Journal of Cleaner Production 294 (2021): 126264). Fly ash is a byproduct of coal-fired electric power generation facilities and has little cementations properties, as compared to lime and cement. Fly ash is a pozzolanic material that consists mainly of silicon and aluminum compounds that, when mixed with lime and water, forms a hardened cementitious mass capable of obtaining high compression strengths (see, e.g. Afrin, Habiba. “A review on different types soil stabilization techniques.” International Journal of Transportation Engineering and Technology 3.2 (2017): 19-24; and Onyelowe Ken, C., and F. O. Okafor. “A comparative review of soil modification methods.” University of Nigeria (2006)). Soils stabilized via a fly ash method are highly susceptible to slaking and strength loss, which reduces long term strength and durability (see, e.g. Afrin, Habiba. “A review on different types soil stabilization techniques.” International Journal of Transportation Engineering and Technology 3.2 (2017): 19-24).

### Bituminous Stabilization

Bituminous soil stabilization refers to a process by which a controlled amount of bituminous material is thoroughly mixed with an existing soil or aggregate material to form a stabilized base (see, e.g. Afrin, Habiba. “A review on different types soil stabilization techniques.” International Journal of Transportation Engineering and Technology 3.2 (2017): 19-24).

Bituminous stabilization is generally accomplished by using asphalt cement, asphalt cutback, or asphalt emulsions (see, e.g. Onyelowe Ken, C., and F. O. Okafor. “A comparative review of soil modification methods.” University of Nigeria (2006)). The type of bitumen used depends on the soil intended to be stabilized, method of construction and weather condition (see, e.g. Onyelowe Ken, C., and F. O. Okafor. “A comparative review of soil modification methods.” University of Nigeria (2006)). Importantly, in frost areas, the use of tar as binder must be avoided (see, e.g. Onyelowe Ken, C., and F. O. Okafor. “A comparative review of soil modification methods.” University of Nigeria (2006)).

### Cement Stabilization

Cementation stabilization is used to modify quality of soil, improve quality of soil, and/or transform soil into a cemented mass, which significantly increases strength and durability (see, e.g. Onyelowe Ken, C., and F. O. Okafor. “A comparative review of soil modification methods.” University of Nigeria (2006)). As cement fills a void between soil particles, the void ratio of the soil is reduced (i.e. denser). When water is added to a soil-cement composition, a reaction occurs and the composition hardens. Therefore, unit weight of soil, shear strength, and bearing capacity are increased (see, e.g. Afrin, Habiba. “A review on different types soil stabilization techniques.” International Journal of Transportation Engineering and Technology 3.2 (2017): 19-24).

According to the UN Environment Programme, production of cement emits approximately 1 ton of carbon dioxide (CO₂) gas into the atmosphere per ton of cement (see, e.g. UNEP-GEAS (2010). Greening cement production has a big role to play in reducing greenhouse gas emissions. United Nations Environment Programme 650 (UNEP) Global Environmental Alert Service (GEAS). Sioux Falls, SD: UNEP-GEAS). Each year, it is estimated that the cement industry contributes approximately 8 to 9% of all anthropogenic CO₂ emissions worldwide and this estimate is expected to increase (see, e.g. Miller, S. et. al. “Carbon dioxide reduction potential in the global cement industry by 2050.” Cement and Concrete Research, (2018): 114, 115-124; and Reis, D. C. et. al. “Potential CO₂ reduction and uptake due to industrialization and efficient cement use in Brazil by 2050.” Journal of Industrial Ecology (2021): 25, 344-358). Thus, development of approaches to stabilize poor subgrade soils that would reduce net CO₂ emissions aligns with larger societal initiatives to reduce the rate of global warming. In certain embodiments, technologies (e.g. compositions and methodologies) described herein reduce or even substantially eliminate CO₂ release during soil stabilization (e.g., reduce or substantially eliminate process-based CO₂). In some embodiments, technologies described herein reduce or even eliminate CO₂ release during subgrade soil stabilization.

### Lime Stabilization

Lime soil stabilization is a method by which lime is added to soil and has been used as a traditional method for soil stabilization (see, e.g. Jawad, Ibtchaj Taha, et al. “Soil stabilization using lime: Advantages, disadvantages and proposing a potential alternative.” Research Journal of Applied Sciences, Engineering and Technology 8.4 (2014): 510-520). There are essentially two forms of improvement: stabilization and modification. Soil stabilization causes a significant improvement in soil texture and structure by reducing plasticity and by providing pozzolanic strength gain (see, e.g. Little, Dallas N. Evaluation of structural properties of lime stabilized soils and aggregates. Arlington: National lime association, 1998).

Soil modification to some extent can improve almost all fine-grained soils, but substantial improvement occurs in clay soils of moderate to high plasticity (see, e.g., Little, Dallas N. Evaluation of structural properties of lime stabilized soils and aggregates. Arlington: National lime association, 1998). Modification occurs primarily due to exchange of calcium cations supplied by hydrated lime (Ca(OH)₂) (see, e.g., Little, Dallas N. Evaluation of structural properties of lime stabilized soils and aggregates. Arlington: National lime association, 1998). Clay soil properties are altered as it reacts with calcium cations to form cementitious products (see, e.g., Little, Dallas N. Evaluation of structural properties of lime stabilized soils and aggregates. Arlington: National lime association, 1998). However, methods using lime as a chemical additive for stabilization of non-plastic materials (e.g., sand and silt) remain unclear. In certain embodiments, technologies (e.g., compositions and methodologies) described herein are designed to stabilize a soil composition comprising non-plastic materials (e.g., sand and silt).

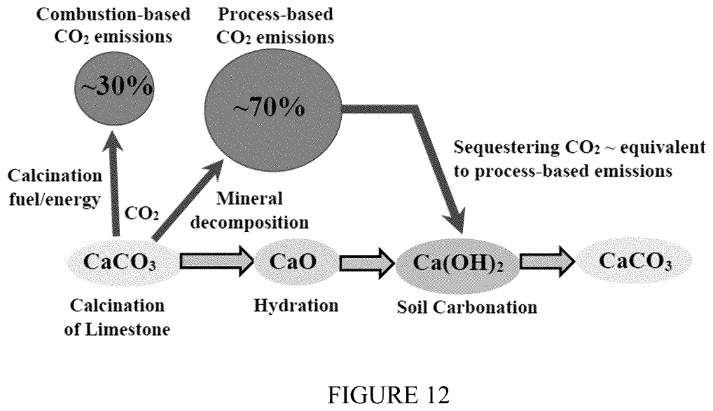

In addition, hydrated lime production from limestone contributes to CO₂ emissions. During production, limestone is calcinated and decomposes into quicklime (i.e. CaO), resulting in “process-based” carbon emissions (i.e. CO₂ released due to decomposition of limestone) and “combustion-based” emissions (i.e. energy and/or fuels needed to heat kilns during the calcination process). Process-based emission account for at least two-thirds of CO₂ emissions during production (see, e.g. Stork, M. et. al. “A competitive and efficient lime industry-cornerstone for a sustainable Europe. Technical report by The European lime Association (EuLA)”. Brussels, Belgium: EuLA (2014); and Campo, F. P. et. al. “Natural and enhanced carbonation of lime in its different applications: a review.” Environmental Technology Reviews, (2021): 10, 224-237). After calcination, water is added to quicklime to produce hydrated lime. There remains a growing urgency throughout the world to find cost-effective solutions to reduce CO₂ emissions during construction. As depicted in FIG. 12, technologies described herein reduce or even substantially eliminate production-based carbon dioxide emissions. In accordance with various embodiments, technologies described herein reduce or even substantially eliminate process-based carbon dioxide emissions associated with production of quicklime (i.e. CaO).

### Soil Carbonation

Soil is considered a large sink for CO₂ storage and can preserve carbon from the atmosphere in many forms (see, e.g., Li, Man, et al. “The state of the art of carbonation technology in geotechnical engineering: A comprehensive review.” Renewable and Sustainable Energy Reviews 171 (2023): 112986). Soil can capture and/or store carbon by natural or artificial processes, corresponding to natural carbonation and accelerated carbonation, respectively. Natural carbonation is a slow and time-consuming process by which CO₂ in the atmosphere diffuses into and reacts with materials in soil (see, e.g., Renforth, Phil, et al. “Designing a carbon capture function into urban soils.” Proceedings of the Institution of Civil Engineers-Urban Design and Planning 164.2 (2011): 121-128). In contrast, accelerated carbonation utilizes artificially manipulated conditions, such as temperature, pressure, and humidity to enhance CO₂ capture efficiency and capacity (see, e.g., Li, Man, et al. “The state of the art of carbonation technology in geotechnical engineering: A comprehensive review.” Renewable and Sustainable Energy Reviews 171 (2023): 112986). Natural and/or accelerated carbonation can result in e.g. formation of an insoluble solid carbonate in soil (e.g., calcite (CaCO₃), dolomite (Ca_{0.5}Mg_{0.5}CO₃), magnesite (MgCO₃), and siderite (FeCO₃)). Furthermore, metal-bearing oxides or divalent cations in soil can react with CO₂ to form an insoluble solid carbonate via a gas phase-solid phase or gas phase-liquid phase-solid phase mechanism (see, e.g., Li, Man, et al. “The state of the art of carbonation technology in geotechnical engineering: A comprehensive review.” Renewable and Sustainable Energy Reviews 171 (2023): 112986).

### Gas Phase-Solid Phase

When soil is contacted with CO₂, carbonation can occur by a gas phase-solid phase route. During the gas phase, CO₂ diffuses into the soil and then CO₂ diffuses to the soil pores. During the solid phase, CO₂ reacts with active materials in soil and a carbonate mineral forms. The reaction is extremely slow, even under the elevated carbonation pressure (see, e.g., Li, Man, et al. “The state of the art of carbonation technology in geotechnical engineering: A comprehensive review.” Renewable and Sustainable Energy Reviews 171 (2023): 112986).

### Gas Phase-Liquid Phase-Solid Phase

When soil comprising water is contacted with CO₂, carbonation can occur by a gas phase-liquid phase-solid phase route. During the gas phase, CO₂ diffuses into soil. During the liquid phase, CO₂ and a metal oxide and/or metal hydroxide dissolves in the pore water solution. Equations 1-3 present exemplary dissolution reactions.

$$Metal oxide {(}_{solid} ) + {H}_{2} {O}_{( liquid )} ↔ Metal {Cation}_{( aqueous )} + {Anion}_{( aqueous )} + \qquad ( Equation 1 )$$

$$Metal hydroxide {(}_{solid} ) + {H}_{2} {O}_{( liquid )} ↔ Metal {Cation}_{( aqueous )} + {Anion}_{( aqueous )} + \qquad ( Equation 2 )$$

$${CO}_{2 ( gas )} + {H}_{2} {O}_{( liquid )} \to {H}_{2} {CO}_{3 ( aqueous )} ↔ {H}_{( aqueous )}^{+} + {HCO}_{3 ( aqueous )}^{-} ↔ 2 {H}_{( aqueous )}^{+} + {CO}_{( aqueous )}^{2 -} \qquad ( Equation 3 )$$

During the solid phase, carbonate (CO₃²⁻) ions combine with available reactive metal cations (e.g., Ca²⁺, Mg²⁺) and then carbonate minerals (e.g., CaCO₃, MgCO₃) precipitates out of the pore water solution. In some embodiments, a metal oxide and/or metal hydroxide reacts with CO₂ and water to form a carbonate mineral (e.g., CaCO₃, MgCO₃). In some embodiments, a carbonate mineral (e.g., CaCO₃, MgCO₃) can bind a soil matrix. In some embodiments, a carbonate mineral (e.g., CaCO₃, MgCO₃) may be referred to herein as a “binder”. In some embodiments, carbonate mineral (e.g., CaCO₃, MgCO₃) content in a composition may be referred to herein as “binder content”.

The preceding description of the gas phase-liquid phase-solid phase route can be summarized in Equations 4 and 5.

$$Metal {oxide}_{( solid )} + {H}_{2} {O}_{( liquid )} + {CO}_{2 ( gas )} \to Metal {carbonate}_{( solid )} + Heat \qquad ( Equation 4 )$$

$$Metal {hydroxide}_{( solid )} + {H}_{2} {O}_{( liquid )} + {CO}_{2 ( gas )} \to Metal {carbonate}_{( solid )} + {H}_{2} O \qquad ( Equation 5 )$$

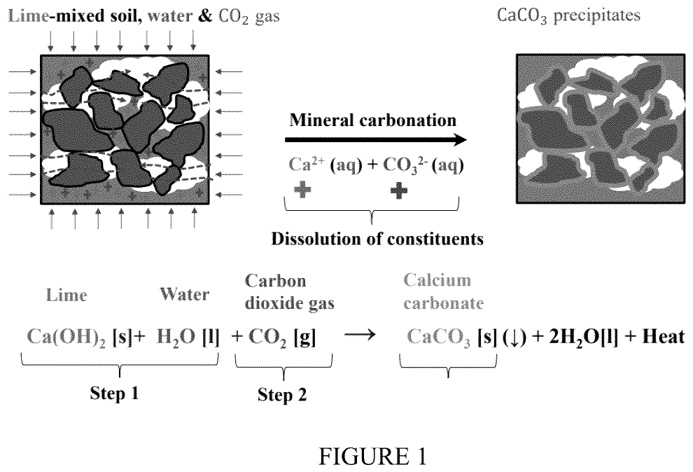

Although, there are several complex reaction steps, there is a capacity for accelerating carbonation reaction rates (see, e.g., Lim, Mihee, et al. “Environmental remediation and conversion of carbon dioxide (CO₂) into useful green products by accelerated carbonation technology.” International Journal of Environmental Research and Public Health 7.1 (2010): 203-228). As but a mere example, a sufficient amount of pore water must be present such that a metal oxide and/or metal hydroxide is in contact with, and dissolve into, the pore water, which facilitates dissolution of a metal source and CO₂ gas (see, e.g., Equations 1-3). Thus, without wishing to be bound by any particular theory, if there is sufficient pore water present, then there is an increased capacity for CO₂ and a metal source to dissolve at any given moment. As but another mere example, CO₂ gas mobility is obstructed in high water content environments. Gas diffusion and mobility through soil increases significantly with air content (see, e.g., Moldrup, P., et al. “Tortuosity, diffusivity, and permeability in the soil liquid and gaseous phases.” Soil Science Society of America Journal 65.3 (2001): 613-623). Thus, without wishing to be bound by any particular theory, water content and volumetric air content in a soil composition must be balanced to create and/or maintain a continuous gas phase (i.e, a gas phase that facilitates mobility of CO₂ gas in the soil matrix, say be diffusion or advection) e.g., see FIG. 1. In accordance with various embodiments, the present disclosure encompasses a recognition that certain parameters may be advantageous for creating and/or maintaining a continuous (i.e. sufficient) gas phase in a composition. In some embodiments, provided technologies described herein facilitate rapid and/or efficient formation a carbonate mineral to precipitate in a composition.

Recent bench-scale studies have demonstrated that stable carbonate minerals from magnesium-based alkali sources such as reactive magnesia (MgO) or olivine (Mg₂SiO₄) can improve strength and stiffness of soil. (see, e.g., Yi, Yaolin, et al. “Carbonating magnesia for soil stabilization.” Canadian Geotechnical Journal 50.8 (2013): 899-905; and Cai, G. H., et al. “Physical properties, electrical resistivity, and strength characteristics of carbonated silty soil admixed with reactive magnesia.” Canadian Geotechnical Journal 52.11 (2015): 1699-1713; and Fasihnikoutalab, M. et. al. “Utilisation of carbonating olivine for sustainable soil stabilisation. Environmental Geotechnics”, (2017): 4, 184-198) However, these studies have focused on investigating the effectiveness of soil carbonation via (1) magnesium-based systems and (2) laboratory tests rather than field application and/or constructions projects in the field. In addition, these studies have not demonstrated necessary parameters for accelerating carbonation in a construction setting. Thus, a challenge remains for developing scalable processes to rapidly and/or consistently introduce CO₂ in soil that could translate to improvements in a field setting (see, e.g., Li, Man, et al. “The state of the art of carbonation technology in geotechnical engineering: A comprehensive review.” Renewable and Sustainable Energy Reviews 171 (2023): 112986). In certain embodiments, provided technologies (e.g. compositions and methods) for scalable processes to rapidly and/or consistently introduce CO₂ in soil may provide improvements to constructions projects in the field. In certain embodiments, the present disclosure encompasses a recognition that certain parameters may be advantageous for scaling accelerated soil stabilization, for example, using carbon dioxide.

### Accelerated Soil Stabilization Methods

In some embodiments, the present disclosure is directed to accelerating soil stabilization, for example, using carbon dioxide. In some embodiments, a composition is contacted with exogenous carbon dioxide sufficient to create and/or maintain a continuous gas phase in the composition for a period of time. In some embodiments, a composition is contacted with exogenous carbon dioxide sufficient to create and/or maintain a continuous gas phase in the composition for a period of time sufficient to precipitate carbonate minerals.

### Compositions Elements

The present invention provides and/or takes advantage of a variety of compositions that are compatible with methods provided herein.

### Soil Type

In accordance with various embodiments, any of a variety of soil types are compatible with methods provided herein. In some embodiments, a composition comprises sand. In some embodiments, at least a portion of an amount of sand has a particle diameter of about 0.1 to 1 mm. In some embodiments, at least a portion of an amount of sand has a particle diameter of about 0.1 mm. In some embodiments, at least a portion of an amount of sand has a particle diameter of about 0.2 mm. In some embodiments, at least a portion of an amount of sand has a particle diameter of about 0.3 mm. In some embodiments, at least a portion of an amount of sand has a particle diameter of about 0.4 mm. In some embodiments, at least a portion of an amount of sand has a particle diameter of about 0.5 mm. In some embodiments, at least a portion of an amount of sand has a particle diameter of about 0.6 mm. In some embodiments, at least a portion of an amount of sand has a particle diameter of about 0.7 mm. In some embodiments, at least a portion of an amount of sand has a particle diameter of about 0.8 mm. In some embodiments, at least a portion of an amount of sand has a particle diameter of about 0.9 mm. In some embodiments, at least a portion of an amount of sand has a particle diameter of about 1 mm.

In some embodiments, a composition comprises silt. In some embodiments, at least a portion of an amount of silt has a particle diameter of about 0.1 to 1 mm. In some embodiments, at least a portion of an amount of silt has a particle diameter of about 0.1 mm. In some embodiments, at least a portion of an amount of silt has a particle diameter of about 0.2 mm. In some embodiments, at least a portion of an amount of silt has a particle diameter of about 0.3 mm. In some embodiments, at least a portion of an amount of silt has a particle diameter of about 0.4 mm. In some embodiments, at least a portion of an amount of silt has a particle diameter of about 0.5 mm. In some embodiments, at least a portion of an amount of silt has a particle diameter of about 0.6 mm. In some embodiments, at least a portion of an amount of silt has a particle diameter of about 0.7 mm. In some embodiments, at least a portion of an amount of silt has a particle diameter of about 0.8 mm. In some embodiments, at least a portion of an amount of silt has a particle diameter of about 0.9 mm. In some embodiments, at least a portion of an amount of silt has a particle diameter of about 1 mm.

In some embodiments, a composition comprises non-plastic silt. In some embodiments, a composition comprises non-plastic sand. In some embodiments, a composition comprises clay. In some embodiments, a composition comprises peat. In some embodiments, a composition comprises chalk. In some embodiments, a composition comprises loam. In some embodiments, a composition comprises silt, non-plastic silt, sand, non-plastic sand, clay, peat, chalk, loam, or a mixture thereof.

In some embodiments, a composition comprises contaminated soil. In some embodiments, a composition comprises solid waste.

### Metal Oxide

In accordance with various embodiments, one or more metal oxide is compatible with provided methods. In some embodiments, a composition comprises calcium silicate, calcium oxide, magnesium silicate, and/or magnesium oxide. In some embodiments, a composition comprises CaSiO₃ (“wollastonite”), CaO (“burnt lime” or “quicklime”; herein also referred to as “quicklime”), Mg₂SiO₄ (“forsterite” or “olivin”), MgO (“magnesia”), and/or combination thereof. In some embodiments, a composition comprises a metal oxide selected from the group consisting of CaSiO₃, CaO, Mg₂SiO₄, MgO, and combinations thereof. In some embodiments, a composition comprises a metal oxide selected from the group consisting of CaSiO₃, CaO, Mg₂SiO₄, MgO, Ca(OH)₂, and combinations thereof.

In some embodiments, a composition comprises CaSiO₃. In some embodiments, a composition comprises CaO. In some embodiments, a composition comprises Mg₂SiO₄. In some embodiments, a composition comprises MgO.

In some embodiments, a composition comprises a metal oxide. In some embodiments, a metal oxide is or comprises CaSiO₃. In some embodiments, a metal oxide is or comprises CaO. In some embodiments, a metal oxide is or comprises Mg₂SiO₄. In some embodiments, a metal oxide is or comprises MgO.

Any of a variety of amounts of a metal oxide, or other application appropriate substance is compatible with provided methods.

In some embodiments, a composition comprises about 3% to about 4% of a metal oxide by weight of soil, about 3% to about 5% of a metal oxide by weight of soil, about 3% to about 6% of a metal oxide by weight of soil, about 3% to about 7% of a metal oxide by weight of soil, about 3% to about 8% of a metal oxide by weight of soil, about 3% to about 9% of a metal oxide by weight of soil, about 3% to about 10% a metal oxide by weight of soil, about 3% to about 11% a metal oxide by weight of soil, about 3% to about 12% a metal oxide by weight of soil, about 3% to about 13% a metal oxide by weight of soil, about 3% to about 14% a metal oxide by weight of soil, about 3% to about 15% a metal oxide by weight of soil, about 3% to about 16% a metal oxide by weight of soil, about 3% to about 17% a metal oxide by weight of soil, about 3% to about 18% a metal oxide by weight of soil, about 3% to about 19% a metal oxide by weight of soil, about 3% to about 20% a metal oxide by weight of soil. In some embodiments, a composition comprises about 4% to about 5% of a metal oxide by weight of soil, about 4% to about 6% of a metal oxide by weight of soil, about 4% to about 7% of a metal oxide by weight of soil, about 4% to about 8% of a metal oxide by weight of soil, about 4% to about 9% of a metal oxide by weight of soil, about 4% to about 10% a metal oxide by weight of soil, about 4% to about 11% a metal oxide by weight of soil, about 4% to about 12% a metal oxide by weight of soil, about 4% to about 13% a metal oxide by weight of soil, about 4% to about 14% a metal oxide by weight of soil, about 4% to about 15% a metal oxide by weight of soil, about 4% to about 16% a metal oxide by weight of soil, about 4% to about 17% a metal oxide by weight of soil, about 4% to about 18% a metal oxide by weight of soil, about 4% to about 19% a metal oxide by weight of soil, about 4% to about 20% a metal oxide by weight of soil. In some embodiments, a composition comprises about 5% to about 6% of a metal oxide by weight of soil, about 5% to about 7% of a metal oxide by weight of soil, about 5% to about 8% of a metal oxide by weight of soil, about 5% to about 9% of a metal oxide by weight of soil, about 5% to about 10% a metal oxide by weight of soil, about 5% to about 11% a metal oxide by weight of soil, about 5% to about 12% a metal oxide by weight of soil, about 5% to about 13% a metal oxide by weight of soil, about 5% to about 14% a metal oxide by weight of soil, about 5% to about 15% a metal oxide by weight of soil, about 5% to about 16% a metal oxide by weight of soil, about 5% to about 17% a metal oxide by weight of soil, about 5% to about 18% a metal oxide by weight of soil, about 5% to about 19% a metal oxide by weight of soil, about 5% to about 20% a metal oxide by weight of soil. In some embodiments, a composition comprises about 6% to about 7% of a metal oxide by weight of soil, about 6% to about 8% of a metal oxide by weight of soil, about 6% to about 9% of a metal oxide by weight of soil, about 6% to about 10% a metal oxide by weight of soil, about 6% to about 11% a metal oxide by weight of soil, about 6% to about 12% a metal oxide by weight of soil, about 6% to about 13% a metal oxide by weight of soil, about 6% to about 14% a metal oxide by weight of soil, about 6% to about 15% a metal oxide by weight of soil, about 6% to about 16% a metal oxide by weight of soil, about 6% to about 17% a metal oxide by weight of soil, about 6% to about 18% a metal oxide by weight of soil, about 6% to about 19% a metal oxide by weight of soil, about 6% to about 20% a metal oxide by weight of soil. In some embodiments, a composition comprises about 7% to about 8% of a metal oxide by weight of soil, about 7% to about 9% of a metal oxide by weight of soil, about 7% to about 10% a metal oxide by weight of soil, about 7% to about 11% a metal oxide by weight of soil, about 7% to about 12% a metal oxide by weight of soil, about 7% to about 13% a metal oxide by weight of soil, about 7% to about 14% a metal oxide by weight of soil, about 7% to about 15% a metal oxide by weight of soil, about 7% to about 16% a metal oxide by weight of soil, about 7% to about 17% a metal oxide by weight of soil, about 7% to about 18% a metal oxide by weight of soil, about 7% to about 19% a metal oxide by weight of soil, about 7% to about 20% a metal oxide by weight of soil. In some embodiments, a composition comprises about 8% to about 9% of a metal oxide by weight of soil, about 8% to about 10% a metal oxide by weight of soil, about 8% to about 11% a metal oxide by weight of soil, about 8% to about 12% a metal oxide by weight of soil, about 8% to about 13% a metal oxide by weight of soil, about 8% to about 14% a metal oxide by weight of soil, about 8% to about 15% a metal oxide by weight of soil, about 8% to about 16% a metal oxide by weight of soil, about 8% to about 17% a metal oxide by weight of soil, about 8% to about 18% a metal oxide by weight of soil, about 8% to about 19% a metal oxide by weight of soil, about 8% to about 20% a metal oxide by weight of soil. In some embodiments, a composition comprises about 9% to about 10% a metal oxide by weight of soil, about 9% to about 11% a metal oxide by weight of soil, about 9% to about 12% a metal oxide by weight of soil, about 9% to about 13% a metal oxide by weight of soil, about 9% to about 14% a metal oxide by weight of soil, about 9% to about 15% a metal oxide by weight of soil, about 9% to about 16% a metal oxide by weight of soil, about 9% to about 17% a metal oxide by weight of soil, about 9% to about 18% a metal oxide by weight of soil, about 9% to about 19% a metal oxide by weight of soil, about 9% to about 20% a metal oxide by weight of soil. In some embodiments, a composition comprises about 10% to about 11% a metal oxide by weight of soil, about 10% to about 12% a metal oxide by weight of soil, about 10% to about 13% a metal oxide by weight of soil, about 10% to about 14% a metal oxide by weight of soil, about 10% to about 15% a metal oxide by weight of soil, about 10% to about 16% a metal oxide by weight of soil, about 10% to about 17% a metal oxide by weight of soil, about 10% to about 18% a metal oxide by weight of soil, about 10% to about 19% a metal oxide by weight of soil, about 10% to about 20% a metal oxide by weight of soil. In some embodiments, a composition comprises about 11% to about 12% a metal oxide by weight of soil, about 11% to about 13% a metal oxide by weight of soil, about 11% to about 14% a metal oxide by weight of soil, about 11% to about 15% a metal oxide by weight of soil, about 11% to about 16% a metal oxide by weight of soil, about 11% to about 17% a metal oxide by weight of soil, about 11% to about 18% a metal oxide by weight of soil, about 11% to about 19% a metal oxide by weight of soil, about 11% to about 20% a metal oxide by weight of soil. In some embodiments, a composition comprises about 12% to about 13% a metal oxide by weight of soil, about 12% to about 14% a metal oxide by weight of soil, about 12% to about 15% a metal oxide by weight of soil, about 12% to about 16% a metal oxide by weight of soil, about 12% to about 17% a metal oxide by weight of soil, about 12% to about 18% a metal oxide by weight of soil, about 12% to about 19% a metal oxide by weight of soil, about 12% to about 20% a metal oxide by weight of soil. In some embodiments, a composition comprises about 13% to about 14% a metal oxide by weight of soil, about 13% to about 15% a metal oxide by weight of soil, about 13% to about 16% a metal oxide by weight of soil, about 13% to about 17% a metal oxide by weight of soil, about 13% to about 18% a metal oxide by weight of soil, about 13% to about 19% a metal oxide by weight of soil, about 13% to about 20% a metal oxide by weight of soil. In some embodiments, a composition comprises about 14% to about 15% a metal oxide by weight of soil, about 14% to about 16% a metal oxide by weight of soil, about 14% to about 17% a metal oxide by weight of soil, about 14% to about 18% a metal oxide by weight of soil, about 14% to about 19% a metal oxide by weight of soil, about 14% to about 20% a metal oxide by weight of soil. In some embodiments, a composition comprises about 15% to about 16% a metal oxide by weight of soil, about 15% to about 17% a metal oxide by weight of soil, about 15% to about 18% a metal oxide by weight of soil, about 15% to about 19% a metal oxide by weight of soil, about 15% to about 20% a metal oxide by weight of soil. In some embodiments, a composition comprises about 16% to about 17% a metal oxide by weight of soil, about 16% to about 18% a metal oxide by weight of soil, about 16% to about 19% a metal oxide by weight of soil, about 16% to about 20% a metal oxide by weight of soil. In some embodiments, a composition comprises about 17% to about 18% a metal oxide by weight of soil, about 17% to about 19% a metal oxide by weight of soil, about 17% to about 20% a metal oxide by weight of soil. In some embodiments, a composition comprises about 18% to about 19% a metal oxide by weight of soil, about 18% to about 20% a metal oxide by weight of soil. In some embodiments, a composition comprises about 19% to about 20% a metal oxide by weight of soil.

In some embodiments, a composition comprises about 3% of a metal oxide by weight of soil, about 4% a metal oxide by weight of soil, about 5% a metal oxide by weight of soil, about 6% a metal oxide by weight of soil, about 7% a metal oxide by weight of soil, a about 8% a metal oxide by weight of soil, about 9% a metal oxide by weigh of soil, about 10% a metal oxide by weight of soil, about 11% a metal oxide by weight of soil, about 12% a metal oxide by weight of soil, about 13% a metal oxide by weight of soil, about 14% a metal oxide by weight of soil, about 15% a metal oxide by weight of soil, about 16% a metal oxide by weight of soil, about 17% a metal oxide by weight of soil, about 18% a metal oxide by weight of soil, about 19% a metal oxide by weight of soil, about 20% a metal oxide by weight of soil.

### Metal Hydroxide

In accordance with various embodiments, one or more metal hydroxide is compatible with provided methods. In some embodiments, a composition comprises calcium hydroxide and/or magnesium hydroxide. In some embodiments, a composition comprises Ca(OH)₂ (“hydrated lime” or “slacked lime”; herein also referred to a “lime”), Mg(OH)₂ (“brucite”), and/or combinations thereof. In some embodiments, a composition comprises a metal hydroxide selected from the group consisting of Ca(OH)₂, Mg(OH)₂, and combination thereof.

In some embodiments, a metal hydroxide is or comprises Ca(OH)₂ (herein also referred to a “lime”). In some embodiments, a metal hydroxide is or comprises Mg(OH)₂.

In some embodiments, a composition comprises about 3% to about 4% of a metal hydroxide by weight of soil, about 3% to about 5% of a metal hydroxide by weight of soil, about 3% to about 6% of a metal hydroxide by weight of soil, about 3% to about 7% of a metal hydroxide by weight of soil, about 3% to about 8% of a metal hydroxide by weight of soil, about 3% to about 9% of a metal hydroxide by weight of soil, about 3% to about 10% a metal hydroxide by weight of soil, about 3% to about 11% a metal hydroxide by weight of soil, about 3% to about 12% a metal hydroxide by weight of soil, about 3% to about 13% a metal hydroxide by weight of soil, about 3% to about 14% a metal hydroxide by weight of soil, about 3% to about 15% a metal hydroxide by weight of soil, about 3% to about 16% a metal hydroxide by weight of soil, about 3% to about 17% a metal hydroxide by weight of soil, about 3% to about 18% a metal hydroxide by weight of soil, about 3% to about 19% a metal hydroxide by weight of soil, about 3% to about 20% a metal hydroxide by weight of soil. In some embodiments, a composition comprises about 4% to about 5% of a metal hydroxide by weight of soil, about 4% to about 6% of a metal hydroxide by weight of soil, about 4% to about 7% of a metal hydroxide by weight of soil, about 4% to about 8% of a metal hydroxide by weight of soil, about 4% to about 9% of a metal hydroxide by weight of soil, about 4% to about 10% a metal hydroxide by weight of soil, about 4% to about 11% a metal hydroxide by weight of soil, about 4% to about 12% a metal hydroxide by weight of soil, about 4% to about 13% a metal hydroxide by weight of soil, about 4% to about 14% a metal hydroxide by weight of soil, about 4% to about 15% a metal hydroxide by weight of soil, about 4% to about 16% a metal hydroxide by weight of soil, about 4% to about 17% a metal hydroxide by weight of soil, about 4% to about 18% a metal hydroxide by weight of soil, about 4% to about 19% a metal hydroxide by weight of soil, about 4% to about 20% a metal hydroxide by weight of soil. In some embodiments, a composition comprises about 5% to about 6% of a metal hydroxide by weight of soil, about 5% to about 7% of a metal hydroxide by weight of soil, about 5% to about 8% of a metal hydroxide by weight of soil, about 5% to about 9% of a metal hydroxide by weight of soil, about 5% to about 10% a metal hydroxide by weight of soil, about 5% to about 11% a metal hydroxide by weight of soil, about 5% to about 12% a metal hydroxide by weight of soil, about 5% to about 13% a metal hydroxide by weight of soil, about 5% to about 14% a metal hydroxide by weight of soil, about 5% to about 15% a metal hydroxide by weight of soil, about 5% to about 16% a metal hydroxide by weight of soil, about 5% to about 17% a metal hydroxide by weight of soil, about 5% to about 18% a metal hydroxide by weight of soil, about 5% to about 19% a metal hydroxide by weight of soil, about 5% to about 20% a metal hydroxide by weight of soil. In some embodiments, a composition comprises about 6% to about 7% of a metal hydroxide by weight of soil, about 6% to about 8% of a metal hydroxide by weight of soil, about 6% to about 9% of a metal hydroxide by weight of soil, about 6% to about 10% a metal hydroxide by weight of soil, about 6% to about 11% a metal hydroxide by weight of soil, about 6% to about 12% a metal hydroxide by weight of soil, about 6% to about 13% a metal hydroxide by weight of soil, about 6% to about 14% a metal hydroxide by weight of soil, about 6% to about 15% a metal hydroxide by weight of soil, about 6% to about 16% a metal hydroxide by weight of soil, about 6% to about 17% a metal hydroxide by weight of soil, about 6% to about 18% a metal hydroxide by weight of soil, about 6% to about 19% a metal hydroxide by weight of soil, about 6% to about 20% a metal hydroxide by weight of soil. In some embodiments, a composition comprises about 7% to about 8% of a metal hydroxide by weight of soil, about 7% to about 9% of a metal hydroxide by weight of soil, about 7% to about 10% a metal hydroxide by weight of soil, about 7% to about 11% a metal hydroxide by weight of soil, about 7% to about 12% a metal hydroxide by weight of soil, about 7% to about 13% a metal hydroxide by weight of soil, about 7% to about 14% a metal hydroxide by weight of soil, about 7% to about 15% a metal hydroxide by weight of soil, about 7% to about 16% a metal hydroxide by weight of soil, about 7% to about 17% a metal hydroxide by weight of soil, about 7% to about 18% a metal hydroxide by weight of soil, about 7% to about 19% a metal hydroxide by weight of soil, about 7% to about 20% a metal hydroxide by weight of soil. In some embodiments, a composition comprises about 8% to about 9% of a metal hydroxide by weight of soil, about 8% to about 10% a metal hydroxide by weight of soil, about 8% to about 11% a metal hydroxide by weight of soil, about 8% to about 12% a metal hydroxide by weight of soil, about 8% to about 13% a metal hydroxide by weight of soil, about 8% to about 14% a metal hydroxide by weight of soil, about 8% to about 15% a metal hydroxide by weight of soil, about 8% to about 16% a metal hydroxide by weight of soil, about 8% to about 17% a metal hydroxide by weight of soil, about 8% to about 18% a metal hydroxide by weight of soil, about 8% to about 19% a metal hydroxide by weight of soil, about 8% to about 20% a metal hydroxide by weight of soil. In some embodiments, a composition comprises about 9% to about 10% a metal hydroxide by weight of soil, about 9% to about 11% a metal hydroxide by weight of soil, about 9% to about 12% a metal hydroxide by weight of soil, about 9% to about 13% a metal hydroxide by weight of soil, about 9% to about 14% a metal hydroxide by weight of soil, about 9% to about 15% a metal hydroxide by weight of soil, about 9% to about 16% a metal hydroxide by weight of soil, about 9% to about 17% a metal hydroxide by weight of soil, about 9% to about 18% a metal hydroxide by weight of soil, about 9% to about 19% a metal hydroxide by weight of soil, about 9% to about 20% a metal hydroxide by weight of soil. In some embodiments, a composition comprises about 10% to about 11% a metal hydroxide by weight of soil, about 10% to about 12% a metal hydroxide by weight of soil, about 10% to about 13% a metal hydroxide by weight of soil, about 10% to about 14% a metal hydroxide by weight of soil, about 10% to about 15% a metal hydroxide by weight of soil, about 10% to about 16% a metal hydroxide by weight of soil, about 10% to about 17% a metal hydroxide by weight of soil, about 10% to about 18% a metal hydroxide by weight of soil, about 10% to about 19% a metal hydroxide by weight of soil, about 10% to about 20% a metal hydroxide by weight of soil. In some embodiments, a composition comprises about 11% to about 12% a metal hydroxide by weight of soil, about 11% to about 13% a metal hydroxide by weight of soil, about 11% to about 14% a metal hydroxide by weight of soil, about 11% to about 15% a metal hydroxide by weight of soil, about 11% to about 16% a metal hydroxide by weight of soil, about 11% to about 17% a metal hydroxide by weight of soil, about 11% to about 18% a metal hydroxide by weight of soil, about 11% to about 19% a metal hydroxide by weight of soil, about 11% to about 20% a metal hydroxide by weight of soil. In some embodiments, a composition comprises about 12% to about 13% a metal hydroxide by weight of soil, about 12% to about 14% a metal hydroxide by weight of soil, about 12% to about 15% a metal hydroxide by weight of soil, about 12% to about 16% a metal hydroxide by weight of soil, about 12% to about 17% a metal hydroxide by weight of soil, about 12% to about 18% a metal hydroxide by weight of soil, about 12% to about 19% a metal hydroxide by weight of soil, about 12% to about 20% a metal hydroxide by weight of soil. In some embodiments, a composition comprises about 13% to about 14% a metal hydroxide by weight of soil, about 13% to about 15% a metal hydroxide by weight of soil, about 13% to about 16% a metal hydroxide by weight of soil, about 13% to about 17% a metal hydroxide by weight of soil, about 13% to about 18% a metal hydroxide by weight of soil, about 13% to about 19% a metal hydroxide by weight of soil, about 13% to about 20% a metal hydroxide by weight of soil. In some embodiments, a composition comprises about 14% to about 15% a metal hydroxide by weight of soil, about 14% to about 16% a metal hydroxide by weight of soil, about 14% to about 17% a metal hydroxide by weight of soil, about 14% to about 18% a metal hydroxide by weight of soil, about 14% to about 19% a metal hydroxide by weight of soil, about 14% to about 20% a metal hydroxide by weight of soil. In some embodiments, a composition comprises about 15% to about 16% a metal hydroxide by weight of soil, about 15% to about 17% a metal hydroxide by weight of soil, about 15% to about 18% a metal hydroxide by weight of soil, about 15% to about 19% a metal hydroxide by weight of soil, about 15% to about 20% a metal hydroxide by weight of soil. In some embodiments, a composition comprises about 16% to about 17% a metal hydroxide by weight of soil, about 16% to about 18% a metal hydroxide by weight of soil, about 16% to about 19% a metal hydroxide by weight of soil, about 16% to about 20% a metal hydroxide by weight of soil. In some embodiments, a composition comprises about 17% to about 18% a metal hydroxide by weight of soil, about 17% to about 19% a metal hydroxide by weight of soil, about 17% to about 20% a metal hydroxide by weight of soil. In some embodiments, a composition comprises about 18% to about 19% a metal hydroxide by weight of soil, about 18% to about 20% a metal hydroxide by weight of soil. In some embodiments, a composition comprises about 19% to about 20% a metal hydroxide by weight of soil.

In some embodiments, a composition comprises about 3% of a metal hydroxide by weight of soil, about 4% a metal hydroxide by weight of soil, about 5% a metal hydroxide by weight of soil, about 6% a metal hydroxide by weight of soil, about 7% a metal hydroxide by weight of soil, about 8% a metal hydroxide by weight of soil, about 9% a metal hydroxide by weigh of soil, about 10% a metal hydroxide by weight of soil, about 11% a metal hydroxide by weight of soil, about 12% a metal hydroxide by weight of soil, about 13% a metal hydroxide by weight of soil, about 14% a metal hydroxide by weight of soil, about 15% a metal hydroxide by weight of soil, about 16% a metal hydroxide by weight of soil, about 17% a metal hydroxide by weight of soil, about 18% a metal hydroxide by weight of soil, about 19% a metal hydroxide by weight of soil, about 20% a metal hydroxide by weight of soil.

Any of a variety of amounts of a metal hydroxide, or other application appropriate substance (e.g., lime) is compatible with provided methods. In some embodiments, a composition comprises about 3% to about 4% of lime by weight of soil, about 3% to about 5% of lime by weight of soil, about 3% to about 6% of lime by weight of soil, about 3% to about 7% of lime by weight of soil, about 3% to about 8% of lime by weight of soil, about 3% to about 9% of lime by weight of soil, about 3% to about 10% lime by weight of soil, about 3% to about 11% lime by weight of soil, about 3% to about 12% lime by weight of soil, about 3% to about 13% lime by weight of soil, about 3% to about 14% lime by weight of soil, about 3% to about 15% lime by weight of soil, about 3% to about 16% lime by weight of soil, about 3% to about 17% lime by weight of soil, about 3% to about 18% lime by weight of soil, about 3% to about 19% lime by weight of soil, about 3% to about 20% lime by weight of soil. In some embodiments, a composition comprises about 4% to about 5% of lime by weight of soil, about 4% to about 6% of lime by weight of soil, about 4% to about 7% of lime by weight of soil, about 4% to about 8% of lime by weight of soil, about 4% to about 9% of lime by weight of soil, about 4% to about 10% lime by weight of soil, about 4% to about 11% lime by weight of soil, about 4% to about 12% lime by weight of soil, about 4% to about 13% lime by weight of soil, about 4% to about 14% lime by weight of soil, about 4% to about 15% lime by weight of soil, about 4% to about 16% lime by weight of soil, about 4% to about 17% lime by weight of soil, about 4% to about 18% lime by weight of soil, about 4% to about 19% lime by weight of soil, about 4% to about 20% lime by weight of soil. In some embodiments, a composition comprises about 5% to about 6% of lime by weight of soil, about 5% to about 7% of lime by weight of soil, about 5% to about 8% of lime by weight of soil, about 5% to about 9% of lime by weight of soil, about 5% to about 10% lime by weight of soil, about 5% to about 11% lime by weight of soil, about 5% to about 12% lime by weight of soil, about 5% to about 13% lime by weight of soil, about 5% to about 14% lime by weight of soil, about 5% to about 15% lime by weight of soil, about 5% to about 16% lime by weight of soil, about 5% to about 17% lime by weight of soil, about 5% to about 18% lime by weight of soil, about 5% to about 19% lime by weight of soil, about 5% to about 20% lime by weight of soil. In some embodiments, a composition comprises about 6% to about 7% of lime by weight of soil, about 6% to about 8% of lime by weight of soil, about 6% to about 9% of lime by weight of soil, about 6% to about 10% lime by weight of soil, about 6% to about 11% lime by weight of soil, about 6% to about 12% lime by weight of soil, about 6% to about 13% lime by weight of soil, about 6% to about 14% lime by weight of soil, about 6% to about 15% lime by weight of soil, about 6% to about 16% lime by weight of soil, about 6% to about 17% lime by weight of soil, about 6% to about 18% lime by weight of soil, about 6% to about 19% lime by weight of soil, about 6% to about 20% lime by weight of soil. In some embodiments, a composition comprises about 7% to about 8% of lime by weight of soil, about 7% to about 9% of lime by weight of soil, about 7% to about 10% lime by weight of soil, about 7% to about 11% lime by weight of soil, about 7% to about 12% lime by weight of soil, about 7% to about 13% lime by weight of soil, about 7% to about 14% lime by weight of soil, about 7% to about 15% lime by weight of soil, about 7% to about 16% lime by weight of soil, about 7% to about 17% lime by weight of soil, about 7% to about 18% lime by weight of soil, about 7% to about 19% lime by weight of soil, about 7% to about 20% lime by weight of soil. In some embodiments, a composition comprises about 8% to about 9% of lime by weight of soil, about 8% to about 10% lime by weight of soil, about 8% to about 11% lime by weight of soil, about 8% to about 12% lime by weight of soil, about 8% to about 13% lime by weight of soil, about 8% to about 14% lime by weight of soil, about 8% to about 15% lime by weight of soil, about 8% to about 16% lime by weight of soil, about 8% to about 17% lime by weight of soil, about 8% to about 18% lime by weight of soil, about 8% to about 19% lime by weight of soil, about 8% to about 20% lime by weight of soil. In some embodiments, a composition comprises about 9% to about 10% lime by weight of soil, about 9% to about 11% lime by weight of soil, about 9% to about 12% lime by weight of soil, about 9% to about 13% lime by weight of soil, about 9% to about 14% lime by weight of soil, about 9% to about 15% lime by weight of soil, about 9% to about 16% lime by weight of soil, about 9% to about 17% lime by weight of soil, about 9% to about 18% lime by weight of soil, about 9% to about 19% lime by weight of soil, about 9% to about 20% lime by weight of soil. In some embodiments, a composition comprises about 10% to about 11% lime by weight of soil, about 10% to about 12% lime by weight of soil, about 10% to about 13% lime by weight of soil, about 10% to about 14% lime by weight of soil, about 10% to about 15% lime by weight of soil, about 10% to about 16% lime by weight of soil, about 10% to about 17% lime by weight of soil, about 10% to about 18% lime by weight of soil, about 10% to about 19% lime by weight of soil, about 10% to about 20% lime by weight of soil. In some embodiments, a composition comprises about 11% to about 12% lime by weight of soil, about 11% to about 13% lime by weight of soil, about 11% to about 14% lime by weight of soil, about 11% to about 15% lime by weight of soil, about 11% to about 16% lime by weight of soil, about 11% to about 17% lime by weight of soil, about 11% to about 18% lime by weight of soil, about 11% to about 19% lime by weight of soil, about 11% to about 20% lime by weight of soil. In some embodiments, a composition comprises about 12% to about 13% lime by weight of soil, about 12% to about 14% lime by weight of soil, about 12% to about 15% lime by weight of soil, about 12% to about 16% lime by weight of soil, about 12% to about 17% lime by weight of soil, about 12% to about 18% lime by weight of soil, about 12% to about 19% lime by weight of soil, about 12% to about 20% lime by weight of soil. In some embodiments, a composition comprises about 13% to about 14% lime by weight of soil, about 13% to about 15% lime by weight of soil, about 13% to about 16% lime by weight of soil, about 13% to about 17% lime by weight of soil, about 13% to about 18% lime by weight of soil, about 13% to about 19% lime by weight of soil, about 13% to about 20% lime by weight of soil. In some embodiments, a composition comprises about 14% to about 15% lime by weight of soil, about 14% to about 16% lime by weight of soil, about 14% to about 17% lime by weight of soil, about 14% to about 18% lime by weight of soil, about 14% to about 19% lime by weight of soil, about 14% to about 20% lime by weight of soil. In some embodiments, a composition comprises about 15% to about 16% lime by weight of soil, about 15% to about 17% lime by weight of soil, about 15% to about 18% lime by weight of soil, about 15% to about 19% lime by weight of soil, about 15% to about 20% lime by weight of soil. In some embodiments, a composition comprises about 16% to about 17% lime by weight of soil, about 16% to about 18% lime by weight of soil, about 16% to about 19% lime by weight of soil, about 16% to about 20% lime by weight of soil. In some embodiments, a composition comprises about 17% to about 18% lime by weight of soil, about 17% to about 19% lime by weight of soil, about 17% to about 20% lime by weight of soil. In some embodiments, a composition comprises about 18% to about 19% lime by weight of soil, about 18% to about 20% lime by weight of soil. In some embodiments, a composition comprises about 19% to about 20% lime by weight of soil.

In some embodiments, a composition comprises about 3% of lime by weight of soil, about 4% lime by weight of soil, about 5% lime by weight of soil, about 6% lime by weight of soil, about 7% lime by weight of soil, about 8% lime by weight of soil, about 9% lime by weigh of soil, about 10% lime by weight of soil, about 11% lime by weight of soil, about 12% lime by weight of soil, about 13% lime by weight of soil, about 14% lime by weight of soil, about 15% lime by weight of soil, about 16% lime by weight of soil, about 17% lime by weight of soil, about 18% lime by weight of soil, about 19% lime by weight of soil, about 20% lime by weight of soil.

### Water Content

In some embodiments, a composition comprises water. In some embodiments, a composition comprises an amount of water by weight of soil and/or lime. In some embodiments, a composition comprises about 5% to about 10% water, about 5% to about 15% water, about 5% to about 20% water about 5% to about 25% water, about 5% to about 30% water, about 5% to about 35% water, about 5% to about 40% water, about 5% to about 45% water, about 5% to about 50% water. In some embodiments, a composition comprises about 10% to about 15% water, about 10% to about 20% water about 10% to about 25% water, about 10% to about 30% water, about 10% to about 35% water, about 10% to about 40% water, about 10% to about 45% water, about 10% to about 50% water. In some embodiments, a composition comprises about 15% to about 20% water about 15% to about 25% water, about 15% to about 30% water, about 15% to about 35% water, about 15% to about 40% water, about 15% to about 45% water, about 15% to about 50% water. In some embodiments, a composition comprises about 20% to about 25% water, about 20% to about 30% water, about 20% to about 35% water, about 20% to about 40% water, about 20% to about 45% water, about 20% to about 50% water. In some embodiments, a composition comprises about 25% to about 30% water, about 25% to about 35% water, about 25% to about 40% water, about 25% to about 45% water, about 25% to about 50% water. In some embodiments, a composition comprises about 30% to about 35% water, about 30% to about 40% water, about 30% to about 45% water, about 30% to about 50% water. In some embodiments, a composition comprises about 35% to about 40% water, about 35% to about 45% water, about 35% to about 50% water. In some embodiments, a composition comprises about 40% to about 45% water, about 40% to about 50% water. In some embodiments, a composition comprises about 45% to about 50% water.

In some embodiments, a composition comprises about 5% water, about 10% water, about 15% water, about 20% water about 25% water, about 30% water, about 35% water, about 40% water, about 45% water, about 50% water.

### State Parameters

In certain embodiments, the present disclosure encompasses a recognition that certain state (e.g. phase) parameters may be advantageous for methods described herein.

### Air Content

In accordance with various embodiments, it can be advantageous to apply provided methods to soil with a certain air content (e.g. to allow for formation and/or maintenance of a continuous gas phase). In some embodiments, a composition has a certain air content prior to contact with CO₂ (e.g. an initial air content to allow for formation and/or maintenance of a continuous gas phase). In some embodiments, a composition has a certain air content during contact with CO₂ (e.g. an air content during contact with CO₂ to allow for maintenance of a continuous gas phase).

In some embodiments, a composition in accordance with the present disclosure has a volumetric air (θₐ) content of about 5% to about 10%, about 5% to about 15%, about 5% to about 20%, about 5% to about 25%, about 5% to about 30%, about 5% to about 35%, about 5% to about 40%, about 5% to about 45%, about 5% to about 50%. In some embodiments, a composition has a volumetric air content of about 10% to about 15%, about 10% to about 20%, about 10% to about 25%, about 10% to about 30%, about 10% to about 35%, about 10% to about 40%, about 10% to about 45%, about 10% to about 50%. In some embodiments, a composition has a volumetric air content of about 15% to about 20%, about 15% to about 25%, about 15% to about 30%, about 15% to about 35%, about 15% to about 40%, about 15% to about 45%, about 15% to about 50%. In some embodiments, a composition has a volumetric air content of about 20% to about 25%, about 20% to about 30%, about 20% to about 35%, about 20% to about 40%, about 20% to about 45%, about 20% to about 50%. In some embodiments, a composition has a volumetric air content of about 25% to about 30%, about 25% to about 35%, about 25% to about 40%, about 25% to about 45%, about 25% to about 50%. In some embodiments, a composition has a volumetric air content of about 30% to about 35%, about 30% to about 40%, about 30% to about 45%, about 30% to about 50%. In some embodiments, a composition has a volumetric air content of about 35% to about 40%, about 35% to about 45%, about 35% to about 50%. In some embodiments, a composition has a volumetric air content of about 40% to about 45%, about 40% to about 50%. In some embodiments, a composition has a volumetric air content of about 45% to about 50%. In some embodiments, a composition has a volumetric air content of about 5%, about 10%, about 15%, about 20%, about 25%, about 30%, about 35%, about 40%, about 45%, about 50%.

In some embodiments, a composition in accordance with the present disclosure has a volumetric air (ea) content of about 5% to about 10%, about 5% to about 15%, about 5% to about 20%, about 5% to about 25%, about 5% to about 30%, about 5% to about 35%, about 5% to about 40%, about 5% to about 45%, about 5% to about 50% prior to contact with CO₂. In some embodiments, a composition has a volumetric air content of about 10% to about 15%, about 10% to about 20%, about 10% to about 25%, about 10% to about 30%, about 10% to about 35%, about 10% to about 40%, about 10% to about 45%, about 10% to about 50% prior to contact with CO₂. In some embodiments, a composition has a volumetric air content of about 15% to about 20%, about 15% to about 25%, about 15% to about 30%, about 15% to about 35%, about 15% to about 40%, about 15% to about 45%, about 15% to about 50% prior to contact with CO₂. In some embodiments, a composition has a volumetric air content of about 20% to about 25%, about 20% to about 30%, about 20% to about 35%, about 20% to about 40%, about 20% to about 45%, about 20% to about 50% prior to contact with CO₂. In some embodiments, a composition has a volumetric air content of about 25% to about 30%, about 25% to about 35%, about 25% to about 40%, about 25% to about 45%, about 25% to about 50% prior to contact with CO₂. In some embodiments, a composition has a volumetric air content of about 30% to about 35%, about 30% to about 40%, about 30% to about 45%, about 30% to about 50% prior to contact with CO₂. In some embodiments, a composition has a volumetric air content of about 35% to about 40%, about 35% to about 45%, about 35% to about 50% prior to contact with CO₂. In some embodiments, a composition has a volumetric air content of about 40% to about 45%, about 40% to about 50% prior to contact with CO₂. In some embodiments, a composition has a volumetric air content of about 45% to about 50% prior to contact with CO₂. In some embodiments, a composition has a volumetric air content of about 5%, about 10%, about 15%, about 20%, about 25%, about 30%, about 35%, about 40%, about 45%, about 50% prior to contact with CO₂.

### Void Ratio

In accordance with various embodiments, it can be advantageous to apply provided methods to soil with a certain void ratio (e.g. to allow for formation and/or maintenance of a continuous gas phase). In some embodiments, a composition has a certain void ratio prior to contact with CO₂ (e.g. an initial void ratio to allow for formation and/or maintenance of a continuous gas phase). In some embodiments, a composition has a certain void ratio during contact with CO₂ (e.g. n void ratio during contact with CO₂ to allow for maintenance of a continuous gas phase).

In some embodiments, a composition in accordance with the present disclosure has a void ratio (e) of about 0.3 to about 0.4, about 0.3 to about 0.5, about 0.3 to about 0.6, about 0.3 to about 0.7, about 0.3 to about 0.8, about 0.3 to about 0.9, about 0.3 to about 1.0, about 0.3 to about 1.1, about 0.3 to about 1.2, about 0.3 to about 1.3, about 0.3 to about 1.4, about 0.3 to about 1.5, about 0.3 to about 1.6, about 0.3 to about 1.7, about 0.3 to about 1.8, about 0.3 to about 1.9, about 0.3 to about 2.0. In some embodiments, a composition has a void ratio (e) of about 0.4 to about 0.5, about 0.4 to about 0.6, about 0.4 to about 0.7, about 0.4 to about 0.8, about 0.4 to about 0.9, about 0.4 to about 1.0, about 0.4 to about 1.1, about 0.4 to about 1.2, about 0.4 to about 1.3, about 0.4 to about 1.4, about 0.4 to about 1.5, about 0.4 to about 1.6, about 0.4 to about 1.7, about 0.4 to about 1.8, about 0.4 to about 1.9, about 0.4 to about 2.0. In some embodiments, a composition has a void ratio (e) of about 0.5 to about 0.6, about 0.5 to about 0.7, about 0.5 to about 0.8, about 0.5 to about 0.9, about 0.5 to about 1.0, about 0.5 to about 1.1, about 0.5 to about 1.2, about 0.5 to about 1.3, about 0.5 to about 1.4, about 0.5 to about 1.5, about 0.5 to about 1.6, about 0.5 to about 1.7, about 0.5 to about 1.8, about 0.5 to about 1.9, about 0.5 to about 2.0. In some embodiments, a composition has a void ratio (e) of about 0.6 to about 0.7, about 0.6 to about 0.8, about 0.6 to about 0.9, about 0.6 to about 1.0, about 0.6 to about 1.1, about 0.6 to about 1.2, about 0.6 to about 1.3, about 0.6 to about 1.4, about 0.6 to about 1.5, about 0.6 to about 1.6, about 0.6 to about 1.7, about 0.6 to about 1.8, about 0.6 to about 1.9, about 0.6 to about 2.0. In some embodiments, a composition has a void ratio (e) of about 0.7 to about 0.8, about 0.7 to about 0.9, about 0.7 to about 1.0, about 0.7 to about 1.1, about 0.7 to about 1.2, about 0.7 to about 1.3, about 0.7 to about 1.4, about 0.7 to about 1.5, about 0.7 to about 1.6, about 0.7 to about 1.7, about 0.7 to about 1.8, about 0.7 to about 1.9, about 0.7 to about 2.0. In some embodiments, a composition has a void ratio (e) of about 0.8 to about 0.9, about 0.8 to about 1.0, about 0.8 to about 1.1, about 0.8 to about 1.2, about 0.8 to about 1.3, about 0.8 to about 1.4, about 0.8 to about 1.5, about 0.8 to about 1.6, about 0.8 to about 1.7, about 0.8 to about 1.8, about 0.8 to about 1.9, about 0.8 to about 2.0. In some embodiments, a composition has a void ratio (e) of about 0.9 to about 1.0, about 0.9 to about 1.1, about 0.9 to about 1.2, about 0.9 to about 1.3, about 0.9 to about 1.4, about 0.9 to about 1.5, about 0.9 to about 1.6, about 0.9 to about 1.7, about 0.9 to about 1.8, about 0.9 to about 1.9, about 0.9 to about 2.0. In some embodiments, a composition has a void ratio (e) of about 1.0 to about 1.1, about 1.0 to about 1.2, about 1.0 to about 1.3, about 1.0 to about 1.4, about 1.0 to about 1.5, about 1.0 to about 1.6, about 1.0 to about 1.7, about 1.0 to about 1.8, about 1.0 to about 1.9, about 1.0 to about 2.0. In some embodiments, a composition has a void ratio (e) of about 1.1 to about 1.2, about 1.1 to about 1.3, about 1.1 to about 1.4, about 1.1 to about 1.5, about 1.1 to about 1.6, about 1.1 to about 1.7, about 1.1 to about 1.8, about 1.1 to about 1.9, about 1.1 to about 2.0. In some embodiments, a composition has a void ratio (e) of about 1.2 to about 1.3, about 1.2 to about 1.4, about 1.2 to about 1.5, about 1.2 to about 1.6, about 1.2 to about 1.7, about 1.2 to about 1.8, about 1.2 to about 1.9, about 1.2 to about 2.0. In some embodiments, a composition has a void ratio (e) of about 1.3 to about 1.4, about 1.3 to about 1.5, about 1.3 to about 1.6, about 1.3 to about 1.7, about 1.3 to about 1.8, about 1.3 to about 1.9, about 1.3 to about 2.0. In some embodiments, a composition has a void ratio (e) of about 1.4 to about 1.5, about 1.4 to about 1.6, about 1.4 to about 1.7, about 1.4 to about 1.8, about 1.4 to about 1.9, about 1.4 to about 2.0. In some embodiments, a composition has a void ratio (e) of about 1.5 to about 1.6, about 1.5 to about 1.7, about 1.5 to about 1.8, about 1.5 to about 1.9, about 1.5 to about 2.0. In some embodiments, a composition has a void ratio (e) of about 1.6 to about 1.7, about 1.6 to about 1.8, about 1.6 to about 1.9, about 1.6 to about 2.0. In some embodiments, a composition has a void ratio (e) of about 1.7 to about 1.8, about 1.7 to about 1.9, about 1.7 to about 2.0. In some embodiments, a composition has a void ratio (e) of about 1.8 to about 1.9, about 1.8 to about 2.0. In some embodiments, a composition has a void ratio (e) of about 1.9 to about 2.0. In some embodiments, a composition has a void ratio (e) of about 1.2 to about 1.3, about 1.2 to about 1.4, about 1.2 to about 1.5, about 1.2 to about 1.6, about 1.2 to about 1.7, about 1.2 to about 1.8, about 1.2 to about 1.9, about 1.2 to about 2.0. In some embodiments, a composition has a void ratio (e) of about 1.2 to about 1.3, about 1.2 to about 1.4, about 1.2 to about 1.5, about 1.2 to about 1.6, about 1.2 to about 1.7, about 1.2 to about 1.8, about 1.2 to about 1.9, about 1.2 to about 2.0. In some embodiments, a composition has a void ratio (e) of about 1.2 to about 1.3, about 1.2 to about 1.4, about 1.2 to about 1.5, about 1.2 to about 1.6, about 1.2 to about 1.7, about 1.2 to about 1.8, about 1.2 to about 1.9, about 1.2 to about 2.0. In some embodiments, a composition has a void ratio (i.e. density) of about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0.

In some embodiments, a composition comprising sand, lime, and water has a void ratio (e) of about 0.3 to about 0.4, about 0.3 to about 0.5, about 0.3 to about 0.6, about 0.3 to about 0.7, about 0.3 to about 0.8, about 0.3 to about 0.9. In some embodiments, a composition comprising sand, lime, and water has a void ratio (i.e. density) of about 0.4 to about 0.5, about 0.4 to about 0.6, about 0.4 to about 0.7, about 0.4 to about 0.8, about 0.4 to about 0.9. In some embodiments, a composition comprising sand, lime, and water has a void ratio (e) of about 0.5 to about 0.6, about 0.5 to about 0.7, about 0.5 to about 0.8, about 0.5 to about 0.9. In some embodiments, a composition comprising sand, lime, and water has a void ratio (e) of about 0.6 to about 0.7, about 0.6 to about 0.8, about 0.6 to about 0.9. In some embodiments, a composition comprising sand, lime, and water has a void ratio (e) of about 0.7 to about 0.8, about 0.7 to about 0.9. In some embodiments, a composition comprising sand, lime, and water has a void ratio (e) of about 0.8 to about 0.9. In some embodiments, a composition comprising sand, lime, and water has a void ratio (i.e. density) of about 0.4, about 0.5, about 0.6, about 0.7, about 0.8, about 0.9.

In some embodiments, a composition comprising silt, lime, and water has a void ratio (e) of about 0.6 to about 0.7, about 0.6 to about 0.8, about 0.6 to about 0.9, about 0.6 to about 1.0, about 0.6 to about 1.1, about 0.6 to about 1.2, about 0.6 to about 1.3. In some embodiments, a composition comprising silt, lime, and water has a void ratio (e) of about 0.7 to about 0.8, about 0.7 to about 0.9, about 0.7 to about 1.0, about 0.7 to about 1.1, about 0.7 to about 1.2, about 0.7 to about 1.3. In some embodiments, a composition comprising silt, lime, and water has a void ratio (e) of about 0.8 to about 0.9, about 0.8 to about 1.0, about 0.8 to about 1.1, about 0.8 to about 1.2, about 0.8 to about 1.3. In some embodiments, a composition comprising silt, lime, and water has a void ratio (e) of about 0.9 to about 1.0, about 0.9 to about 1.1, about 0.9 to about 1.2, about 0.9 to about 1.3. In some embodiments, a composition comprising silt, lime, and water has a void ratio (e) of about 1.0 to about 1.1, about 1.0 to about 1.2, about 1.0 to about 1.3. In some embodiments, a composition comprising silt, lime, and water has a void ratio (e) of about 1.1 to about 1.2, about 1.1 to about 1.3. In some embodiments, a composition comprising silt, lime, and water has a void ratio (e) of about 1.2 to about 1.3. In some embodiments, a composition comprising silt, lime, and water has a void ratio (i.e. density) of about 0.6, about 0.7, about 0.8, about 0.9, about 1.0, about 1.1, about 1.2, about 1.3.

### Degree of Saturation

In accordance with various embodiments, it can be advantageous to apply provided methods to soil with a certain degree of saturation (e.g. to allow for formation and/or maintenance of a continuous gas phase). In some embodiments, a composition has a certain degree of saturation prior to contact with CO₂ (e.g. an initial degree of saturation to allow for formation and/or maintenance of a continuous gas phase). In some embodiments, a composition has a certain degree of saturation during contact with CO₂ (e.g. a degree of saturation during contact with CO₂ to allow for maintenance of a continuous gas phase).

In some embodiments, a composition in accordance with the present disclosure has a degree of saturation of about 10% to about 15%, about 10% to about 20%, about 10% to about 25%, about 10% to about 30%, about 10% to about 35%, about 10% to about 40%, about 10% to about 45%, about 10% to about 50%, about 10% to about 55%, about 10% to about 60%, about 10% to about 65%, about 10% to about 70%, about 10% to about 75%, about 10% to about 80%. In some embodiments, a composition has a degree of saturation of about 15% to about 20%, about 15% to about 25%, about 15% to about 30%, about 15% to about 35%, about 15% to about 40%, about 15% to about 45%, about 15% to about 50%, about 15% to about 55%, about 15% to about 60%, about 15% to about 65%, about 15% to about 70%, about 15% to about 75%, about 15% to about 80%. In some embodiments, a composition has a degree of saturation of about 20% to about 25%, about 20% to about 30%, about 20% to about 35%, about 20% to about 40%, about 20% to about 45%, about 20% to about 50%, about 20% to about 55%, about 20% to about 60%, about 20% to about 65%, about 20% to about 70%, about 20% to about 75%, about 20% to about 80%. In some embodiments, a composition has a degree of saturation of about 25% to about 30%, about 25% to about 35%, about 25% to about 40%, about 25% to about 45%, about 25% to about 50%, about 25% to about 55%, about 25% to about 60%, about 25% to about 65%, about 25% to about 70%, about 25% to about 75%, about 25% to about 80%. In some embodiments, a composition has a degree of saturation of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%. In some embodiments, a composition has a degree of saturation of about 35% to about 40%, about 35% to about 45%, about 35% to about 50%, about 35% to about 55%, about 35% to about 60%, about 35% to about 65%, about 35% to about 70%, about 35% to about 75%, about 35% to about 80%. In some embodiments, a composition has a degree of saturation of about 40% to about 45%, about 40% to about 50%, about 40% to about 55%, about 40% to about 60%, about 40% to about 65%, about 40% to about 70%, about 40% to about 75%, about 40% to about 80%. In some embodiments, a composition has a degree of saturation of about 45% to about 50%, about 45% to about 55%, about 45% to about 60%, about 45% to about 65%, about 45% to about 70%, about 45% to about 75%, about 45% to about 80%. In some embodiments, a composition has a degree of saturation of about 50% to about 55%, about 55% to about 60%, about 50% to about 65%, about 50% to about 70%, about 50% to about 75%, about 50% to about 80%. In some embodiments, a composition has a degree of saturation of about 55% to about 60%, about 55% to about 65%, about 55% to about 70%, about 55% to about 75%, about 55% to about 80%. In some embodiments, a composition has a degree of saturation of about 60% to about 65%, about 60% to about 70%, about 60% to about 75%, about 60% to about 80%. In some embodiments, a composition has a degree of saturation of about 65% to about 70%, about 65% to about 75%, about 65% to about 80%. In some embodiments, a composition has a degree of saturation of about 70% to about 75%, about 70% to about 80%. In some embodiments, a composition has a degree of saturation of about 75% to about 80%.

In some embodiments, a composition has a degree of saturation of about 10%, about 15%, about 20%, about 25%, about 30%, about 35%, about 40%, about 45%, about 50%, about 55%, about 60%, about 65%, about 70%, about 75%, about 80%.

### Carbonation

In accordance with various embodiments, the present disclosure recognizes that it can be advantageous for a composition to be contacted with exogenous carbon dioxide at a composition surface (e.g. ground surface, subsurface) for a period of time sufficient to precipitate carbonate minerals in a composition. In some embodiments, a composition is contacted with exogenous carbon dioxide at a composition surface (e.g. ground surface, subsurface). In some embodiments, a composition is contacted with exogenous carbon dioxide closer to a targeted area, such that CO₂ can penetrate deeper into a composition (e.g., through a conduit formed through a portion of the soil).

### Pressure

In accordance with various embodiments, the present disclosure recognizes that it can be advantageous for a composition to be contacted with exogenous carbon dioxide sufficient to create and/or maintain a continuous gas phase. In some embodiments, exogenous carbon dioxide is applied under a constant pressure of about 1 to about 10 kPa. In some embodiments, exogenous carbon dioxide is applied under a constant pressure of about 1 to about 15 kPa. In some embodiments, exogenous carbon dioxide is applied under a constant pressure of about 1 to about 20 kPa. In some embodiments, exogenous carbon dioxide is applied under a constant pressure of about 1 to about 25 kPa. In some embodiments, exogenous carbon dioxide is applied under a constant pressure of about 1 to about 30 kPa. In some embodiments, exogenous carbon dioxide is applied under a constant pressure of about 1 to about 40 kPa. In some embodiments, exogenous carbon dioxide is applied under a constant pressure of about 1 to about 50 kPa. In some embodiments, exogenous carbon dioxide is applied under a constant pressure of about 1 to about 100 kPa. In some embodiments, exogenous carbon dioxide is applied under a constant pressure of about 1 to about 200 kPa. In some embodiments, exogenous carbon dioxide is applied under a constant pressure of about 1 to about 300 kPa. In some embodiments, exogenous carbon dioxide is applied under a constant pressure of about 1 to about 400 kPa. In some embodiments, exogenous carbon dioxide is applied under a constant pressure of about 1 to about 500 kPa. In some embodiments, exogenous carbon dioxide is applied under a constant pressure of about 1 kPa, about 5 kPa, about 10 kPa, about 15 kPa, about 20 kPa, about 25 kPa, about 30 kPa, about 35 kPa, about 40 kPa, about 45 kPa, about 50 kPa, about 60 kPa, about 70 kPa, about 80 kPa, about 90 kPa, about 100 kPa, about 200 kPa, about 300 kPa, about 400 Pa, about 500 kPa.

In some embodiments, exogenous carbon dioxide is applied under a constant pressure of less than about 5 kPa pressure. In some embodiments, exogenous carbon dioxide is applied under a constant pressure of less than about 4 kPa pressure. In some embodiments, exogenous carbon dioxide is applied under a constant pressure of less than about 3 kPa pressure. In some embodiments, exogenous carbon dioxide is applied under a constant pressure of less than about 2 kPa pressure. In some embodiments, exogenous carbon dioxide is applied under a constant pressure of less than about 1 kPa pressure. In some embodiments, exogenous carbon dioxide is applied under a pressure about atmospheric pressure.

### Duration

In accordance with various embodiments, the present disclosure recognizes that it can be advantageous for a composition to be contacted with exogenous carbon dioxide for a period of time sufficient to precipitate carbonate minerals in a composition. In some embodiments, a composition is contacted with exogenous carbon dioxide for about 2 hours and 72 hours, 2 hours and 100 hours, 2 hours and 200 hours, 2 hours and 300 hours. In some embodiments, a composition is contacted with exogenous carbon dioxide for at least 2 hours. In some embodiments, a composition is contacted with exogenous carbon dioxide for at least 24 hours. In some embodiments, a composition is contacted with exogenous carbon dioxide for at least 36 hours. In some embodiments, a composition is contacted with exogenous carbon dioxide for at least 48 hours. In some embodiments, a composition is contacted with exogenous carbon dioxide for at least 72 hours. In some embodiments, a composition is contacted with exogenous carbon dioxide for at least 96 hours. In some embodiments, a composition is contacted with exogenous carbon dioxide for at least 96 hours. In some embodiments, a composition is contacted with exogenous carbon dioxide for at least 120 hours. In some embodiments, a composition is contacted with exogenous carbon dioxide for at least 144 hours.

### Depth

In accordance with various embodiments, the present disclosure recognizes that it can be advantageous for a composition to be contacted with exogenous carbon dioxide for a period of time sufficient to precipitate carbonate minerals in a composition at a target depth. In some embodiments, a composition is contacted with exogenous carbon dioxide for a period of time sufficient to precipitate carbonate minerals in a composition at a depth of about 0 mm to about 50 mm, about 0 mm to 150 mm, about 0 mm to 200 mm, about 0 mm to about 250 mm, about 0 mm to about 300 mm, about 0 mm to about 350 mm, about 0 mm to about 400 mm, about 0 mm to about 450 mm, about 0 mm to about 500 mm, about 50 mm to about 150 mm, about 50 mm to about 200 mm, about 50 mm to about 250 mm, about 50 mm to about 300 mm, about 50 mm to about 350 mm, about 50 mm to about 400 mm, about 50 mm to about 450 mm, about 50 mm to about 500 mm, about 150 mm to about 200 mm, about 150 mm to about 250 mm, about 150 mm to about 300 mm, about 150 mm to about 350 mm, about 150 mm to about 400 mm, about 150 mm to about 450 mm, about 150 mm to about 500 mm, about 200 mm to about 250 mm, about 200 mm to about 300 mm, about 200 mm to about 350 mm, about 200 mm to about 400 mm, about 200 mm to about 450 mm, about 200 mm to about 500 mm, about 250 mm to about 300 mm, about 250 mm to about 350 mm, about 250 mm to about 400 mm, about 250 mm to about 450 mm, about 250 mm to about 500 mm, about 300 mm to about 350 mm, about 300 mm to about 400 mm, about 300 mm to about 450 mm, about 300 mm to about 500 mm, about 400 mm to about 450 mm, about 400 mm to about 500 mm, about 450 mm to about 500 mm, about 50 mm, about 100 mm, about 150 mm, about 200 mm, about 250 mm, about 300 mm, about 350 mm, about 400 mm, about 450 mm, about 500 mm

In some embodiments, a composition is contacted with exogenous carbon dioxide for a period of time sufficient to precipitate carbonate minerals in a composition at a depth of about 0 m to about 1 m, about 0 m to about 2 m, about 0 m to about 3 m, about 0 m to about 4 m, about 0 m to about 5 m, about 1 m to about 2 m, about 1 m to about 3 m, about 1 m to about 4 m, about 1 m to about 5 m, about 2 m to about 3 m, about 2 m to about 4 m, about 3 m to about 5 m, about 4 m to about 5 m, about 1 m, about 2 m, about 3 m, about 4 m, about 5 m.

### Characterization of Carbonated Compositions

In some embodiments, provided compositions may be characterized in order to determine changes in properties (e.g. physical and/or chemical).

### Mechanical Properties

In some embodiments, provided compositions may be characterized in order to determine, for example, mechanical properties. In some embodiments, a composition contacted with exogenous carbon dioxide has an increased strength as compared to a composition not contacted with exogenous carbon dioxide.

In some embodiments, a composition contacted with exogenous carbon dioxide has a California bearing ratio (CBR) of at least about 20%, 35%, 40%, 45%, 55%, 60%, 65%, 70%, 75%, 80%, 85%, 90%, 95%, 100%, 105%, or 110%. In some embodiments, a composition contacted with exogenous carbon dioxide has an increased California bearing ratio (CBR) as compared to a composition not contacted with exogenous carbon dioxide. In some embodiments, a composition contacted with exogenous carbon dioxide may exhibit an increased CBR of at least 1%, 5%, 10%, 20%, 50%, 100%, 200%, 300%, 400%, 500%, or greater as compared to a composition not contacted with exogenous carbon dioxide.

In some embodiments, a composition contacted with exogenous carbon dioxide has a sheer wave velocity of at least about 100 m/s, 200 m/s, 300 m/s, 400 m/s, 500 m/s, 600 m/s, 700 m/s, 800 m/s, 900 m/s, 1000 m/s, 1100 m/s, 1200 m/s, 1300 m/s, 1400 m/s, 1500 m/s. In some embodiments, a composition contacted with exogenous carbon dioxide has an increased sheer wave velocities as compared to a composition not contacted with exogenous carbon dioxide. In some embodiments, a composition contacted with exogenous carbon dioxide may exhibit an increased sheer wave velocities of at least 1%, 5%, 10%, 50%, 100%, 200%, 300%, 400%, 500%, or greater as compared to a composition not contacted with exogenous carbon dioxide.

In some embodiments, provided compositions may be characterized in that it has self-sensing ability (e.g., ability of a structural material to sense stress, strain, and/or temperature in it without the incorporation of any external sensor).

In some embodiments, standard testing (e.g. ASTM, 2014) can be used to determine content of a sample. In some embodiments, standard testing (e.g. ASTM, 2014) can be used to determine a relative amount of contents of a sample. In some embodiments, standard testing (e.g. ASTM, 2014) can be used to determine a relative amount of unreacted metal oxide and/or metal hydroxide (e.g., Ca(OH)₂) in a sample. In some embodiments, standard testing (e.g. ASTM, 2014) can be used to determine a relative amount of carbonate minerals (CaCO₃) in a sample. In some embodiments, a sample is or comprises soil.

### Industrial Applications

In certain embodiments, the present disclosure recognizes parameters for scaling accelerated soil stabilization using carbon dioxide. In some embodiments, the present disclosure provides methods for accelerating soil stabilization using carbon dioxide at a large-scale. In some embodiments, the present disclosure provides methods for accelerating soil stabilization using carbon dioxide in a field setting. In some embodiments, the present disclosure provides methods for accelerating soil stabilization using carbon dioxide in a non-laboratory setting.

### Construction

In some certain embodiments, the present disclosure provides methods that are applicability to many technological fields and industries. For example, in some embodiments, methods provided herein stabilize subgrade soil. In some embodiments, methods provided herein stabilize subgrade soil for roadway construction.

In some embodiments, methods provided herein stabilize subgrade soil for pavement construction. In some embodiments, methods provided herein reduce annually repair of pavement. In some embodiments, methods provided herein reduce annually repair of a pavement subgrade soil.

In some embodiments, methods provided herein stabilize frost-susceptible soil. In some embodiments, technologies methods herein reduce a susceptibility of a subgrade soil to freezing and thawing. In some embodiments, technologies methods herein reduce a susceptibility of pavement subgrade soil to deterioration from freezing and thawing.

In some embodiments, methods provided herein stabilize soil under harsh environmental conditions. In some embodiments, methods provided herein stabilize soil exposed to harsh environmental weather.

In some embodiments, the present disclosure provides an insight that CO₂ is introduced to soil at an elevated pressure (e.g. above at least about 1 bar). Without wishing to be held to a particular theory, introduction at higher pressures may drive enhanced stabilization by causing the reaction to extend deeper into the soil.

In some embodiments, methods provided herein stabilize soil depths of at least about 0 mm from a surface. In some embodiments, methods provided herein stabilize soil depths of at least about 50 mm from a surface. In some embodiments, methods provided herein stabilize soil depths of at least about 100 mm from a surface. In some embodiments, methods provided herein stabilize soil depths of at least about 150 mm from a surface. In some embodiments, methods provided herein stabilize soil depths of at least about 200 mm from a surface. In some embodiments, methods provided herein stabilize soil depths of at least about 250 mm from a surface. In some embodiments, methods provided herein stabilize soil depths of at least about 300 mm from a surface. In some embodiments, methods provided herein stabilize soil depths of at least about 350 mm from a surface. In some embodiments, methods provided herein stabilize soil depths of at least about 400 mm from a surface. In some embodiments, methods provided herein stabilize soil depths of at least about 450 mm from a surface. In some embodiments, methods provided herein stabilize soil depths of at least about 500 mm from a surface.

In some embodiments, methods provided herein stabilize (e.g. cement and/or solidify) a composition at a depth of at least about 0.5 m from a surface, at least about 1 m from a surface, at least about 1.5 m from a surface, at least about 2 m from a surface, at least about 2.5 m from a surface, at least about 3 m from a surface, at least about 3.5 m from a surface, at least about 4 m from a surface, at least about 4.5 m from a surface.

### Frost Action

The present disclosure encompasses a recognition that technologies described herein may be advantageous for reducing susceptibly of a soil to frost action.

In cold regions, frost action is one of the most detrimental environmental stressors impacting surface transportation systems, which includes the foundation soils (e.g. subgrade and subbase materials) (see, e.g. Aldaood, Abdulrahman, Marwen Bouasker, and Muzahim Al-Mukhtar. “Impact of freeze-thaw cycles on mechanical behaviour of lime stabilized gypscous soils.” Cold Regions Science and Technology 99 (2014): 38-45; Tebaldi, G., Orazi, M., & Orazi, U. S. (2016). Effect of freeze-thaw cycles on mechanical behavior of lime-stabilized soil. Journal of Materials in Civil Engineering, 28, 06016002; Zhang, W., Guo, A., & Lin, C. (2019a). Effects of cyclic freeze and thaw on engineering properties of compacted loess and lime-stabilized loess. Journal of materials in civil engineering, 31, 04019205; and Uduebor, M., Adeyanju, E., Saulick, Y., Daniels, J., & Cetin, B. (2022). A review of innovative frost heave mitigation techniques for road pavements. In International Conference on Transportation and Development 2022 (pp. 95-106)).

In 1999, DiMillio (1999) estimated that US$2 billion annually in damage to pavement systems was caused by frost action in the United States, and Dor'e et al. (2005) reported that seasonal freeze-thaw cycles contribute up to 75% of the degradation for surface transportation infrastructure (see, e.g. DiMillio, A. F. (1999). A quarter century of geotechnical research. Technical Report Turner-Fairbank Highway Research Center; and Dor'e, G., Drouin, P., Pierre, P., & Desrochers, P. (2005). Estimation of the relationships of road deterioration to traffic and weather in Canada. Transport Canada, Final Report). In a warming climate, the number of freeze-thaw cycles is expected to increase and can be expected to exacerbate the impacts of frost action (see, e.g., Asam, S., Bhat, C., Dix, B., Bauer, J., Gopalakrishna, D. et al. (2015). Climate change adaptation guide for transportation systems management, operations, and maintenance. Technical Report United States. Federal Highway Administration, and Tonn, G., Reilly, A., Czajkowski, J., Ghadi, H., & Kunreuther, H. (2021). US transportation infrastructure resilience: Influences of insurance, incentives, and public assistance. Transport Policy, 100, 108-119). In accordance with various embodiments, technologies provided herein stabilize frost susceptible soil. In some embodiments, technologies provided herein improve strength of a composition comprising frost susceptible soil.

In some embodiments, a composition comprising frost susceptible soil, lime, and water contacted with exogenous carbon dioxide has an increased California bearing ratio (CBR) as compared to a composition comprising frost susceptible soil, lime, and water not contacted with exogenous carbon dioxide. In some embodiments, a composition comprising frost susceptible soil, lime, and water contacted with exogenous carbon dioxide has a California bearing ratio (CBR) of at least about 20%, 35%, 40%, 45%, 55%, 60%, 65%, 70%, 75%, 80%, 85%, 90%, 95%, 100%, 105%, or 110%. In some embodiments, a composition comprising frost susceptible soil, lime, and water contacted with exogenous carbon dioxide has an increased California bearing ratio (CBR) as compared to a composition not contacted with exogenous carbon dioxide. In some embodiments, a composition contacted with exogenous carbon dioxide may exhibit an increased CBR of at least 1%, 5%, 10%, 20%, 50%, 100%, 200%, 300%, 400%, 500%, or greater as compared to a composition not contacted with exogenous carbon dioxide.

In some embodiments, a composition comprising frost susceptible soil, lime, and water contacted with exogenous carbon dioxide has an increased sheer wave velocities as compared to a composition comprising frost susceptible soil, lime, and water not contacted with exogenous carbon dioxide. In some embodiments, a composition comprising frost susceptible soil, lime, and water contacted with exogenous carbon dioxide has a sheer wave velocity of at least about 100 m/s, 200 m/s, 300 m/s, 400 m/s, 500 m/s, 600 m/s, 700 m/s, 800 m/s, 900 m/s, 1000 m/s, 1100 m/s, 1200 m/s, 1300 m/s, 1400 m/s, 1500 m/s. In some embodiments, a composition comprising frost susceptible soil, lime, and water contacted with exogenous carbon dioxide has an increased sheer wave velocities as compared to a composition not contacted with exogenous carbon dioxide. In some embodiments, a composition contacted with exogenous carbon dioxide may exhibit an increased sheer wave velocities of at least 1%, 5%, 10%, 50%, 100%, 200%, 300%, 400%, 500%, or greater as compared to a composition not contacted with exogenous carbon dioxide.

### Carbon Emission

In certain embodiments, the present disclosure provides methods to reduce carbon emissions associated with production of chemical additives (e.g., cement, hydrated lime). As shown in FIG. 12, in certain embodiments, technologies (e.g. compositions and methodologies) described herein reduce or even eliminate substantially eliminate CO₂ release during subgrade soil stabilization (e.g. CO₂ release associated with generation of a metal oxide and/or metal hydroxide).

In some embodiments, technologies described herein reduce or even eliminate reduce CO₂ emitted during soil stabilization. In some embodiments, technologies described herein reduce or even eliminate CO₂ emitted during subgrade soil stabilization.

In some embodiments, technologies described herein reduce or even substantially eliminate CO₂ emitted during construction. In some embodiments, technologies described herein reduce net carbon footprint.

### EXEMPLIFICATION

### Example 1: State Parameters Influencing Rate of Carbonate Mineral Formation and Mechanical Improvement

The present example demonstrates that degree of saturation, volumetric air, water content, and density (i.e., void ratio) of a composition may influence efficient CO₂ consumption and formation of carbonate mineral (e.g., CaCO₃).

### Methods

### Preparation of Soil Compositions

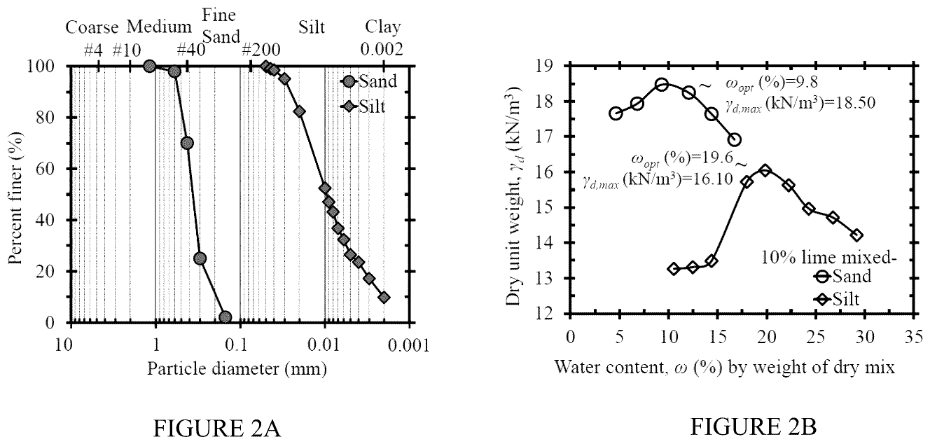

Ottawa sand (“sand”) and MIN-U-SIL 40 silt (ground silica) (“silt”). Sand and silt contained 99.7% SiO₂ with a specific gravity, Gₛ, of 2.65 and gradations as shown in FIG. 2A, which conform to ASTM C778 (ASTM, 2017c). According to the unified soil classification system (USCS) (ASTM, 2017a), Ottawa sand was classified as poorly graded sand (SP) and the ground silica was classified as silt (ML). Commercial grade hydrated lime from Acros Organics, USA, was approximately 85-90% pure calcium hydroxide with a Gₛ of 2.24. FIG. 2B shows standard compaction curves (ASTM, 2012) for lime-mixed soils.

Soil-lime-water compositions were prepared by placing dry lime and soil in a mechanical mixer for at least two minutes or until the mixture appeared uniform in color. Deionized water was then added to achieve a target gravimetric water content, wo, volumetric water (or air) content, and/or degree of saturation. Soil-lime-water compositions were then mixed again for at least five minutes to achieve uniformity. Soil-lime-water compositions were immediately transferred to air-tight plastic bags for 24 hours to achieve moisture equalization. Soil-lime-water compositions, 50 mm in diameter and 100 mm in height, were prepared to achieve a desired dry density (y_{d}), void ratio and porosity (e and η), and degree of saturation (Sᵣ). Soil-lime-water compositions were prepared in four lifts using a two-part split aluminum mold. Each lift was uniformly compacted with a wooden tamper and soil at the top of each lift was scarified before placing subsequent lifts. Soil-lime-water compositions were then placed in a CO₂ gas chamber and carbonated under low pressure (about 0 kPa gauge pressure).

All soil-lime-water compositions were mixed with a target gravimetric lime content (β_{L}), defined as a ratio of dry mass of lime, my by dry mass of soil, mₛ. A target value of β_{L}, about 10% was chosen for exemplary testing. Carbonate mineral (i.e., CaCO₃) content (also referred herein to as a binder content), varied depending on the amount of time that soil-lime-water compositions were left in the CO₂ gas chamber. The gravimetric binder content (β_{B}) was defined as β_{B}=m_{B}/mₛ where m_{B} was the mass of carbonate mineral (i.e., CaCO₃). The volumetric binder content (θ_{B}) was defined as, θ_{B}=V_{B}/Vₜ=(m_{B}/(G_{B}ρ_{w}))/Vₜ, where V_{B} and Vₜ are the volume of carbonate mineral (i.e., CaCO₃) and total soil volume respectively. The specific gravity of the carbonate mineral (i.e., CaCO₃), G_{B}, and density of water, ρ_{w}, was used to compute volume of carbonate mineral (i.e., CaCO₃) content. Degree of carbonation (DoC) was defined as a ratio of calcium carbonate formed to a maximum amount possible based on the amount of chemical additive mixed in the soil.

### Testing and Sampling

Displacement-controlled (0.5 mm/min.) unconfined compression strength (UCS) tests were performed on carbonated soil-lime-water compositions in accordance with ASTM D5102 (ASTM, 2009) using an Instron 5900 apparatus. Immediately after UCS testing, a representative sample was collected and dried to prevent any further carbonation. Changes in strength demonstrates a change in formation of carbonate mineral (i.e. CaCO₃) content. Select samples were also tested via thermogravimetric analyses (TGA) using a TGA 55 from TA instruments to determine carbonate mineral (i.e. CaCO₃) content and DoC. TGA performed on calcium hydrated lime determined that the material was about 80-85% pure lime, which was approximately the maximum DoCs achievable. Table 1 summarizes tested conditions.

TABLE 1
Summary of UCS and TGA tests performed on
exemplary sand and silt compositions.

| Test | Soil | tc | | γd | ωo | Sr | UCS | TGA |
|---|---|---|---|---|---|---|---|---|
| ID | Type | (hours) | eo | (kN/m3) | (%) | (%) | Tests | Tests |
| SP1 | Sand | 3, 24, | 0.53 | 16.7 | 5.0 | 24.6 | 15 | 10 |
| | (SP) | 72, 120, | | | | | | |
| | | 168 | | | | | | |
| SP2 | Sand | 3, 24, | 0.49 | 17.2 | 7.7 | 41.0 | 15 | 10 |
| | (SP) | 72, 120, | | | | | | |
| | | 168 | | | | | | |
| SP3 | Sand | 3, 24, | 0.48 | 17.3 | 9.7 | 52.7 | 15 | 10 |
| | (SP) | 72, 120, | | | | | | |
| | | 168 | | | | | | |
| SP4 | Sand | 3, 24, | 0.48 | 17.3 | 14.1 | 76.7 | 15 | 10 |
| | (SP) | 72, 120, | | | | | | |
| | | 168 | | | | | | |
| SP5 | Sand | 24, 72 | 0.65 | 15.5 | 7.3 | 29.4 | 6 | 4 |
| | (SP) | | | | | | | |
| SP6 | Sand | 168 | 0.64 | 15.6 | 13.7 | 56.2 | 3 | 2 |
| | (SP) | | | | | | | |
| SP7 | Sand | 24, 72 | 0.74 | 17.7 | 7.4 | 25.8 | 6 | 4 |
| | (SP) | | | | | | | |
| SP8 | Sand | 168 | 0.78 | 14.4 | 13.7 | 46.0 | 3 | 2 |
| | (SP) | | | | | | | |
| SP9 | Sand | 24, 72 | 0.85 | 13.8 | 7.3 | 22.5 | 6 | 4 |
| | (SP) | | | | | | | |
| ML1 | Silt | 3, 24 | 1.11 | 12.1 | 11.3 | 26.5 | 6 | 4 |
| | (ML) | | | | | | | |
| ML2 | Silt | 3, 24, | 1.07 | 12.4 | 16.3 | 39.8 | 9 | 6 |
| | (ML) | 72 | | | | | | |
| ML3 | Silt | 3, 24, | 1.08 | 12.3 | 20.3 | 49.0 | 12 | 8 |
| | (ML) | 72, 120 | | | | | | |
| ML4 | Silt | 3, 24, | 1.08 | 12.3 | 25.2 | 60.9 | 9 | 6 |
| | (ML) | 168 | | | | | | |
| ML5 | Silt | 24, 72 | 0.94 | 13.2 | 18.6 | 51.4 | 6 | 4 |
| | (ML) | | | | | | | |
| ML6 | Silt | 24, 72 | 0.80 | 14.2 | 18.7 | 61.4 | 6 | 4 |
| | (ML) | | | | | | | |

Definitions:
t_{c} = carbonation period;
eₒ = initial void ratio;
ωₒ = initial gravimetric water content;
Sᵣ = initial degree of saturation;
γ_{d} = dry unit weight;
UCS = Unconfined Compression Strength;
TGA = Thermogravimetric Analysis

### Influence of Degree of Saturation on Carbonation Rate

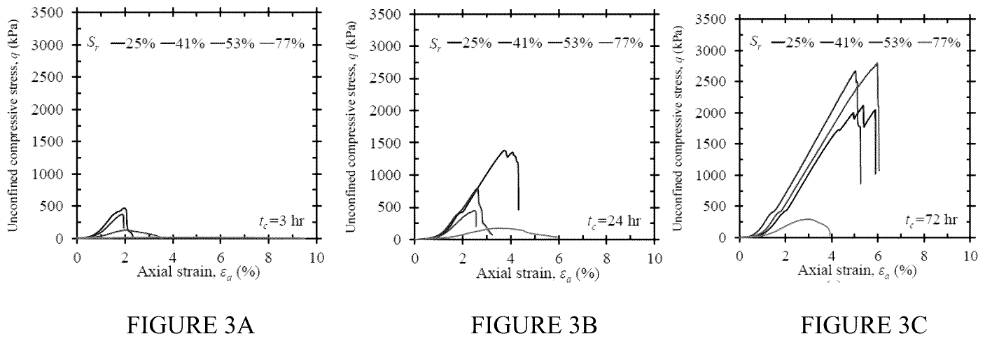

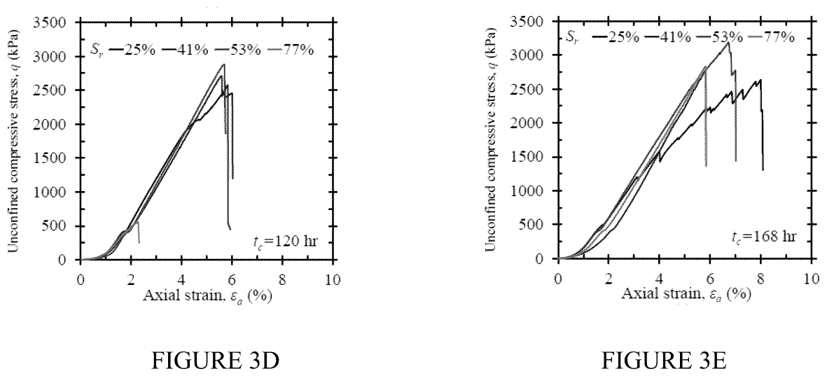

Sand compositions with a degree of saturation, Sᵣ, of about 25, 41, 53, or 77% were carbonated for about 3, 24, 72, 120, and/or 168 hours (see Table 1). After carbonation, UCS tests were performed and strength of tested compositions were determined. As shown in FIGS. 3A and 3B, strength gains occurred rapidly in compositions with lower Sᵣ values. After about 3 hours of carbonation, sand compositions with Sᵣ values of about 25% and 41% demonstrated a peak UCS, q, of about 500 kPa and a peak axial strain of about 2%. After about 24 hours of carbonation, sand compositions with an Sᵣ values of about 25%, 41%, 53% demonstrated a peak UCS, q, of about 1500 kPa, 750 kPa, and 500 kPa, respectively, and a peak axial strain of about 4%, 3%, and 2.5%, respectively. Without wishing to be bound to any particular theory, rapid gains in strength in compositions with lower Sᵣ values may attributed to higher volumetric air contents and a more interconnected gas-phase in the voids.

Surprisingly, as shown in FIGS. 3D and 3E, sand compositions carbonated for longer periods (i.e. 120 hours and 168 hours) did not exhibit a substantial change in strength as compared to shorter periods (i.e. 72 hours). However, substantial gains in strength were observed after about 168 hours of carbonation for sand compositions with a high Sᵣ value of 77% (FIG. 3E). Without wishing to be bound to any particular theory, delayed strength gain for compositions with a higher Sᵣ value (e.g. at least 77%) was likely attributed to a hindrance of CO₂ gas. Thus, the present study demonstrates that compositions with a low (e.g. 20%-60%) initial degree of saturation comprising soil (e.g. sand), water, and lime may exhibit improved UCS strength with a shorter duration of carbonation (e.g. less than about 72 hours).

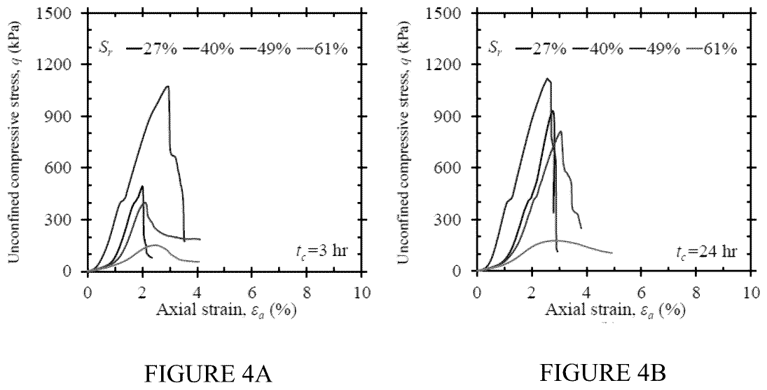

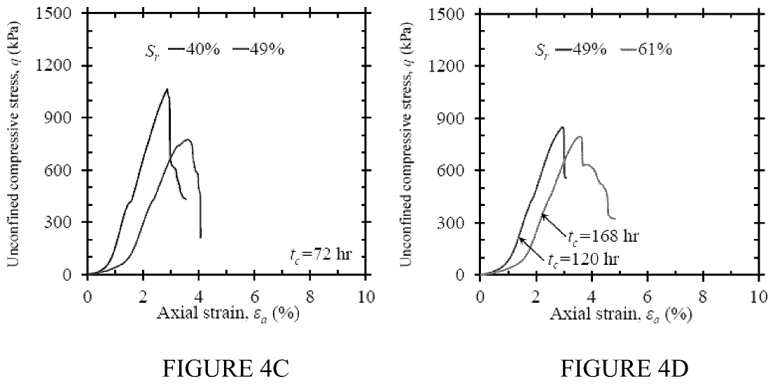

Silt compositions with a degree of saturation, Sᵣ, of about 27, 40, 49, and 61% were carbonated for about 3, 24, 72, 120, and/or 168 hours (see Table 1). After carbonation, UCS tests were performed and strength of tested compositions were determined. As shown in FIGS. 4A-4D, similar to sand composition, silt compositions with relatively low Sᵣ values (e.g., less than about 50%) gained strength relatively quickly. A notable delay was observed for silt compositions with higher Sᵣ values. As shown in FIGS. 4A and 4B, after about 3 hours of carbonation, silt compositions with Sᵣ values of about 27%, 40%, and 49% demonstrated a peak UCS, q, of about 1100 kPa, 500 kPa, 400 kPa, respectively, and a peak axial strain of about 3%, 2%, and 2%, respectively. After about 24 hours of carbonation, silt compositions with Sᵣ values of about 27%, 40%, and 49% demonstrated a peak UCS, q, of about 1100 kPa, 900 kPa, 800 kPa, respectively, and a peak axial strain of about 3%, 3%, and 3%, respectively.

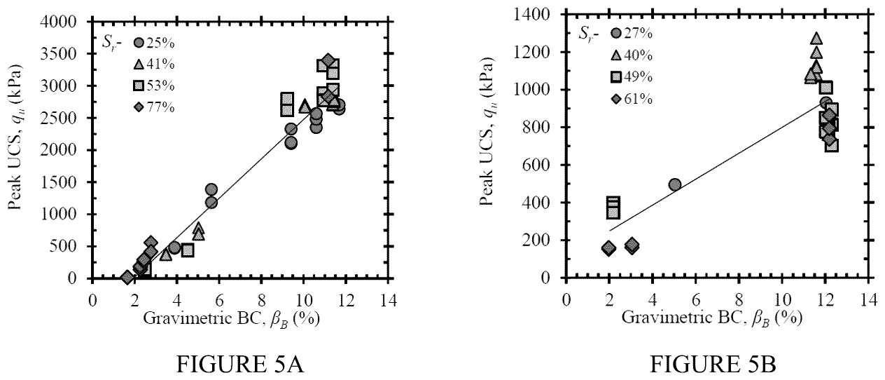

As shown in FIGS. 5A and 5B, strength gains were associated with the amount of carbonate mineral (i.e., CaCO₃) content formed. The amount of carbonate mineral (i.e., CaCO₃) content formed was also affected by an initial degree of saturation and associated intrinsic mobility of gas in the soil matrix. Therefore, the present study demonstrated that a shorter carbonation time (e.g., shorter than 72 hours) was effective to achieve efficient CO₂ consumption, formation of carbonate (i.e., CaCO₃ minerals, and improve strength when a soil (e.g., sand and/or silt) composition has an initial low (e.g., about 20%-60%) initial degree of saturation.

### Influence of Air and Water Content on Carbonation Rate

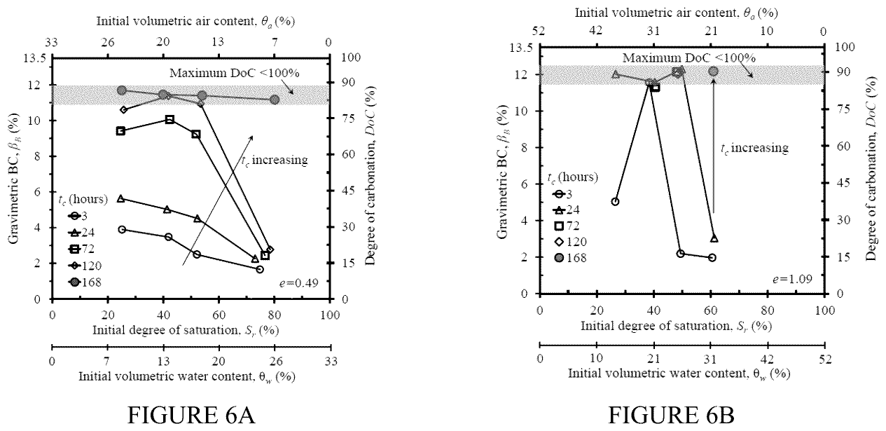

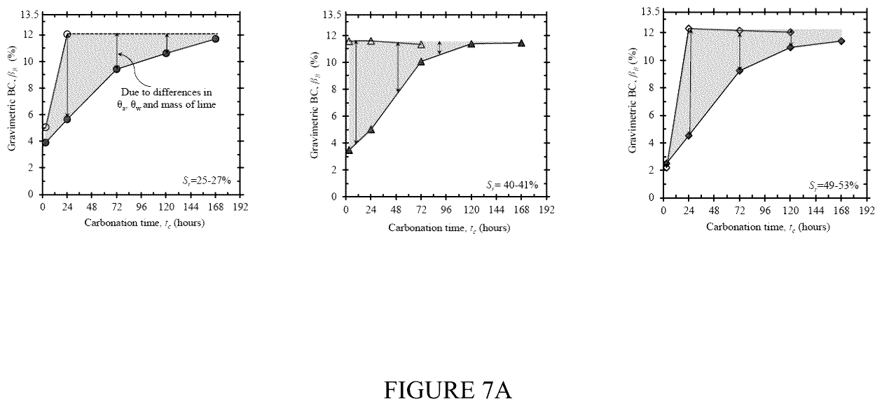

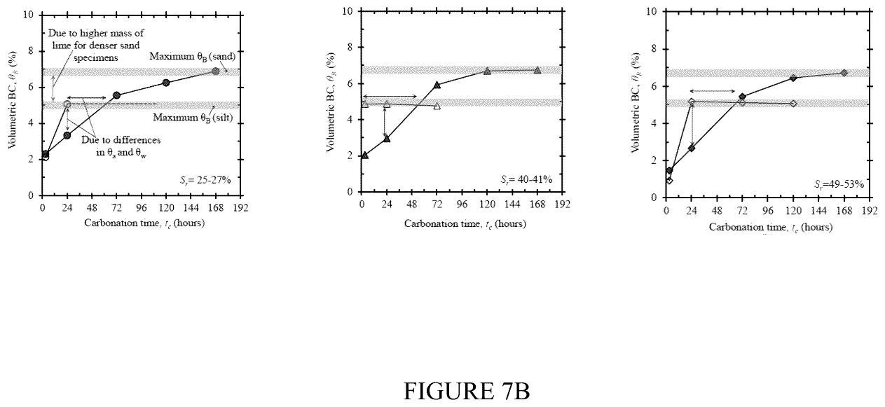

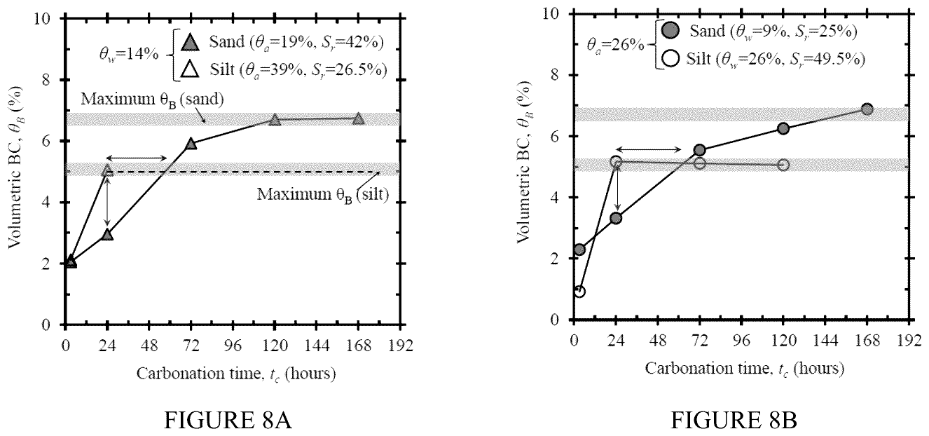

FIGS. 6A and 6B show exemplary temporal changes in the amount of carbonate mineral (i.e., CaCO₃) content formed (i.e., gravimetric BC, β_{B}) and DoC at the center of carbonated sand (FIG. 6A) and silt (FIG. 6B) compositions with different Sᵣ. Sand and silt compositions reached similar DoC and amount of carbonate mineral (i.e., CaCO₃) content irrespective of the initial Sᵣ. There were notable differences in duration of carbonation required to achieve a maximum degree of carbonation (DoC) observed in each soil (i.e., sand or silt) compositions at a similar Sᵣ. Sand compositions with Sᵣ values less than about 50% reached a maximum carbonate mineral (i.e., CaCO₃) content and DoC within approximately 72 hours, while silt compositions with similar Sᵣ values were near their maximum DoC within 24 hours. Volumetric air contents, θₐ and volumetric water contents, θ_{w} were greater in silt compositions than sand compositions prepared at a similar Sᵣ. Thus, θₐ and θ_{w}, which influences the effective mobility of gas in the soil matrix, can influence rapid rates carbonate mineral (i.e., CaCO₃) formation.

Thus, the present study demonstrated that there was a balance between θₐ, θ_{w}, and S^{r} to optimize a rate of carbonation. Without wishing to be bound by any particular theory, higher θ_{w} permitted the dissolution of CO₂ gas and lime during carbonation and higher θₐ permitted efficient gas mobility and the amount of CO₂ gas that can be conveyed to lime-mixed soil.

### Influence of Density on Mechanical Improvement of Carbonated Sand and Silt Compositions.

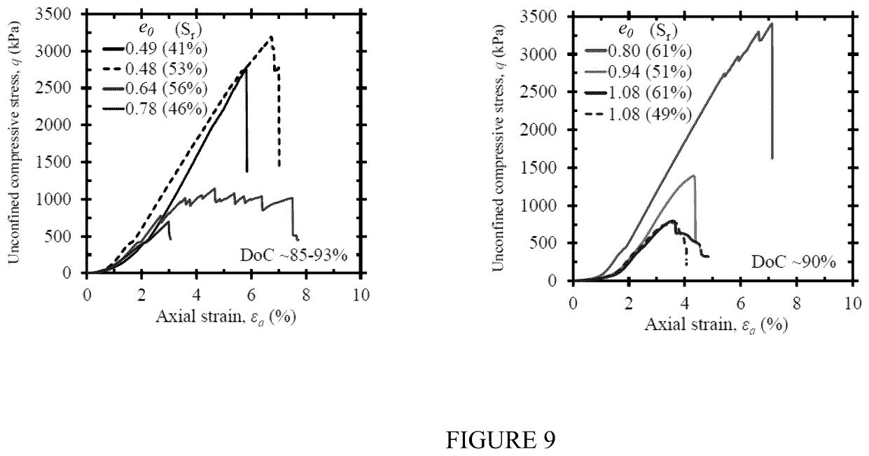

Carbonated sand and silt compositions with different initial void ratio were tested for UCS. As shown in FIG. 9, all compositions had a DoC of at least 85% (i.e. maximum DoC attainable based on available lime in the lime). Carbonated sand compositions with a high density (i.e., a void ratio of about 0.49) exhibited a peak UCS of about 3200 kPA and a peak axial strain of about 7%. While, carbonated sand compositions with a low density (i.e., a void ratio of about 0.78) exhibited a peak UCS of about 750 kPA and a peak axial strain of about 3%. Surprisingly, carbonated silt compositions achieved similar a strength measurement at lower densities (i.e., higher void ratios). Carbonated silt with a void ratio of about 0.80 exhibited a peak UCS of about 3500 kPA and a peak axial strain of about 7%.

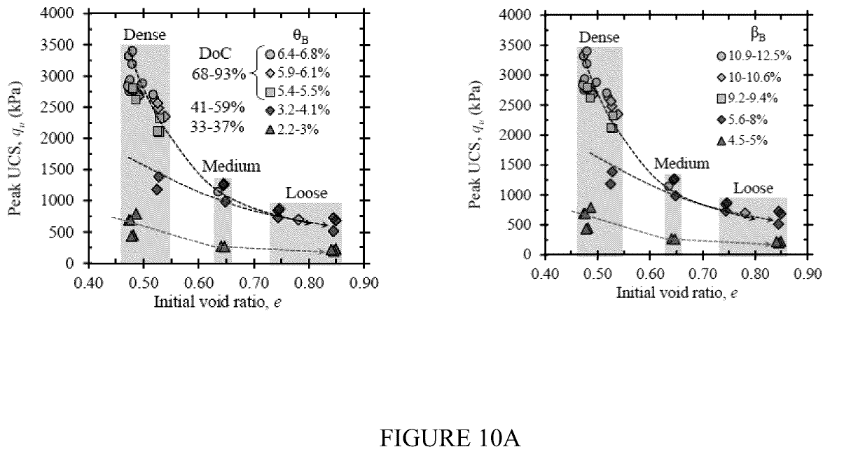

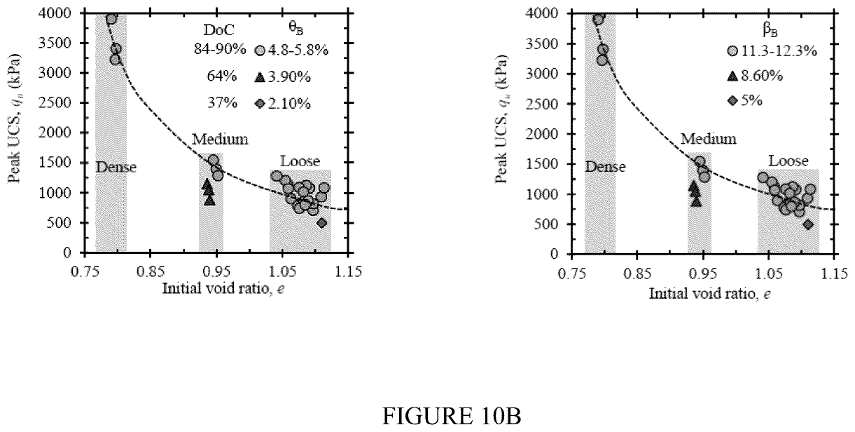

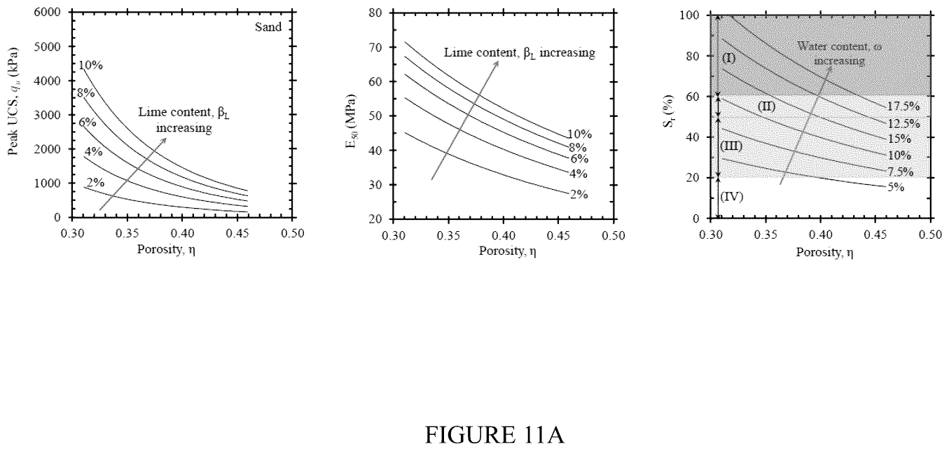

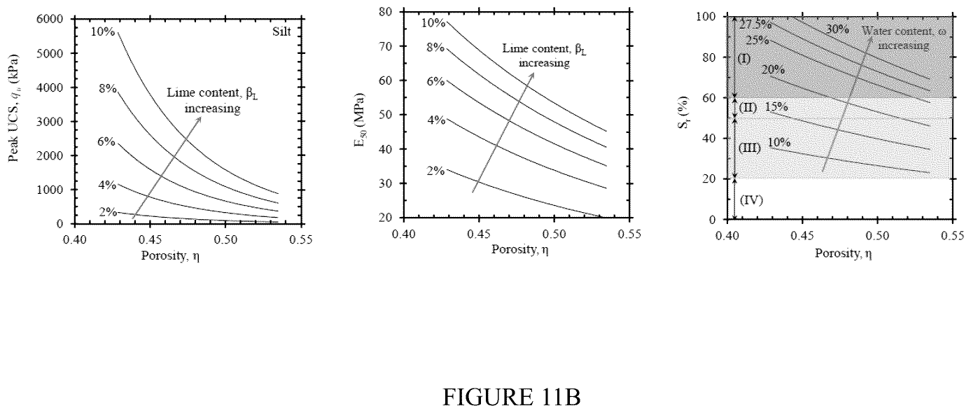

FIG. 10A summarizes UCS tests performed on sand compositions at different void ratios, which are categorized as “loose,” “medium dense,” and “dense.” The carbonate mineral (i.e., CaCO₃) content (left graph) and corresponding gravimetric carbonate mineral (i.e., CaCO₃) content (right graph) in each density range are also shown. There was increase UCS, as void ratio decreased and density increased for carbonated sand compositions. For “dense” sands, subtle changes in void ratio had a significant influence on the UCS. As shown in FIG. 10B, lower densities (i.e., higher void ratios) in silt compositions achieved similar strengths as sand compositions.

Thus, the present study demonstrates that density has an influence on mechanical improvements associated with carbonation. This influence was soil dependent as for carbonated sand compositions UCS increased at low (e.g., about 0.50) initial void ratios and for carbonated silt compositions UCS increased at higher (e.g., about 0.8) initial void ratios.

### Example 2: Evaluation of Carbonated Compositions in Large-Scale Experiments

The present example demonstrates that accelerated carbonation described herein may substantially increase soil stiffness and subgrade quality in large-scale experiments.

### Methods

### Soil Box Construction

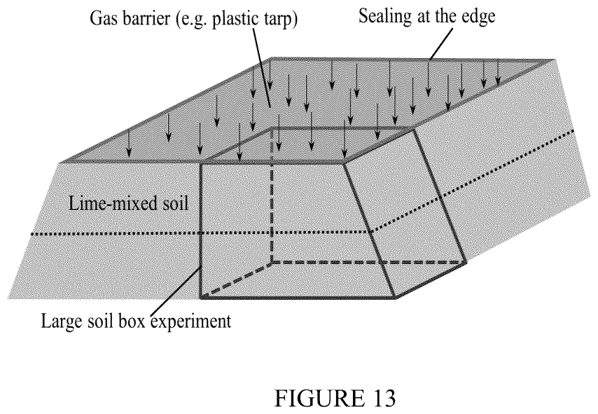

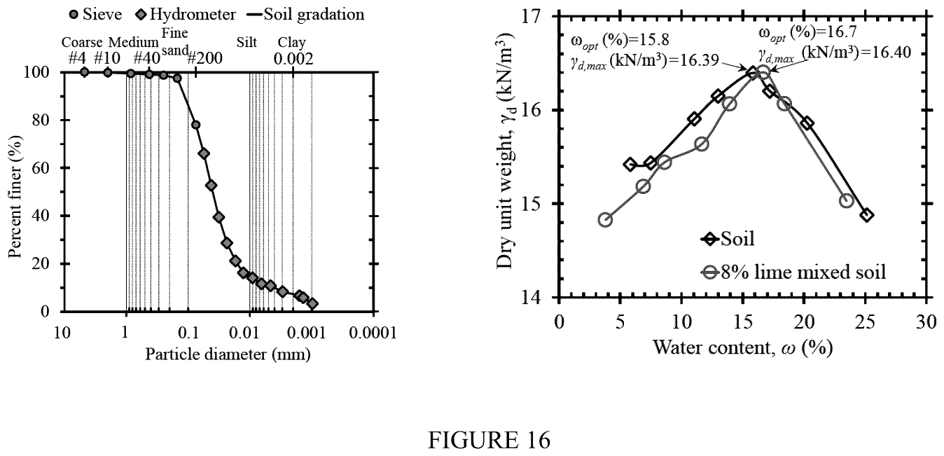

Non-plastic silt mixed with a gravimetric lime content (β_{L}) of about 8% were prepared. FIG. 16 shows gradation curves for silt and standard compaction curves, according to ASTM, 2012, for silt with and without lime. Thermogravimetric analyses (TGA) performed on calcium hydrated lime determined that the material was about 80-85% pure lime, which was approximately the maximum DoCs achievable. FIG. 13 provides an exemplary schematic overview of soil box construction. The box was sealed at the bottom and jointed connections to prevent gas and water leakage during experiments. Perforated PVC pipes were installed at the base of the box to allow gas-escape (i.e., flow) at bottom of the soil. The pipes simulated a substantially thicker deposit anticipated in the field than the soil column height in the box (i.e., not trap CO₂ gas in the box). The perforated pipes were also used to introduce groundwater for freeze-thaw durability testing of carbonated soil (see Example 3). The soil was compacted in 50 mm lifts to a modest dry density, γ_{d} of about 14.2 to 14.4 kN/m³, and a target void ratio, e, of about 0.8 to a final thickness of 450 mm.

### Experimental Arrangement and Instrumentation

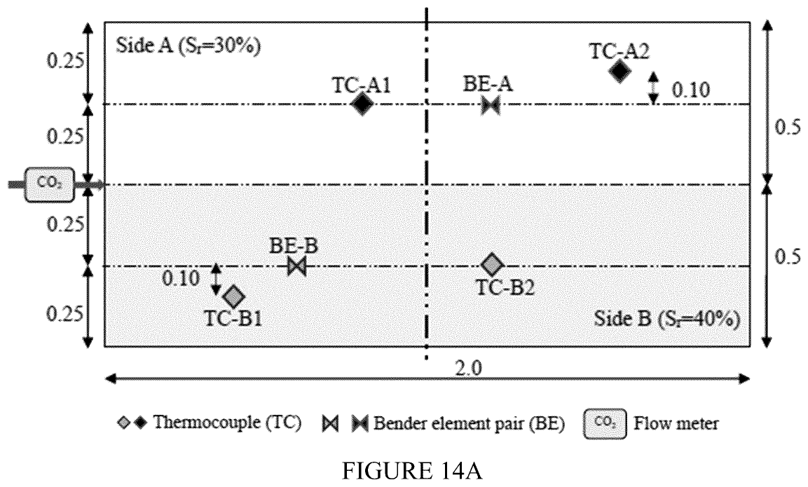

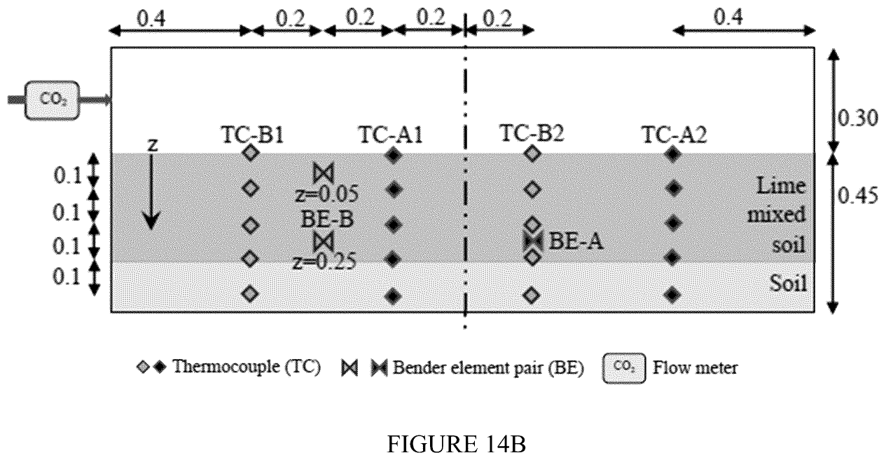

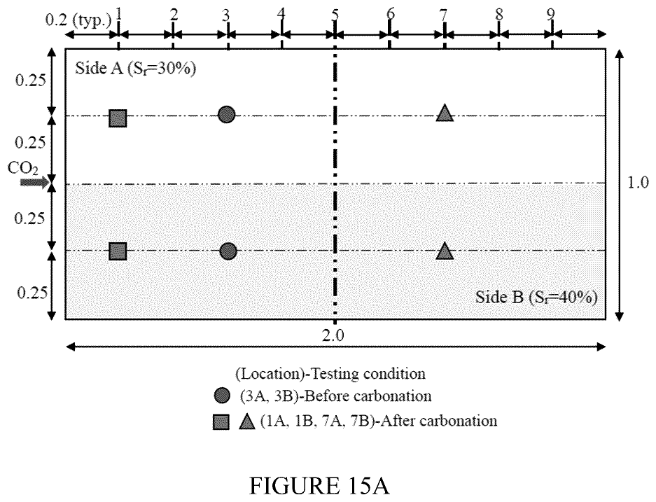

Thermocouples, TC (thermocouple probe wire-20 wire gauge, K calibration from Thermo Electric Company), bender element pairs, BE (GDS encapsulated bender element and insert from GDS instruments, UK), and settlement plate pedestals (wooden, in-house built) were embedded in the soil at varying depths. Thermocouples and bender element pairs were used to monitor the real-time carbonation progress, whereas the settlement plate pedestals were installed to mount the Linear Potentiometer Position Sensor (LPPS). As shown in FIG. 14A, the box was divided into two-halves, sides “A” and “B,” to examine two different degrees of saturation (Sᵣ=30% and 40%) on surface carbonation. These degrees of saturation provide air and water to facilitate the reaction, but not so much water such that it obstructs the permeation of gas into the soil matrix. The box was sealed with a plastic covering and sealed around the edges. Holes were drilled through one side of the box to allow gas flow and simulate the perimeter of an embankment.

As shown in FIG. 14B, lime-mixed soil was in the upper 300 mm of the 450 mm soil column. Five thermocouples were placed at two locations on each side of the box (20 total) to monitor temperature changes at depths of 0,100,200, 300, and 400 mm. Two pairs of bender elements were located on each side of the box at depths of 50 and 250 mm (i.e., 50 mm below the top and above the bottom of the lime-mixed soil). The flowmeter, thermocouples, and bender elements allowed for real-time monitoring of the CO₂ gas flow rate, pressure at the box, total gas introduced, temperature throughout the soil column (a proxy for where the exothermic reaction was occurring), and changes in shear wave velocity during carbonation in this region of the soil column.

### Testing and Sampling

Post-carbonation, testing and sampling assessed changes in mechanical behavior and gravimetric binder content and lime content. Gravimetric binder content was defined as the ratio of the mass of carbonate mineral (i.e., CaCO₃) and soil. Field CBR equipment, which consists of a mechanical screw jack and piston that penetrates the ground, reacted off a steel beam spanning the soil the box that was secured by reaction blocks on each side. CBR was defined as CBR=σ_{δ}/σ_{std} where σ_{δ} was the stress after 2.54 or 5.08 mm of piston penetration and σ_{std} was a standard stress of 6.9 or 10.3 MPa that corresponds to 2.54 or 5.08 mm deformations, respectively; the CBR was the largest stress-ratio arising from measurements at 2.54 and 5.08 mm.

Samples were extruded and oven-dried to measure the water content of the extruded samples, and to prevent any further chemical reactions. The dried sample was stored in air-tight plastic containers prior to TGA testing to determine mineral (i.e., CaCO₃) content and lime content.

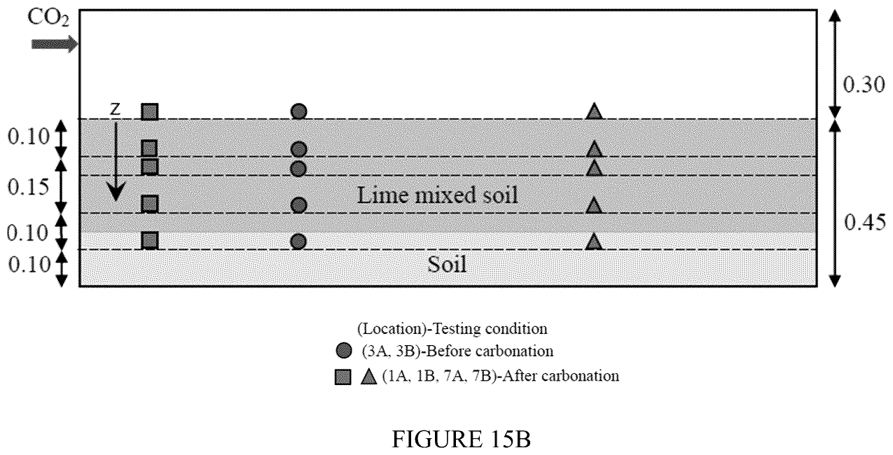

FIGS. 15A and 15B show CBR testing and sampling locations. As shown in FIG. 15B, CBR was performed at five different depths (0, 100, 150, 250, and 350 mm) at 3 locations on each side of the box. CBR testing and sampling were performed in tandem; after each CBR test, sampling was performed to collect soil for chemical testing, but to also advance the hole to the next CBR test depth.

### Monitoring of Flow, Temperature and Sheer Wave Velocity

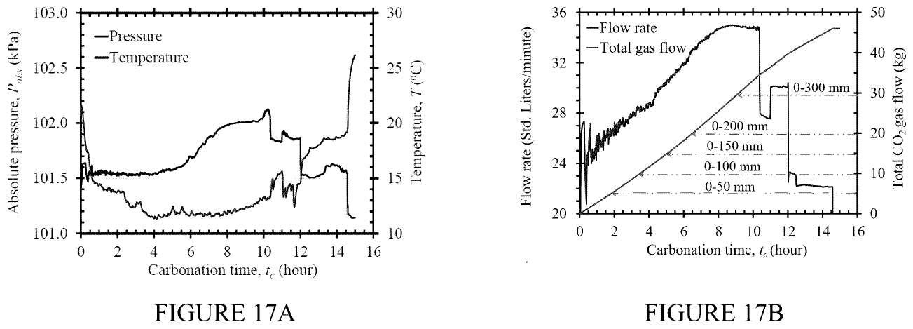

FIG. 17A and FIG. 17B show exemplary flowmeter (TSI 5300 series instrument) data during carbonation, including absolute gas pressure and temperature where CO₂ entered the soil box and corresponding flow rate (FIG. 17A), and total mass of CO₂ that entered the box (FIG. 17B). Assuming carbonation progressed from the top of the soil column downward e.g. 0-50 mm, 0-100 mm, 0-150 mm, 0-200 mm, 0-300 mm, FIG. 17B also shows the corresponding theoretically amount of gas that was required to fully carbonate available lime over different depth intervals in lime-mixed soil.

Gas was continuously supplied to the soil box without making any adjustments to the pressure regulator at the manifold for approximately 10 hours under a low absolute pressure between about 101 and 102 kPa (about 0 gauge pressure). During the period where no adjustments were made during the carbonation period (tₑ<10 hours), the flowrate steadily increased for approximately 8 hours and then steadied out. The greatest fluctuations in flowrate were observed at the beginning of the test, presumably due to the influence of an ongoing reaction, which diminished over the course of the first 5 hours when enough gas had been introduced to carbonate the upper 150 mm of soil. Thereafter, the flowrate steadily increased, but with limited fluctuations.

### Evaluation of Flow, Temperature and Sheer Wave Velocity

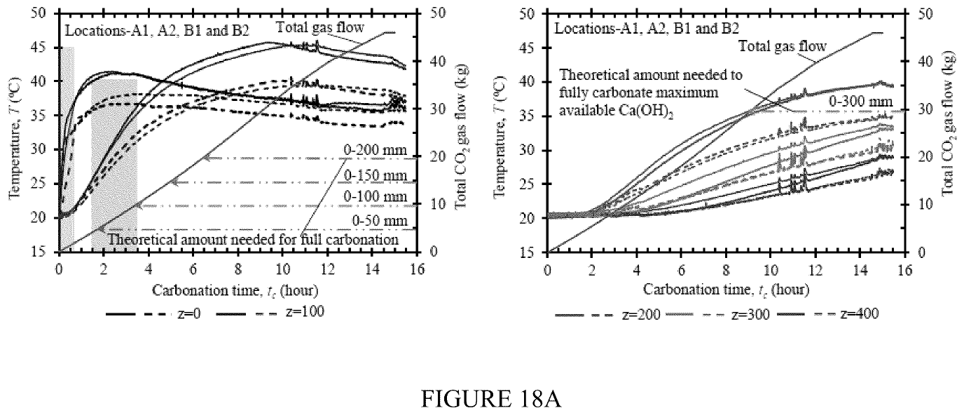

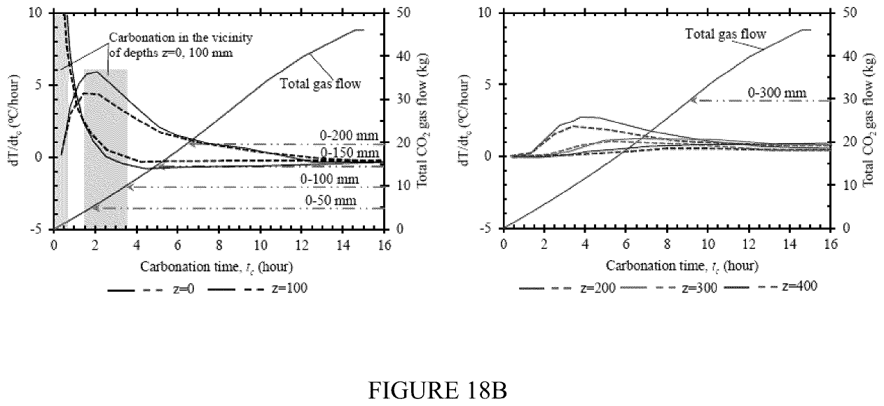

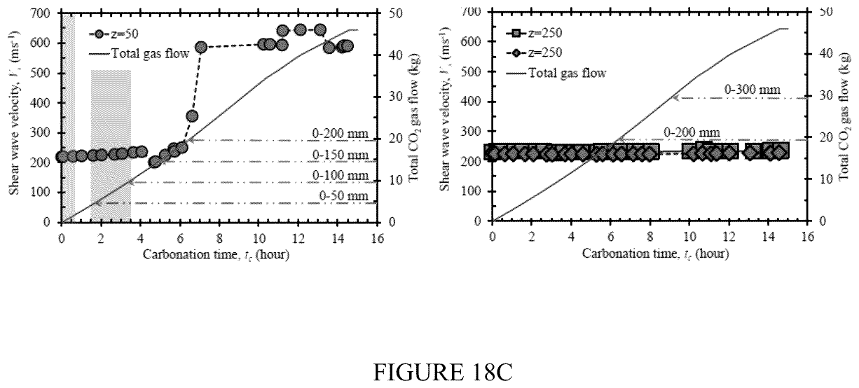

The present study demonstrates that carbonation induced a rapid temperature change correlated with increased sheer wave velocity. FIGS. 18A-18C show temporal changes in temperature readings and shear wave velocity at various depths in in exemplary soil compositions during surface carbonation. CO₂ reacts with hydrated lime and generates heat. As shown in FIG. 18A, temperatures first increased rapidly near ground surface (about 0 mm) followed by a spike in temperature at about 100 mm. As shown in FIG. 18B, corresponding rate of temperature change was greatest at the beginning of tests at near ground surface, but continuously decreased with time, suggesting that the reaction first occurred at shallow depths and then progressed vertically downward.

Temperature also increased at greater depths in at about 200 to 400 mm. However, spikes in temperature rise were not as pronounced as at shallower depths, likely signaling that reaction was not occurring as rapidly. Though temperatures increased from depths of about 200 to 400 mm, there was a noticeably higher rate of temperature at a depth of about 200 mm than at greater depths.

At all depths, temperature rise on side A (Sᵣ of about 30%) was lower than side B (Sᵣ of about 40%). However, when temperature changes happened, they occurred simultaneously, suggesting that the reactions occurred simultaneously at the similar depths. As water has a high specific heat capacity, therefore lower temperatures on side B may be attributed to a greater volume of water in the soil matrix. Thus, thermocouple readings did not indicate that differences in Sᵣ on each side of the box had a significant impact on the rate or extent of where carbonation occurred in the soil column.

As shown in FIG. 18C, shear wave velocities measured at a depth of about 50 mm increased substantially from approximately 200 m/s to 600 m/s, indicating stiffness of the upper portion of the soil profile was similar to very hard soils or soft rock. Surprisingly, this was not observed until approximately 3 to 4 hours after it was believed carbonation would have occurred at this depth. Therefore, there was short delay between when the reaction occurred and when mineral content (i.e., CaCO₃) agglomerated. Regardless, for most practical construction applications, the improvement after carbonation occurred was effectively “immediate.” No changes in shear wave velocity were observed on either side of the soil box at a depth of about 250 mm.

### Evaluation of Mineral Content (i.e., CaCO₃)

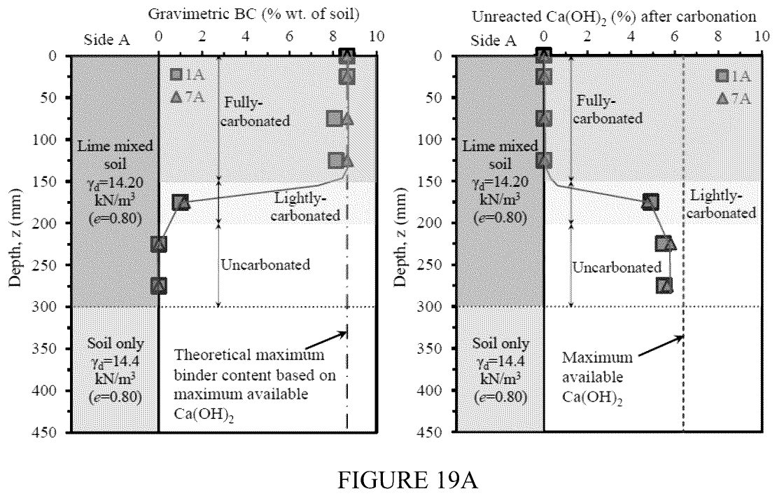

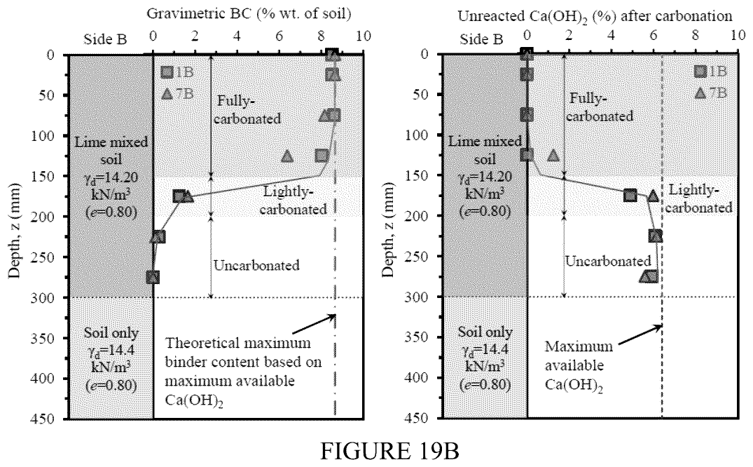

The present study demonstrates formation of mineral (i.e., CaCO₃) content after surface carbonation of sides A (FIG. 19A) and B (FIG. 19B). Gravimetric mineral (i.e. CaCO₃) content on each side of the box demonstrated that soil compositions were fully carbonated in the upper 150 mm of the soil column on both sides of the soil box (i.e. all lime reacted) and was lightly carbonated from 150 to 200 mm (i.e. partially all lime reacted). Little to no carbonation occurred from 200-300 mm in the lime-mixed soil. Thus, the present study demonstrated that a majority of CO₂ gas penetrating into the soil during the first 4.5 hours of surface carbonation was consumed in the upper 150 mm of the soil box.

### CBR Tests

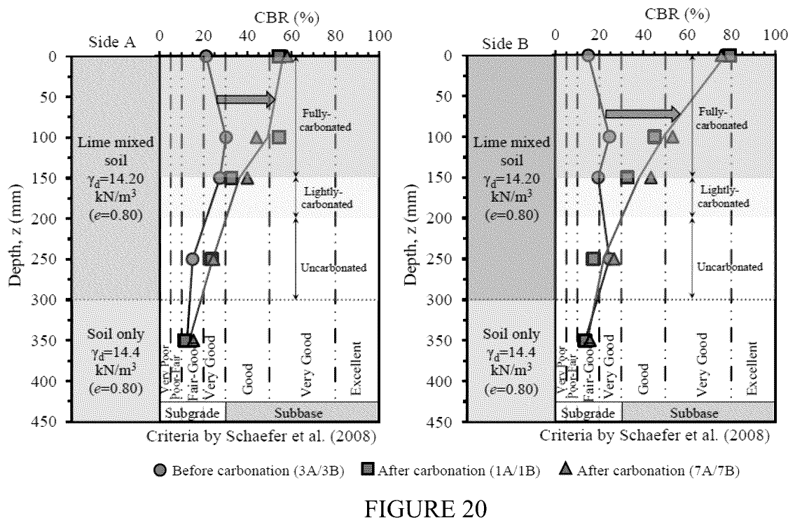

The present study demonstrates improved mechanical properties of carbonated coil compositions. FIG. 20 shows pre- and post-carbonation CBR measurements throughout the soil column for both sides of the soil box. At depths of about 0-100 mm, CBR values increased from values considered fair to good for a subgrade material to very good or excellent subbase material. CBR values ranged from 60 to 80% at depths of about 0-100 mm and remained elevated through the fully carbonated zone (e.g., depths of about 150 mm). Thus, these CBR values demonstrated that accelerated carbonation methods described herein may substantially improve mechanical properties of soil at depths of about 0-200 mm.

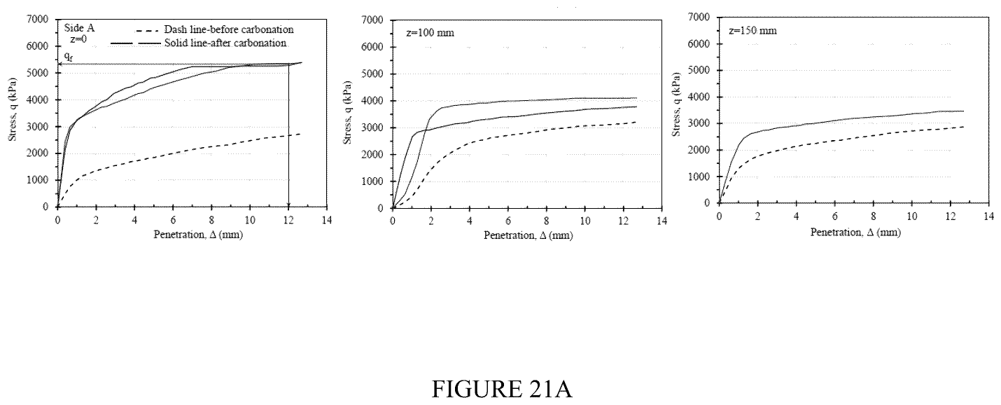

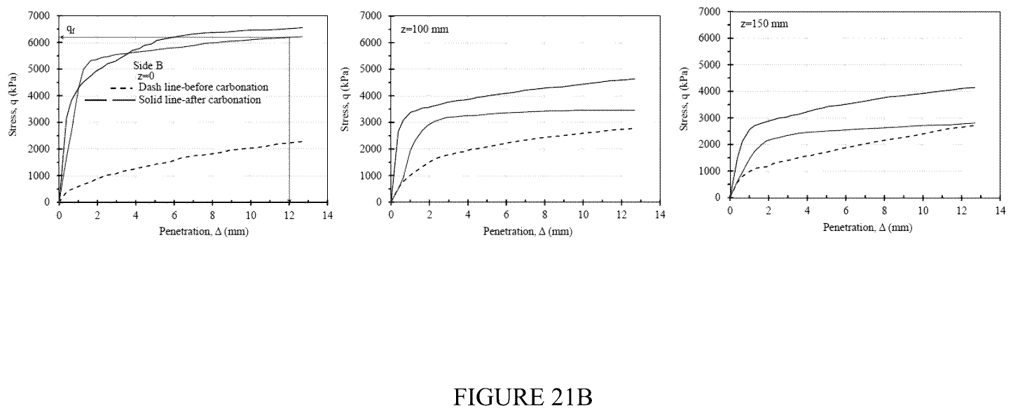

As shown in FIGS. 21A and 21B, there was substantial stiffness and load-carrying capacity were measured at depths closer to about 0 mm. While load carrying capacity diminished with depth, post-carbonation stiffness was much greater, even at depths of about 100 and 150 mm.

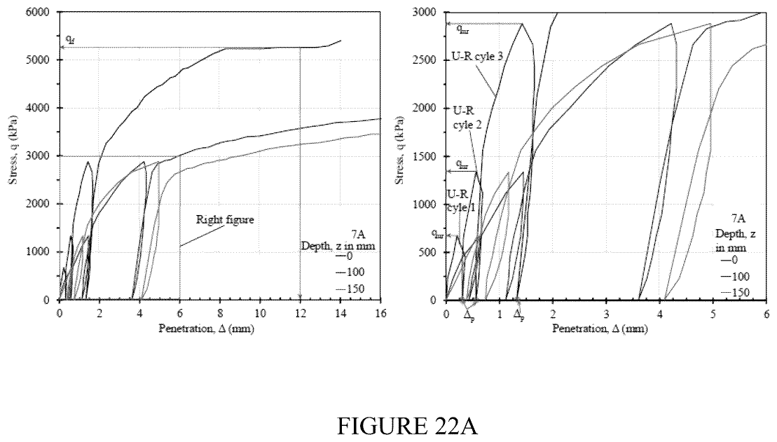

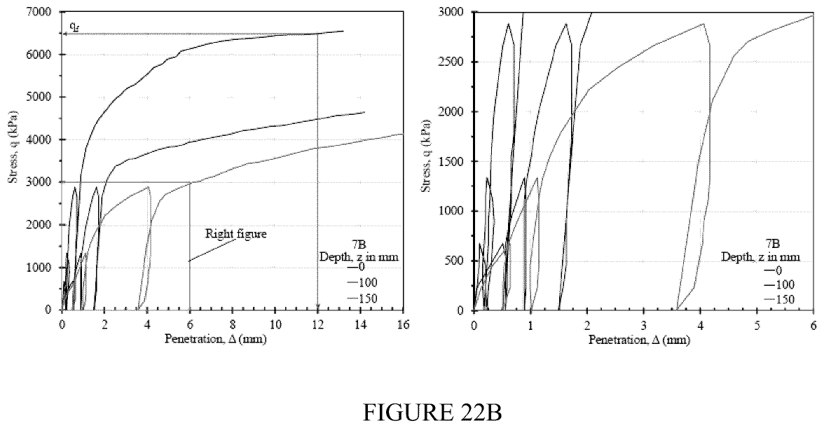

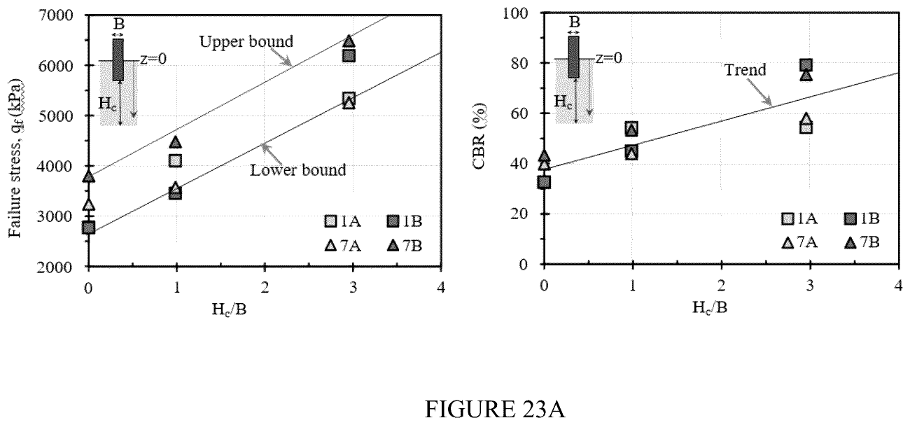

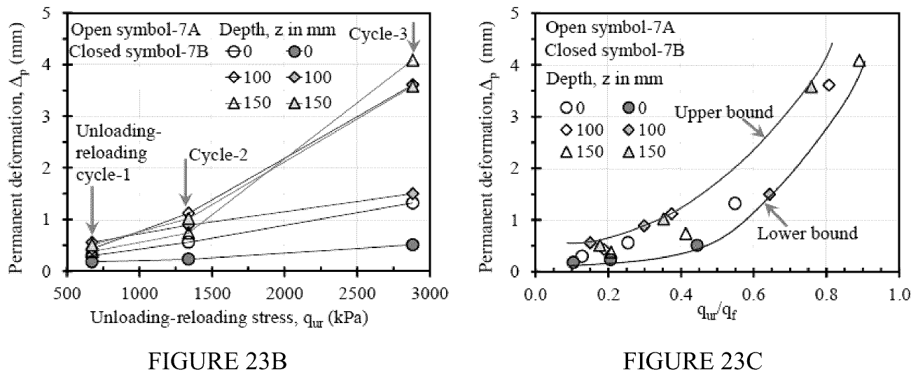

Unload-reload cycles were performed at three stress-levels to demonstrate plastic deformations that accumulate upon unloading at varying stress levels. As shown in FIGS. 22A and 22B, tests performed at shallower depths accumulated smaller plastic deformations at the same stress levels and their ultimate capacity (q_{f}), was greater. As shown in FIG. 23A, thickness of fully carbonated material underlying the piston, He, on ultimate failure stress, which was defined as the stress at a deformation of 12 mm, influenced He, which was normalized by the piston diameter, B, on the ultimate capacity during the CBR tests. Permanent deformation was dependent on the magnitude of the unload stress, qᵤᵣ, relative to the ultimate capacity and applied stresses near the surface of a roadway (e.g. by vehicles) decay with depth. As shown in FIG. 23C, permanent deformations remain small (less than about 1 mm) when qᵤᵣ/q_{f} was less than approximately 0.5. Thus, the effective modulus of carbonated material remained high, and greater than that of untreated soil, if it does not exceed an about 0.5 threshold qᵤᵣ/q_{f} ratio and approach its ultimate capacity.

Therefore, the example demonstrated that substantial gains in strength and stiffness can be achieved via surface carbonation at depths of about 0 mm, 100 mm, 150 mm, and 200 mm. Without wishing to be bound by any particular theory, if carbonation was applied closer to a targeted area, it was possible that CO₂ could have penetrated deeper into the soil column and carbonated soil at greater depths (e.g. at 300 mm). Thus, there was a potential to achieve these target depths with surface carbonation.

### Example 3: Carbonation Increased Durability of Frost-Susceptible Soil

The present example demonstrates that that accelerated carbonation described herein may substantially increase soil stiffness and subgrade quality of frost-susceptible soil compositions.

### Methods

### Preparation of Soil Compositions

Non-plastic silt comprising about 21% fine sand and about 71.4% silt with a plasticity index (PI) of about 2 was used for experiments described herein. Silt was considered to have a “very high” degree of frost susceptibility (frost category F4) (Christopher et al., 2006). High calcium hydrated lime used in this study was obtained from Graymont Inc. TGA performed on calcium hydrated lime determined that the material was about 80-85% pure lime, which was approximately the maximum DoCs achievable. lime-mixed soil prepared for large soil box experiments, compromised a gravimetric lime content, β_{L}, of about 8%, by dry weight of soil. FIG. 16, shows soil gradation curves for the silt and standard compaction curves for silt with and without lime.

### Soil Box Construction

A large-scale freeze-thaw experiment was conducted in an environmental chamber (interior dimensions −6.7 m in length and width with a height of 4.3 m) capable of controlling the temperature (T) between +50° C. and −40° C., and relative humidity (RH) between 5% and 100%. After post-carbonation testing, as described in Example 2 (see methods), a large soil box was moved into the environmental chamber to investigate the freeze-thaw effects on carbonated soils.

Inside an environmental chamber, there was an insulation system consisting of thermal insulation covered by a plastic tarp fixed at the top of the subgrade layer with a wooden beam, and at bottom of the box with surcharge weights all round to enforce a freezing front. During freezing, relatively hot (compared to freezing room temperature) air, temperature varied between 5-10° C. approximately, was supplied from a heating system via an insulated flex duct to the bottom of the soil box. This maintained a warm (i.e. slightly above zero ° C.) temperature at the bottom of the subgrade soils inside the box as compared to the soil surface. As discussed in Example 2, the soil box was designed and built with horizontal perforated conduits installed at the bottom of the box to supply groundwater during freezing as an open system for water uptake.

### Experimental Arrangement and Instrumentation

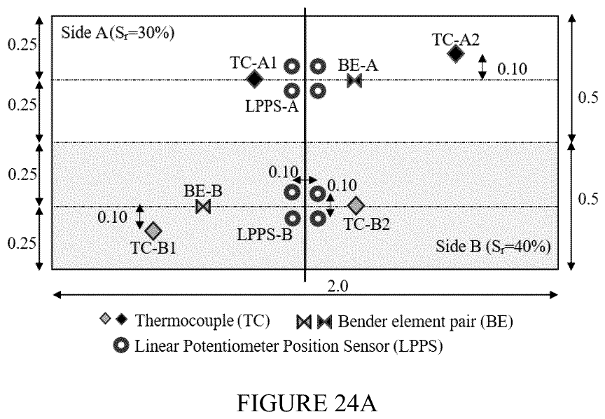

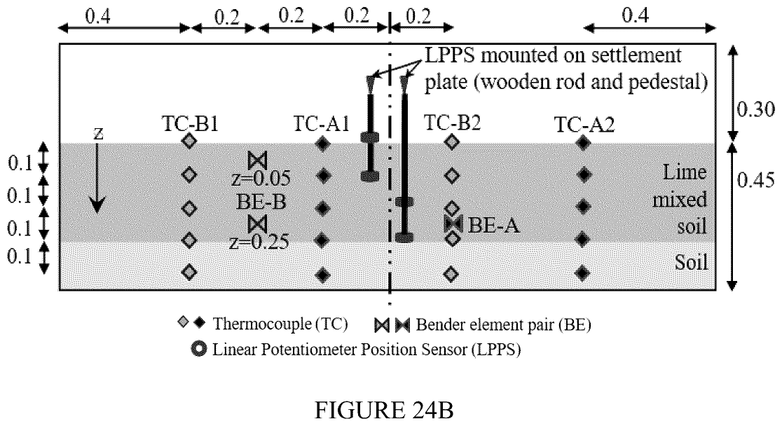

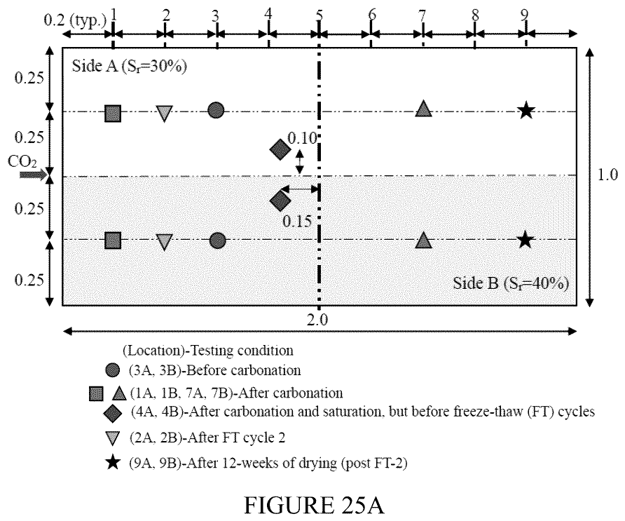

As discussed in Example 2, during construction of the soil box thermocouples, TC, bender element pairs, BE, and settlement plate pedestals were embedded in the soil at varying depths. The thermocouples and bender element pairs were used to monitor the real-time carbonation progress, whereas the settlement plate pedestals were installed to mount the Linear Potentiometer Position Sensor (LPPS). The TC and LPPS wires were connected to a USB data acquisition system, (i.e., USB-2416 series from Measurement Computing) with a real-time monitoring system in the instrumentation monitoring room beside the environmental chamber. FIGS. 24A and 24B show a detailed instrumentation plan and dimensions showing the locations of each instrumentation (i.e., TC, BE, LPPS) in the soil box during freeze-thaw experiment. The soil box was 2 m in length and 1 m wide (inside dimensions), and divided into Side A and Side B with an initial degree of saturation, Sᵣ, of 30% and 40%, and each side was approximately 0.5 m wide. Lime-mixed soil was in the upper 300 mm of the 450 mm soil column.

Five thermocouples were placed at two locations on each side of the box (20 total) to monitor temperature changes at depths of 0, 100, 200, 300, and 400 mm whereas, two pairs of bender elements were located on each side of the box at depths of 50 and 250 mm (i.e. 50 mm below the top and above the bottom of the lime-mixed soil) to monitor the changes in temperature, T and shear wave velocity, Vs, respectively during freeze-thaw cycles. Four LPPS were placed for each side (8 total) on top of the settlement plates that were installed at depths 0, 100, 200, and 300 mm to monitor the vertical movement (i.e. heave or settlement) during freeze-thaw cycles.

### Freeze-Thaw Experiment

Before applying freeze-thaw cycles, the post-carbonated soil column inside the box was saturated (soaked). Water was introduced from the water buckets to the bottom of the box using tubes and pre-installed groundwater conduits (approximately 25 mm in diameter). This plumbing arrangement facilitated bottom-up saturation and a supply of water during freezing. The water buckets were placed at a higher elevation to flow water due to the total head difference between the water bucket and the bottom of the box. After saturation, the soil surface appeared completely wet with surface moisture observed at different locations. After the saturation, a field CBR test was performed on the carbonated soil surface for each side (total 2) to understand the relative influence of soaking on the mechanical strength and stiffness of carbonated soils. After post-soaking CBR testing, the soil box was subjected to two freeze-thaw cycles (representative of a harsh winter condition). During freeze-thaw cycles, temperatures at various depths of the soil column on each side of the box were monitored in real-time using the embedded thermocouples.

During freeze-thaw cycle 1, temperature in the environmental chamber was set to −23° C. to impose a 1-D freezing front through the top of the soil surface by providing an insulation system all around the soil box and supplying relatively hot air at the bottom of the box from a heating system. The freezing temperature (i.e. approximately-23° C.) in the chamber was continued until the soil column (depths between 0 to 400 mm) on each side of the box achieved at least −10° C. Afterward, the insulation system was removed to expose the soil box completely to ambient room temperature for thawing of the soil column on each side of the box. The temperature of the chamber was set to +23° C. with relative humidity (RH) of approximately 85% at the beginning, and then the temperature was increased to +33° C. to accelerate the thawing process of the soil column inside the box. Thawing of the soil column continued until the temperature attained at least +10° C. along the depth between 0 to 400 mm for both sides. Freezing and thawing duration during freeze-thaw cycle 1 was about 125.4 and 91.2 hours, respectively and the soil column in the box experienced a −10° C. to +10° C. cycle during freeze-thaw cycle 1. After freeze-thaw cycle 1, soil samples were collected from both sides of the box to measure the water content, and CaCO₃ binder and lime content along the depth.

During freeze-thaw cycle 2, initially, chamber temperature was set to −23° C., which was reduced further down to −40° C. to accelerate freezing in the soil column. At the beginning of thawing, chamber temperature was set to +23° C. and a RH of approximately 85%, and then the temperature was subsequently increased to +33° C. and continued until the soil column between 0 to 400 mm on each side of the box reached to approximately +20° C. Afterward, the temperature of the chamber was reduced to ambient temperature and prolonged to achieve a complete thermal equilibrium that concluded the second freeze-thaw cycle. Freezing and thawing duration during freeze-thaw cycle 2 was 115.8 and 142.8 hours, respectively. Field CBR tests and sampling were performed after two freeze-thaw cycles on both sides of the box. After freeze-thaw cycle 2, CBR testing and sampling, the soil box was removed from the environmental chamber and kept in a laboratory for approximately 12 weeks by covering the soil box with a plastic tarp (representative of a spring field condition after the harsh winter).

After 12 weeks of drying, field CBR tests were performed on both sides of the soil box to investigate the long-term performance in terms of mechanical strength/stiffness of the carbonated soils that were subjected to saturation and two freeze-thaw cycles. In addition, soil sampling was performed to evaluate any possible chemical reaction via mineral (i.e., CaCO₃) content formation or lime, lime, consumption.

### Testing and Sampling

Post-carbonation and freeze-thaw cycles testing and sampling assessed changes in mechanical behavior and gravimetric binder content and lime content. Gravimetric binder content was defined as the ratio of the mass of carbonate mineral (i.e., CaCO₃) and soil. Field CBR equipment, which consists of a mechanical screw jack and piston that penetrates the ground, reacted off a steel beam spanning the soil the box that was secured by reaction blocks on each side. CBR was defined as CBR=σ₆/σ_{std} where σ₆ was the stress after 2.54 or 5.08 mm of piston penetration and σ_{std} was a standard stress of 6.9 or 10.3 Mpa that corresponds to 2.54 or 5.08 mm deformations, respectively; the CBR was the largest stress-ratio arising from measurements at 2.54 and 5.08 mm.

Samples were extruded and oven-dried to measure the water content of the extruded samples, and to prevent any further chemical reactions. The dried sample was stored in air-tight plastic containers prior to TGA testing to determine mineral (i.e., CaCO₃) content and lime content.

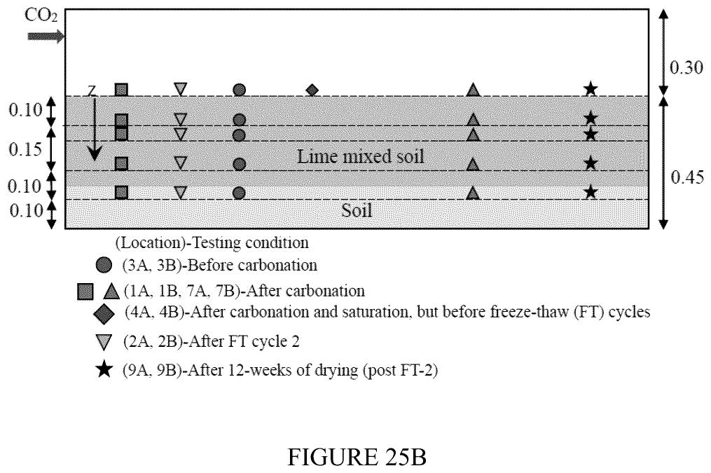

As shown in FIGS. 25A and 25B shows CBR testing and sampling locations. CBR was performed on the surface (i.e., a depth of about 0 mm) on each side after carbonation and saturation, but before freeze-thaw cycles. After two freeze-thaw cycles, and after drying for 12 weeks, CBR tests were performed at five different depths (0, 100, 150, 250, and 350 mm) at 2 locations on each side of the box (total 4 locations). A total of 52 field CBR tests were conducted on the soil box at different testing conditions. CBR testing and sampling were performed in tandem; after each CBR test, sampling was performed to collect soil for water content measurements and TGA but to also advance the hole to the next CBR test depth.

### Effects of Carbonation can Persist to Deeper Regions in a Soil Composition

The present study demonstrates that carbonate mineral (i.e. CaCO₃) content will continue to form in deeper regions of carbonated soil. After the surface carbonation was conducted, seven days elapsed prior to soaking the silt (i.e. fully saturating the soil box) for freeze-thaw experiments. Thus, during the period between the end of surface carbonation and prior to soaking, any remaining unreacted lime had a potential to react with atmospheric CO₂. However, once the box was soaked, diffusion of CO₂ into the voids would no longer have occurred, as diffusion would have ceased because water obstructed the mobility of gas.

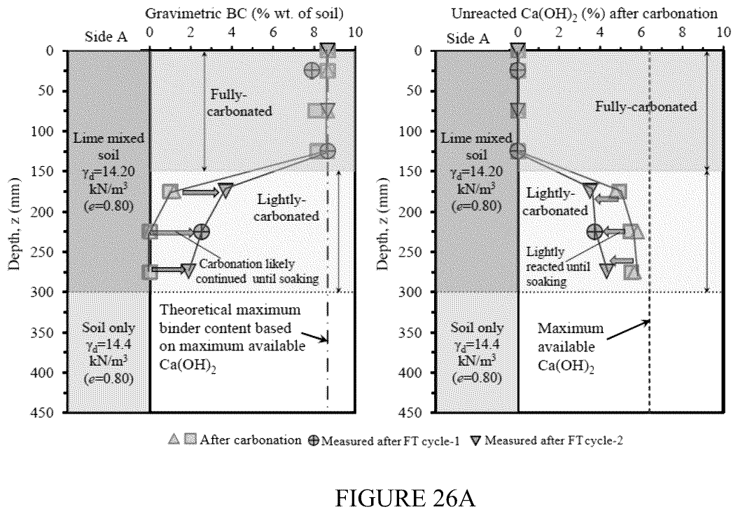

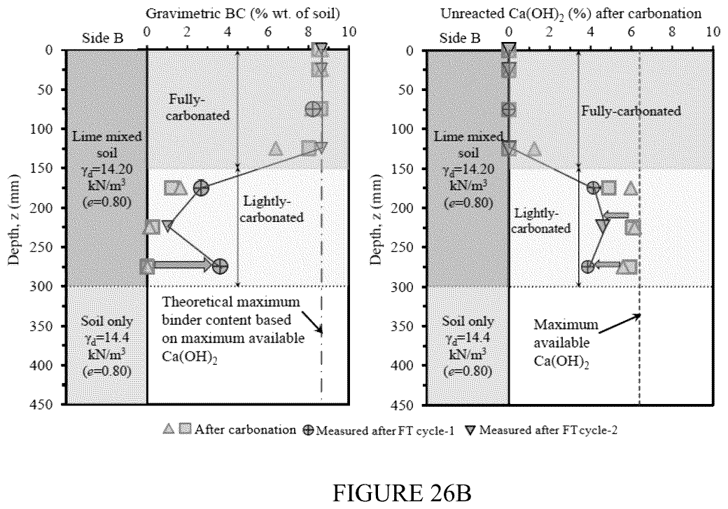

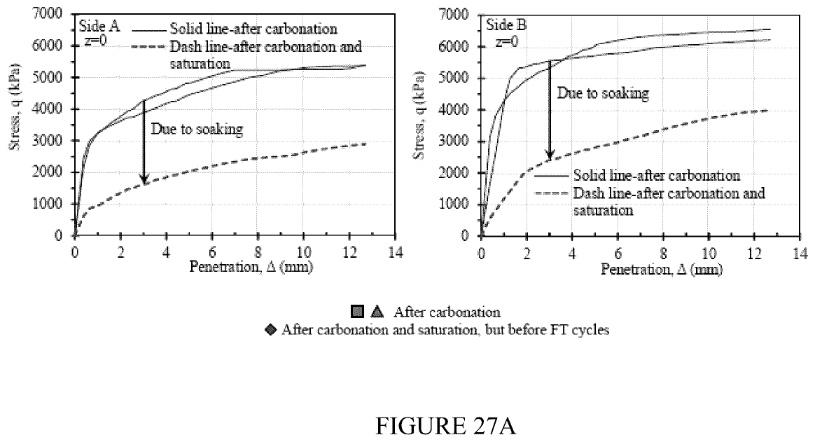

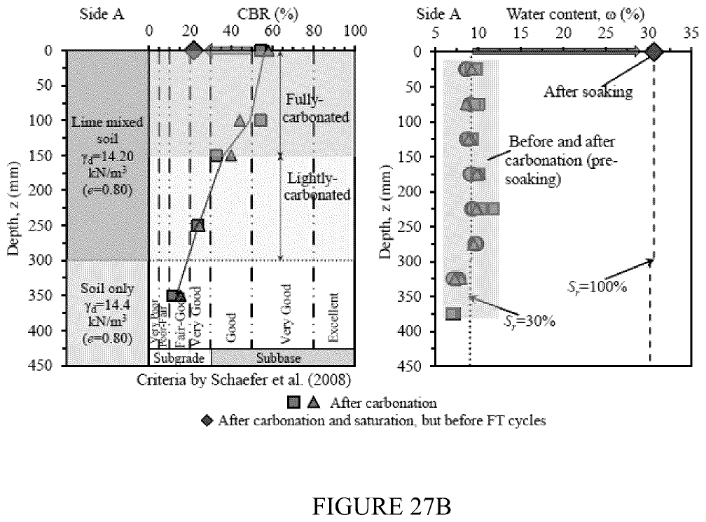

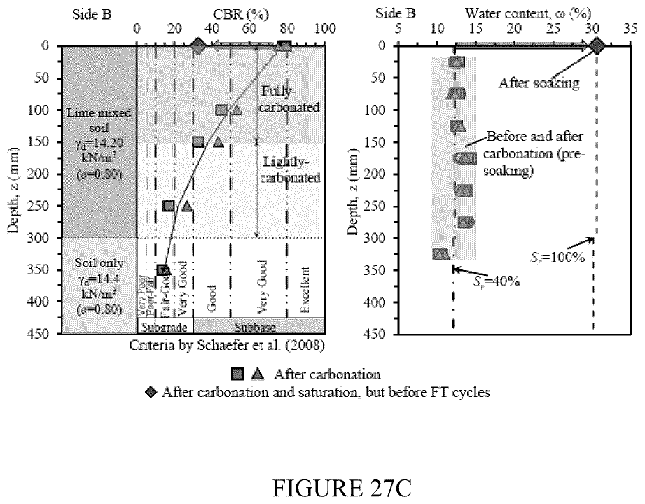

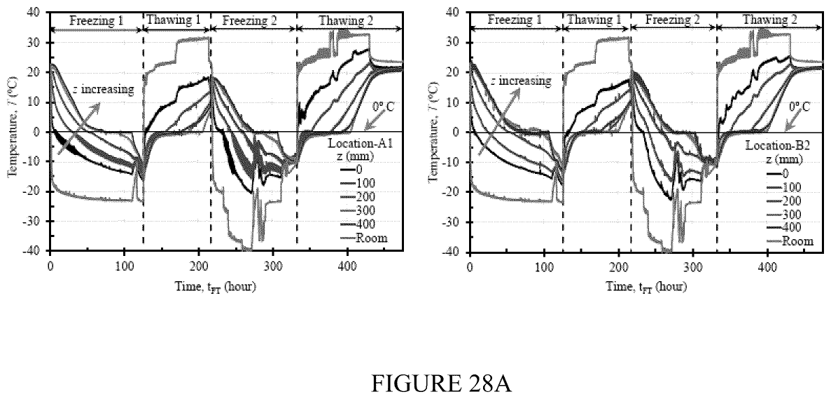

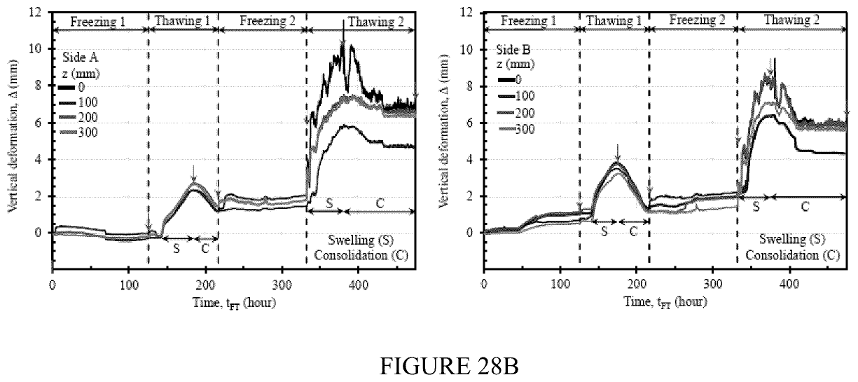

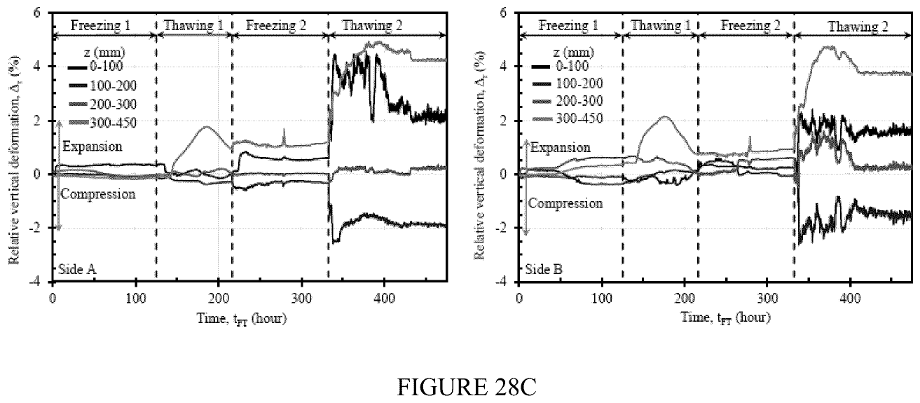

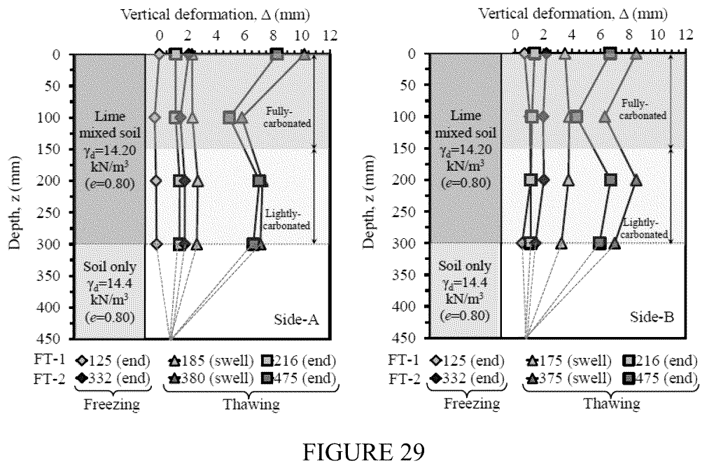

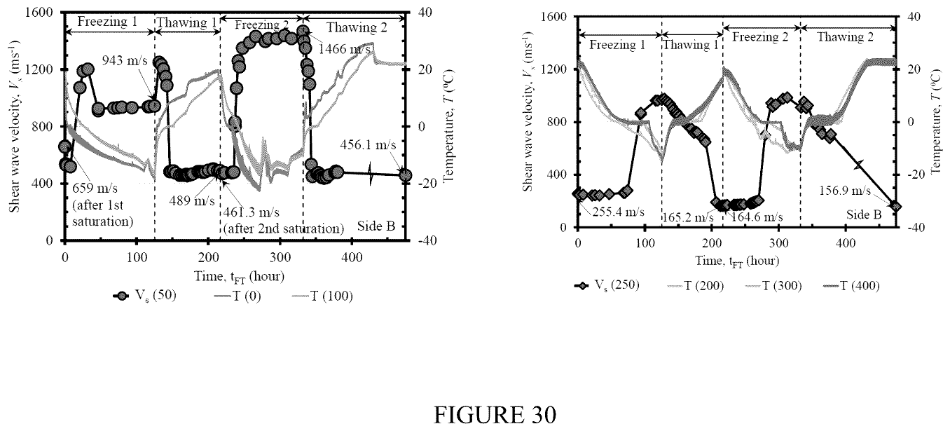

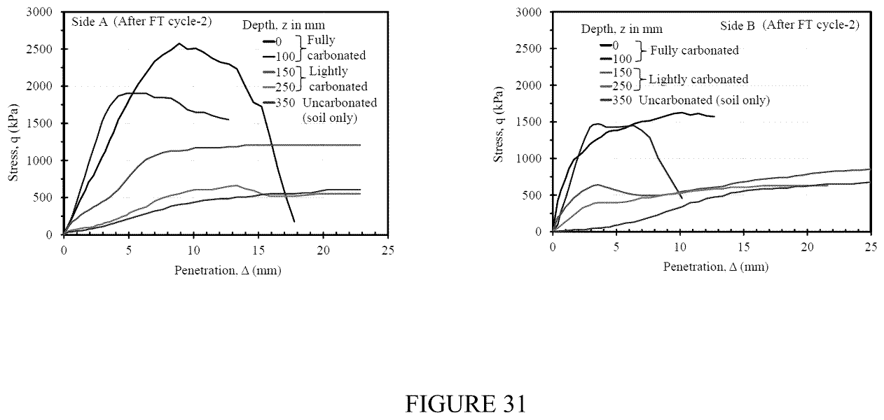

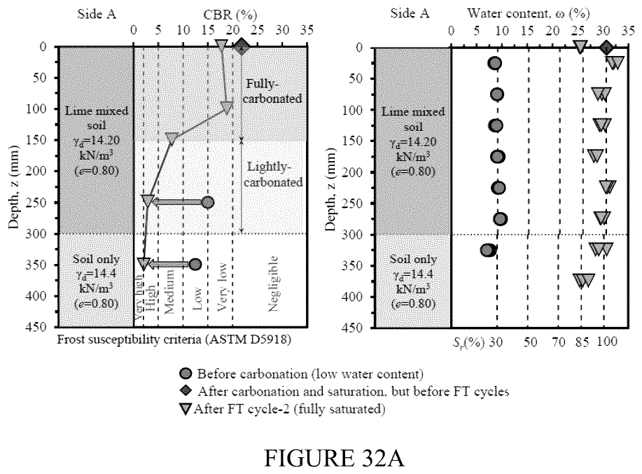

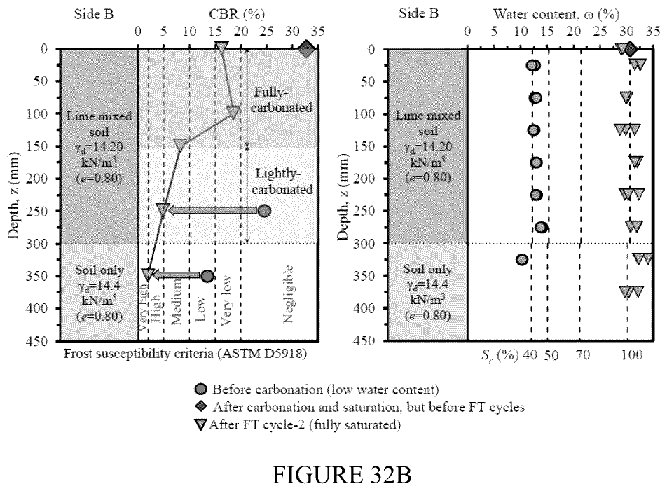

As shown in FIGS. 26A and 26B, TGA testing on soil samples collected after soaking and freeze-thaw cycles revealed that there was some additional carbonation at depths (e.g. about 150-300 mm) where lime had not fully reacted during the accelerated surface carbonation experiment. There was increased carbonate mineral (i.e. CaCO₃) content and decreased lime content in the lightly carbonated zone (e.g. about 150-300 mm) during that time period. This finding was surprising, as it demonstrated that deeper region in a soil composition (i.e. bottom of lime mixed soils) where surface carbonation did not immediately generate carbonate mineral (i.e. CaCO₃) content continued to carbonate. There were no significant differences in testing conditions on each side of the box during soaking, freeze-thaw experiments, and the drying period.

CBR Testing and Sampling after Drying Period

The present study demonstrates that soil carbonation can occur relatively rapidly under natural atmospheric conditions. After the 12-week drying period of the soil column, moisture contents to decreased and CBR testing and sampling were performed to assess the resilience of carbonated material and potential changes in carbonate mineral (i.e., CaCO₃) content.

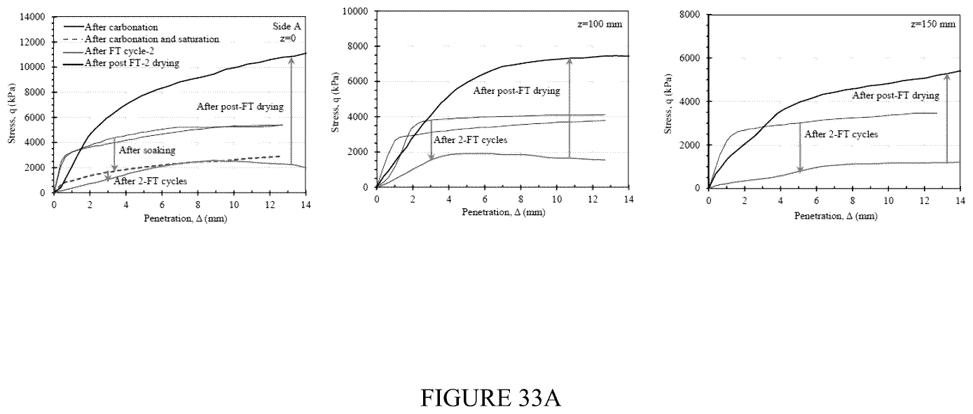

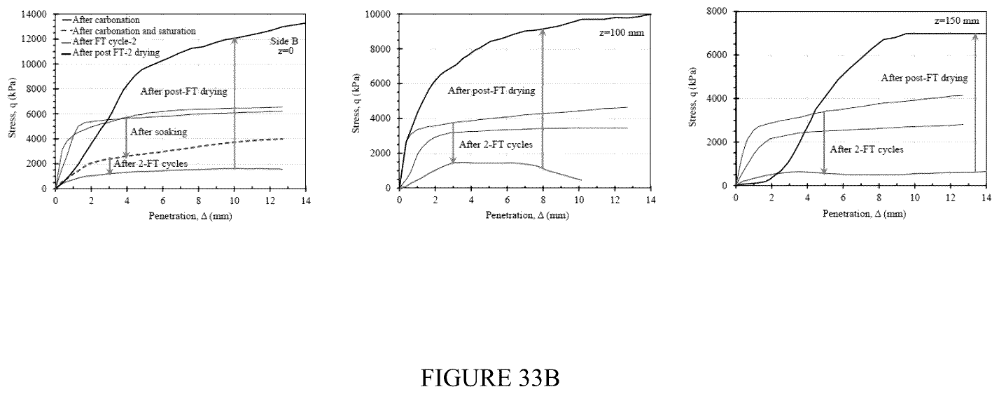

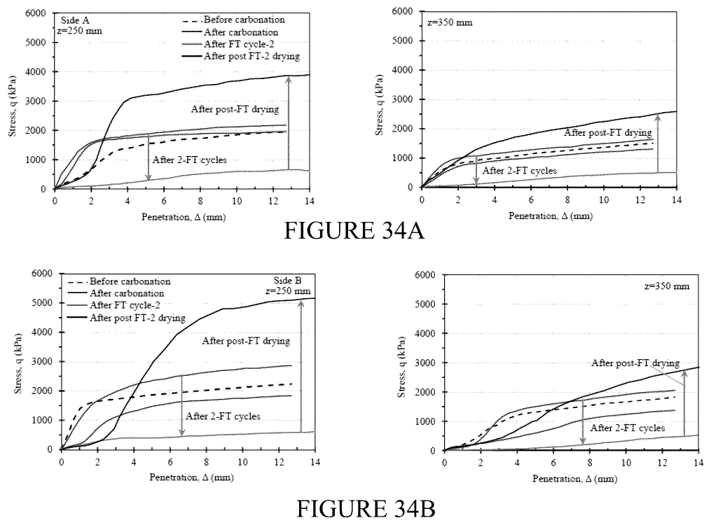

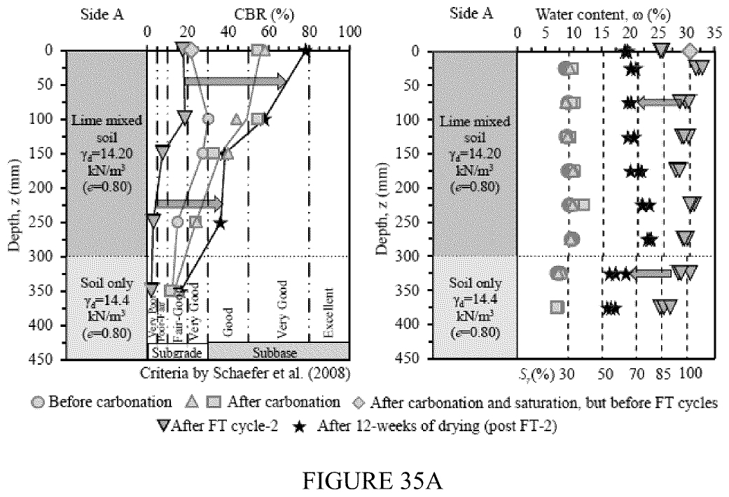

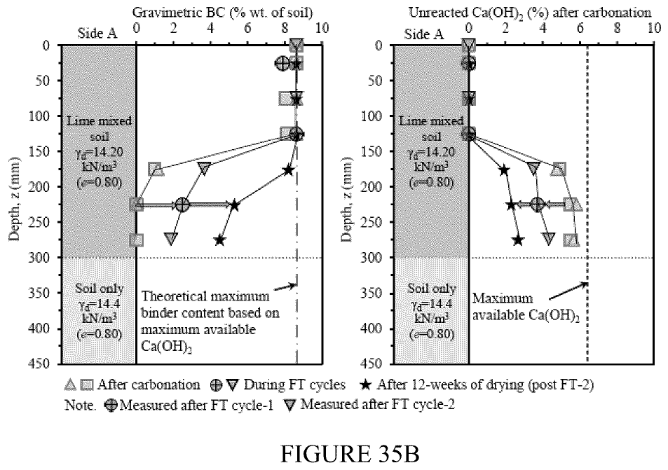

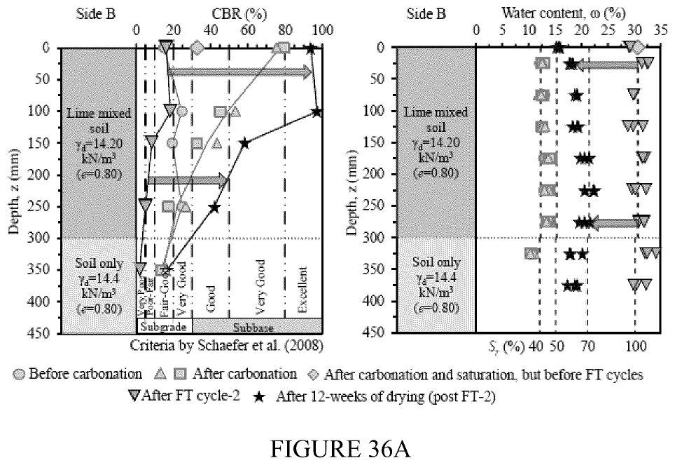

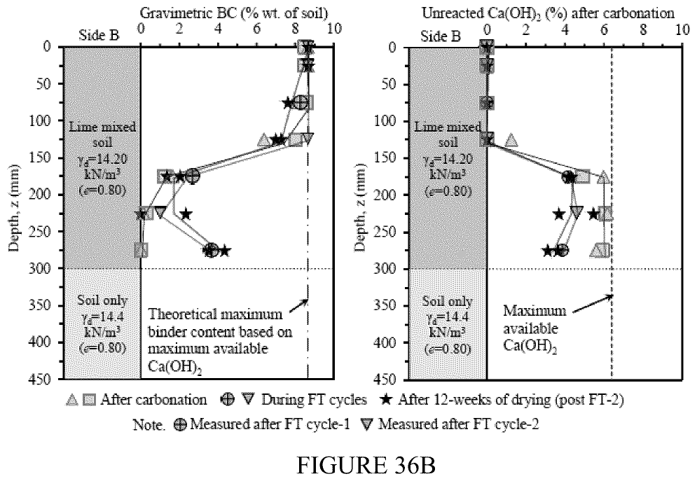

As shown in FIGS. 33A and 33B, strength and stiffness of fully carbonated silt compositions not only recovered, but also exceeded bearing resistances observed immediately after carbonation before freeze-thaw testing was performed. As shown in FIGS. 34A and 34B, uncarbonated silt compositions recovered and also exceeded pre-freeze-thaw bearing resistances, but to a lesser extent than carbonated silt compositions. FIGS. 35A and 36A illustrate CBR values fully recovered, and in most cases, exceeded values observed after carbonation, but prior to soaking and freeze thaw testing. Surprisingly, CBR increased, especially in the lightly carbonated soil.

As shown in FIGS. 35B and 36B, sampling and TGA results revealed carbonate mineral (i.e., CaCO₃) content and decreased unreacted lime from depths of about 150 to 300 mm. Without wishing to be bound by any particular theory, as the water content in the soil decreased, it opened pathways for atmospheric CO₂ to diffuse into the soil and react with remaining lime in the previously lightly carbonated soil.

Based on the increased carbonate mineral (i.e., CaCO₃) content between accelerated surface carbonation and soaking, as well as increased carbonate mineral (i.e., CaCO₃) content observed during the drying period, substantial amounts of carbonate mineral (i.e., CaCO₃) content formed so long there was mobility of gas. This observation opens up the possibility of carbonating soil in a reasonable time frame without introducing the CO₂ directly (i.e., via surface carbonation).

Thus, aside from demonstrating that carbonated material was durable when exposed to frost-action, this study revealed that carbonation can occur relatively rapidly under natural atmospheric conditions if water does not obstruct the mobility of gas within the pore volume. This unexpected finding has the potential to simplify implementation of soil carbonation.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

1. A method of soil stabilization, the method comprising,
contacting a composition comprising soil, lime, and water, with exogenous carbon dioxide sufficient to create and/or maintain a continuous gas phase in the composition for a period of time sufficient to precipitate carbonate minerals in the composition.

2. The method of claim 1, wherein a combination of void ratio and water content results in the composition with a degree of saturation that maintains the continuous gas-phase in the composition to facilitate gas mobility via diffusion and/or advection, such that the carbonate minerals are rapidly and/or efficiently precipitated to bond soil grains.

3. The method of claim 1, wherein the composition comprises silt, non-plastic silt, sand, non-plastic sand, clay, peat, chalk, loam or a mixture thereof.

4. The method of claim 3, wherein the composition comprises one or more of silt, sand, contaminated soil, and solid waste.

5.-7. (canceled)

8. The method of claim 1, wherein the lime is quick lime or hydrated lime.

9. The method of claim 1, wherein the lime is hydrated lime (i.e. Ca(OH)₂) and wherein the hydrated lime is in amount between about 3% to about 15% by weight of the soil.

10.-19. (canceled)

20. The method of claim 1, wherein the composition comprises about 5% to about 50% water.

21.-29. (canceled)

30. The method of claim 2, wherein the void ratio, eₒ, is between about 0.3 to about 2.0.

31. The method of claim 2, wherein the void ratio, eₒ, between is about 0.5 to about 1.3.

32. The method of claim 2, wherein the degree of saturation is between about 10% to about 80%.

33.-45. (canceled)

46. The method of claim 1, wherein the precipitated carbonate mineral is calcium carbonate.

47.-57. (canceled)

58. The method of claim 1, wherein the period of time is between about 2 hours and about 300 hours.

59. The method of claim 1, wherein the exogenous carbon dioxide is applied under a constant pressure.

60.-78. (canceled)

79. The method of claim 1, wherein the formation of the carbonate mineral does not result in substantial atmospheric release of carbon dioxide into the atmosphere.

80.-108. (canceled)

109. A method of accelerated soil stabilization, the method comprising,
contacting a composition comprising soil, a metal oxide and/or metal hydroxide and water, with exogenous carbon dioxide sufficient to create and/or maintain a continuous gas phase in the composition for a period of time sufficient to precipitate carbonate minerals in the composition.

110.-111. (canceled)

112. The method of claim 109, wherein the metal oxide and/or metal hydroxide is selected from the group consisting of CaSiO₃, CaO, Mg₂SiO₄, MgO, Ca(OH)₂, and Mg(OH)₂.

113.-116. (canceled)

117. The method of claim 109, wherein the precipitated carbonate mineral is calcium carbonate and/or magnesium carbonate.

118. A method of soil stabilization, the method comprising,
(a) determining a soil type, void ratio, and/or degree of saturation for a composition comprising soil, a metal oxide and/or metal hydroxide, and water; and
(b) contacting the composition with exogenous carbon dioxide sufficient to create and/or maintain a continuous gas phase in the composition for a period of time sufficient to precipitate carbonate minerals in the composition,
wherein the period of time is determined by the soil type, degree of saturation, and/or water content.

119.-120. (canceled)
